(19) United States
(12) Patent Application Publication
(10) Pub. No.: US 2026/0159772 A1
(43) Pub. Date: Jun. 11, 2026

(54) FUEL AND MANUFACTURE OF THE SAME

(71) Applicant: REC RELIABLE ENGINEERING CONCEPTS GMBH, Stuttgart (DE)

(72) Inventors: Julian TÜRCK, Stuttgart (DE); Ralf TÜRCK, Stuttgart (DE); Jürgen KRAHL, Lemgo (DE); Jens UTECHT, Obrigheim (DE); David TÜRCK, Stuttgart (DE)

(21) Appl. No.: 19/127,049

(22) PCT Filed: Nov. 3, 2023
(86) PCT No.: PCT/EP2023/080675

§ 371 Date: May 2, 2025

(30) Foreign Application Priority Data
Nov. 3, 2022 (EP) 22205278.9
Aug. 23, 2023 (EP) 23192932.4

(51) Int. Cl. C10L 1/185

(52) U.S. Cl. CPC C10L 1/1852; C10L 2200/0476; C10L 2270/023; C10L 2270/026; C10L 2290/24

(57) ABSTRACT

The present invention provides fuels for combustion engines of the diesel type and petrol type and especially to fuels having an increased content of fuel components originating from renewable sources. In particular, diesel type fuels are provided, which contain at least solketal, renewable alkane fuel and biodiesel. Petrol fuels are also provided, wherein solketal is provided as a substitute for fossil petrol or other petrol fuel components. The present invention further provides methods for manufacturing the fuels of the invention as well as uses thereof.

### 1. TECHNICAL FIELD OF THE INVENTION

The present invention relates to fuels for combustion engines of the diesel type and petrol type and especially to fuels having an increased content of fuel components originating from renewable sources. The present invention further provides methods for manufacturing the fuels of the invention as well as uses thereof.

### 2. STATE OF THE ART

Fuels for combustion engines primarily consist of fuel components having fossil origin. Having regard to the climate crisis as well as likely future shortages of fossil fuels, there is a general need for alternative fuels having an increased content of fuel components from renewable sources.

Such fuel components from renewable sources are already known. They include
“biodiesel”, i.e. a composition of fatty acid methyl esters originating from transesterification of oils originating for instance from plant materials;
“bioethanol”, i.e. ethanol typically obtained by fermentation of glucose or other raw materials originating from renewable sources such as lignocellulose;
“HVO”, i.e. a composition of hydrotreated vegetable oils or, generally, hydrotreated triglycerides; as well as
“solketal”, also known as isopropylidene glycerol, may be obtained by condensation of glycerol with acetone, the glycerol potentially originating from renewable sources; for instance, glycerol is a by-product of the manufacture of biodiesel by transesterification.

At present, a typical diesel fuel according to EN 590 specification contains up to 7% biodiesel (B7) and in some cases HVO. The E10 petrol contains about 10% of bioethanol although other fuel compositions have been tested, for instance in an article by C. J. A. Mota et al. in Energy Fuels 2010, 24, 2733-2736, doi:10.1021/ef9015735.

It is desired to further increase the content of fuel components from renewable sources. However, increasing the content of renewable fuel components is difficult as it gives rise to new problems. For instance, incorporating significantly more than 26% of HVO into diesel fuel has the effect of reducing the density of the fuel. This is detrimental because the resulting fuel exhibits very low density, which is not desirable.

Adding greater amounts of solketal into diesel fuel is not a viable alternative since the resulting compositions show a tendency to de-mix because of physico-chemical interactions, expressed in e.g. polarity.

To make matters worse, some fuels having an increased content of components from renewable sources exhibit reduced stability: such fuels frequently exhibit increased turbidity and precipitation of small particles of upon long-term storage.

There is literature reporting on experiments with diesel fuel having a very high content of fuel components from renewable sources. For instance, Alptekin reports in Energy 119, 2017, 44-52, http://dx.doi.org/10.1016/j.energy.2016.12.069, on tests with fuel compositions containing 85% biodiesel and the remainder being either ethanol or solketal. However, the resulting fuel is characterized by a very low cetane index, and it is therefore not suitable for all diesel engines.

The article by Giraldo et al. in Fuel 108, 2013, 709-714, describes tests with palm biodiesel having incorporated therein 1%, 3%, 5% or 10% of an additive selected from glycerol ketals, glycerol triacetate and fatty acid esters with branched alcohols such as isobutanol. However, these diesel fuel compositions are not ideal for use in real life practice because the tested fuels due to high density and low cetane index.

Türck et al. describe in Fuel, 2022, 310, https://doi.org/10.1016/j.fuel.2021.122463 investigations on solketal in diesel fuel compositions. However, the investigated compositions contained substantial amounts of fossil diesel fuel. There is no information how the content of fuel components from renewable sources can be maximised. Moreover, Türck et al. report on problems with precipitation and aging for the tested fuel compositions.

In view of the above problems, one objective underlying the present invention is to provide diesel fuel compositions with a high or very high content of components from renewable sources, which compositions exhibit a favorable combination of properties including especially as many as possible and preferably all of the following target properties:
a cetane number of 30 or more and more preferably a cetane number of 51.0 or more;
a gross calorific value of 25,000 J/g or more;
a net calorific value of 23,000 J/g or more;
compliance with the EN 590 standard with respect to
   the flash point
   the content of polycyclic aromatic hydrocarbons,
   the content of sulfur,
   the content of manganese,
   the carbon residue,
   the ash content,
   total contamination and
a homogenous phase without de-mixing; and
a superior stability, including especially
   absence of precipitates upon storage; and
   absence of demixing including absence of demixing at low temperature; and
good low temperature performance.

According to another embodiment, diesel fuel compositions are to be provided, which exhibit the above target properties to such an extent that they may serve as drop-in solution for existing diesel fuels and technology.

According to yet another embodiment, diesel fuel compositions are to be provided, which accomplish one or more of the above objectives and which additionally exhibit a density of 820-845 kg/m³, in accordance with EN 590, or a density of 810-845 kg/m³ or 800-845 kg/m³, or a density in accordance with another industrial norm such as the density range of 815-880 kg/m³ of Dirjen Migas Standard 185.K/HK.02/DJM/2022 of Indonesia.

In a preferred embodiment, it is an objective underlying the present invention to provide diesel fuel compositions as specified above that comply with the current or any future EN 590 standard in as many respects as possible and most preferably in all respects (except for the intentional deviation from the limited maximum amount of biodiesel of 7%), and which exhibits excellent low temperature performance as expressed by a CFPP value of less than-10° C. and more preferably less than −20° C.

Of course, there are also further performance characteristics that are advantageously improved. Further objectives of the present invention are therefore to provide diesel fuel compositions exhibiting one or more of the above-mentioned performance characteristics and additionally one or more of reduced formation of soot particles, higher cetane number, reduced sulfur emissions, satisfactory energy content allowing for a high range of the vehicle at a given tank volume, suitable viscosity, high stability at low temperatures and low temperature stability.

According to yet another embodiment of the invention, diesel fuel compositions specifically for marine vessels are provided, which accomplish the beneficial properties corresponding to the above beneficial properties, to the extent that these are relevant for use in marine vessels, preferably with a compliance with ISO 8217 2017 that is as high as possible, and which in particular exhibit advantageous stability while permitting to adjust viscosity according to requirements.

For petrol, the situation is similar in so far as there is also a general desire to increase fuel components originating from renewable sources. However, increasing the content of the commonly used renewable fuel component bioethanol to contents of significantly more than 10% is possible only if the engine is suitably adapted (so-called “flex fuel vehicles”). Bioethanol is not an ideal component for petrol since its high demand and corresponding higher price; its higher degree of regulation, taxation and associated bureaucracy; and also because it is one of the renewable materials that is in the focus of criticism referred to under the heading of “indirect land use change” (ILUC) impacts of biofuels. Moreover, increasing the content of bioethanol may lead to stability problems. Adding other components from renewable sources such as methanol is not advantageous as methanol is a toxic substance. The methanol-based fuel additive MTBE (methyl tert-butyl ether) shows groundwater toxicity.

In view of the above, it is desired to provide a petrol fuel composition having an increased content of fuel components from renewable sources, which is stable, shows little toxicity and which can be used in conventional cars without need for any adaptation of the engine. It is also an objective of the present invention to provide a petrol fuel, which accomplishes the above-mentioned benefits while allowing to substitute a significant quantity of ethanol. Yet another objective is to provide such a petrol fuel, which complies with as many criteria of the applicable industrial norm EN 228 as possible, with the exception that there is no intention to satisfy the oxygen content specified in this norm. Further objectives of the present invention are to provide petrol fuels exhibiting one or more of the above-mentioned performance characteristics and additionally one or more of reduced formation of soot particles, higher octane number, reduced sulfur emissions, high energy content allowing for a high range of the vehicle at a given tank volume, suitable viscosity, high stability at low temperatures, and low temperature stability.

A further objective underlying the present invention is the possibility to reduce turbidity of aged fuels including diesel and petrol fuels. Turbidity is an indicator for the precipitation of aged components which reduce the performance of the fuel.

Yet another objective is to provide diesel fuel compositions that show improved storage stability in a humid environment. In a related aspect, it is an object of the invention to provide a possibility of using biodiesel having an elevated moisture content in the manufacture of diesel fuel compositions. Another related objective is to provide stable diesel fuel compositions having an elevated moisture content, as well as diesel fuel compositions having a lower moisture content but which remain stable upon uptake of further moisture, e.g., during storage or transport. A further object of the invention is to provide a diesel fuel component that can be used to improve stability of diesel fuel compositions against degradation associated with high contents of water as an impurity.

Yet another objective is to provide a fuel for use in motor sports or specific application like short distance urban transport and autonomic driving which exhibits reduced soot emissions, increased safety and originates from sustainable sources.

### 3. SUMMARY OF THE INVENTION

The above objectives are accomplished by the fuel compositions of the present invention. In one embodiment, diesel fuel compositions are provided, which contain a high or very high content of fuel components from renewable sources, and which simultaneously comply with the requirements of the current or any future industrial standard EN 590, or any related industrial standards in other countries, in most respects and therefore allow a drop-in solution for existing technology of combustion engines. In addition, they show a low tendency to de-mix as well as a high stability. The diesel fuel composition of this embodiment is characterized in the appended claim 1. Preferred aspects of this embodiment are specified in the subsequent dependent claims 2 to 9.

In another aspect, the invention provides a use of said diesel fuel compositions of the invention for replacing fossil diesel fuel. The embodiment is specified in appended claim 10 and dependent claim 11.

The present invention furthermore provides methods for manufacturing the above-mentioned diesel fuel compositions of the present invention. These are defined in appended claim 12, while preferred aspects of these manufacturing methods are defined in the subsequent dependent claims 13 and 14.

In another embodiment, a petrol fuel composition is provided, which contains a high or very high content of fuel components from renewable sources and which accomplishes at the same time high stability as well as low toxicity. The petrol composition of this embodiment is specified in the appended claim 15. The manufacture of said petrol fuel compositions of the invention is specified in appended claim 16.

In another aspect of the invention, solketal is used for increasing the content of renewable components in diesel or petrol fuel. This aspect is specified in appended claim 17.

Yet another embodiment of the invention relates to the use of solketal for removing degradation products in aged petrol or diesel compositions, such as turbidity or precipitation, by addition of solketal. This aspect of the invention is specified in appended claim 18.

A further aspect of the invention relates to the use of solketal, optionally with one or more additives, as a drop-in fuel for diesel or petrol fuel, as specified in appended claim 19.

In yet another embodiment, the use of solketal as a diesel fuel component is provided to thereby improve the stability of said diesel fuel compositions against degradation caused by water impurities, such as growth of bacteria or molds. This embodiment is specified in claim 20.

Further details on the various aspects of the present invention are provided herein in the general part and experimental part of the present application, which, however, should not be construed as limiting the invention.

### 4. BRIEF DESCRIPTION OF FIGURES

FIG. 1 shows the results of some model calculations in the form of graphical representations. The lines connecting the calculated endpoints depict all the “permissible” compositions of the two variable components, which allow to obtain a density within the target range. The calculations were made for a biodiesel content of 10 wt. % and varying solketal contents of 3 wt. %, 5 wt. % and 10 wt. %, while the contents of renewable alkane and fossil diesel are represented by the position on the respective axis and can be selected from the different points on the depicted lines. The densities of solketal, biodiesel, renewable alkane and fossil diesel were assumed to be 1063 kg/m³, 885 kg/m³, 780 kg/m³ and 837.5 kg/m³, respectively.

### 5. DETAILED DESCRIPTION OF THE INVENTION

### 5.1. Definitions

In the context of the present invention, diesel is understood to be a composition of liquid combustible substances, typically containing hydrocarbons optionally blended with further components such as biodiesel, which is suitable for use in diesel engines including diesel engines in cars and trucks as well as diesel engines in marine vessels (bunker fuel), SAF (sustainable aviation fuel) or emergency power units. In specific embodiments, diesel is understood to be a composition of liquid combustible substances suitable for use in diesel engines in cars and trucks. In even more specific embodiments, especially in connection with fossil diesel as a raw material, diesel is understood to be a composition of hydrocarbons suitable for use in diesel engines in cars and trucks and additionally complying with industrial standard EN 590 (version of 2014). Fossil diesel in the sense of the present invention typically contains 90 mol-% or more of C₉₋₂₂ alkanes and preferably C₁₄₋₁₈ alkanes. Aromatic components having typically 6 to 24 carbon atoms may also be present in amounts of 10 mol-% or less. The boiling point of diesel at atmospheric pressure is typically in the range of from 180° C. to 380° C.

In the context of the present invention, petrol (or gasoline) is understood to be a composition of hydrocarbons suitable for use in cars and trucks (other than diesel cars and trucks). In specific embodiments, petrol refers to compositions of hydrocarbons for use in non-diesel cars and trucks, which also comply with industrial standard EN 228 except that the maximum oxygen content need not be below 3.7 wt %. Fossil petrol in the sense of the present invention typically contains up to 42 vol.-% aromatic components, up to 18 vol.-% C₅₋₁₂ alkene components and the remainder being C₅₋₁₂ alkanes. The boiling point of petrol at atmospheric pressure is in the range of from 40° C. to 220° C.

In the context of the present invention, the expression fossil fuel refers to diesel fuel or petrol, which is obtained by crude oil drilling, cracking and refining processes. Fossil diesel is diesel fuel according to the above definition which is obtained by crude oil drilling, cracking and refining processes. Fossil petrol is petrol according to the above definition, which is obtained by crude oil drilling, cracking and refining processes.

The present invention refers to the term renewable in the context of fuel and fuel components as characterizing materials that are obtained from renewable primary products like biomasses (cell, plant and animal based) and waste material. Such biomasses and waste materials are obtained by harvesting, collecting or capturing. By contrast, fossil fuels are not meant to be encompassed by this definition even though they originate from ancient plant materials.

In the context of the present invention, the expression renewable alkane fuel is intended to encompass any alkane-containing composition, which is manufactured from renewable sources, which is authorized or developed for use in diesel fuel as defined above. It is intended to encompass hydrotreated vegetable or animal fats and/or oils (HVO) as well as diesel-type renewable synthetic fuels as defined below, or any mixture thereof. For the avoidance of doubt, biodiesel, as defined below, is not to be regarded as a renewable alkane fuel even though the molecules constituting biodiesel each contain two alkane groups. The ester functional group linking these two alkane groups justifies treating biodiesel separately. The above expression “alkane-containing” is thus to be understood as “containing an alkane molecule”, i.e. an alkane molecule that has no other functional groups. Moreover, the term renewable alkane fuel is to be understood such that compositions obtained by mixing renewable alkane fuel with substances that are, as such, not renewable alkane fuel (such as other fuel components like biodiesel or additives), are not meant to be encompassed. Renewable alkane fuel can be distinguished from fossil fuel by virtue of its ¹⁴C/¹²C isotope ratio, in a manner that is based on the same approach as the radiocarbon dating method (https://en.wikipedia.org/wiki/Radiocarbon_dating).

The present invention refers to hydrotreated vegetable oil (HVO) as a substance obtainable by hydrotreatment or hydrocracking of vegetable or animal fat and/or oil, which is an industrial established renewable alkane. For the avoidance of doubt, the term hydrotreated vegetable oil is to be understood such that compositions obtained by mixing hydrotreated vegetable oil with substances that are, as such, not hydrotreated vegetable oil (such as other fuel components like biodiesel or additives), are not meant to be encompassed.

The terms e-fuels or electrofuels are used herein as synonyms to characterize alkane-containing compositions that are obtained by reacting hydrogen gas with carbon monoxide and/or carbon dioxide, wherein the carbon monoxide and/or carbon dioxide is preferably captured from the atmosphere or industrial resp. biological waste gas. The hydrogen used for this process is preferably prepared using electricity from renewable electricity sources such as wind or solar energy. Depending on the characteristics of the fuel, a distinction may be made between diesel-type e-fuels (which are suitable as components of diesel fuels) and petrol-type e-fuels (which are suitable as components for petrol fuels). If the e-fuel is produced via a Fischer-Tropsch process, diesel-type and petrol-type e-fuel components may be separated from the primary product by means of conventional refining technology. A pure petrol-type e-fuel is obtained in a sequence of processes involving the formation of methanol from a mixture of hydrogen with carbon monoxide or carbon dioxide, followed by conversion of methanol into octane in a so-called “methanol-to-gasoline” process.

The term synthetic fuel is generally understood to encompass all fuels obtained by chemical conversion of other raw materials such as natural gas (gas-to-liquid), coal (coal-to-liquid), biomass (biomass-to-liquid) and carbon dioxide (power-to-liquid, e-fuel, or sun-to-liquid). The more specific term renewable synthetic fuel is used herein to characterize only those synthetic fuels that do not rely on fossil raw materials. These include, in more detail, e-fuels and biodiesel as defined above and below. In addition, they also include other fuels of the biomass-to-liquid type such as “e-gasoline” and “biogasoline”. E-gasoline is a synthetic isooctane fuel created by Audi from biomass and hydrogen, as described in the Wikipedia entry “E-gasoline”, version as at Sep. 1, 2022. Biogasoline is petrol obtained from wood by means of a process developed by Haldor Topsoe involving formation of methanol from wood raw material, followed by conversion into petrol via a process termed TIGAS (Topsoe Improved Gasoline Synthesis).

In the context of the present invention, the term biodiesel is understood as a composition directly obtained from esterification of fatty acids or transesterification of fatty acid triglycerides, wherein the fatty acids or fatty acid triglycerides originate from renewable sources. By consequence, the thus obtained biodiesel comprises one or more fatty acid esters as a main component. The alkyl of the ester is typically selected from methanol, ethanol, propanol, isopropanol, n-butanol and iso-butanol and any mixture thereof. In specific embodiments, biodiesel is understood to be a composition comprising one or more fatty acid methyl esters as a main component and additionally complying with industrial standard EN 14214 in the version of 2019. The above-mentioned expression “directly obtained” is meant to exclude subsequent steps of adding substances that are, as such, not biodiesel (such as other fuel components like HVO or additives), while it does not mean to exclude steps of refining, purification or water removal (i.e. steps of removing undesired components).

In the context of the present invention, the term fatty acid is to be understood as a monocarboxylic acid having the carboxyl group covalently bonded to a terminal position of a linear alkane or linear alkene group. The total number of carbon atoms of fatty acids may range from 4 to 28 and more typically 6 to 24. Fatty acids obtained from renewable sources typically are a mixture of different fatty acid molecules. A number average of carbon atoms in such fatty acid mixtures typically falls within the range of 6 to 24 carbon atoms.

In the context of the present invention, the term renewable petrol is intended to characterize any compound or composition, which is manufactured from renewable sources, which is authorized or developed for use in petrol as defined above. It is intended to encompass bioethanol, as well renewable synthetic fuels or any mixture thereof. For the avoidance of doubt, this definition is to be understood as not encompassing compositions obtained by mixing renewable petrol with other substances that are, as such, not renewable petrol (e.g. fossil petrol, solketal, or additives as described hereinbelow). Renewable petrol can be distinguished from fossil petrol by virtue of its ¹⁴C/¹²C isotope ratio, in a manner that is similar to the radiocarbon dating method.

In the context of the present invention, the term petrol fuel component refers to all substances other than the above-mentioned fossil fuel and additives as mentioned below, which can be incorporated into petrol with the primary objective of providing energy upon combustion. This includes the above-mentioned synthetic fuels (as far as suitable for petrol applications), as well as alcohols and ethers. Among the alcohols, reference can be made to methanol, ethanol, propanol, n-butanol and iso-butanol.

In the context of the present invention, the term renewable petrol fuel components refers to all components in agreement with the above definition of petrol fuel component, but which additionally fulfil the condition of originating from renewable raw materials. A typical example of this class is bioethanol obtained by fermentation of carbohydrates from renewable plant material. Again, as explained above, a distinction from fossil petrol fuel components is possible by virtue of its ¹⁴C/¹²C isotope ratio, similar to the radiocarbon dating method.

In the context of the present invention, the term additive refers to substances that are added to fuel compositions in small quantity of less than 10 weight-% (typically 1 weight-% or less) to provide, enhance or modify a property of the fuel composition. While each additive is typically employed to perform a specific well-defined function to thereby accomplish a specific target property, it is of course not excluded that an additive can influence more than one property.

Unless specified otherwise, relative amount indications provided in the context of the present invention are to be understood as indications in weight-%, i.e. the weight of the respective component of interest divided by the total weight of the fuel composition of the invention, such that the relative amount of a component is calculated as 100%*weight of component/weight of entire composition.

In the context of the present invention, indications of numerical ranges, such as numerical ranges to characterize relative amounts of components, are to be understood such that each value falling within the range and each sub-range that can be formed by any two values falling within the range are also intended to be disclosed. For example, a disclosure of a range of 1 to 10 weight-% equally discloses all values of 1, 2, 3, 4, 5, 6, 7, 8, 9 and 10 weight-% as well as any subrange formed between any two of these values such as 2-6 or 5-9 weight-%. The specified degree of precision applies also to the equally disclosed individual values and sub-ranges. This means also that a disclosure of the corresponding range, but with a higher degree of precision, discloses individual values and sub-ranges of the same higher level of precision. For example, a disclosure of the range 1.0 to 10.0 weight-% also discloses all individual values of 1.0, 1.1, 1.2, 1.3, etc. up to 9.7, 9.8, 9.9 and 10.0 weight-%, as well as any sub-range formed between any two of these values.

Unless specified otherwise or unless the context dictates otherwise, the specified level of precision in the indication of numerical values determines the permissible degree of variation due to measurement errors or the like. Standard rounding conventions apply. For instance, the indication of a numerical value of 5 is intended to characterize all values of 5±0.5 (to be precise: 4.5 or more to less than 5.5) whereas the value 5.0 characterizes all values of 5±0.05 (to be precise: 4.95 or more to less than 5.05).

Indications of density refer to densities determined at 15° C. according to EN ISO 12185:1997.

The cetane number is to be determined pursuant to DIN EN 17155:2018

The flash point is to be determined in accordance with DIN EN ISO 2719:2021

Viscosity is to be determined according to DIN EN ISO 3104:2021

Turbidity is to be determined by Hach 2100Q turbidity device. Absence of turbidity means a turbidity value of 4 NTU or less.

The present application uses the term impurity in its normal sense to characterize substances such as water, which are present in the raw materials and/or final composition as a consequence of impurity of raw materials, production and/or storage but without being deliberately added.

If there are different versions of an industrial norm, in the absence of a concrete indication of the applicable year, the version that is in force on Sep. 1, 2022 is to be considered as relevant for the present invention. References to internet publications are to be understood as references to said internet publications as can accessed on Aug. 1, 2023.

In the context of the present invention, indications of multiple ranges of relative amounts for different components are to be understood such that only those values and sub-ranges are meant to be disclosed for the different components, which are mathematically possible, i.e. for which the sum of relative amounts is 100 weight-% (or less, to allow for unmentioned further components). In other words, such disclosures of multiple ranges of relative amounts for different components are to be read as being subject to the proviso that the sum of individual relative amounts does not exceed 100 weight-%. For example, indications of relative amounts in terms of weight-% for multiple components of the composition are to be understood such that any value falling within the range specified for one component may be combined with any value falling within the range specified for the second component and any value falling within the range specified for the third component, and so forth, with the following provisos:
if the sum of the components is less than 100 weight-%, the remainder is fossil diesel fuel and/or one or more additive, or, in other embodiments, the remainder being fossil diesel fuel and/or one or more additive and/or unmentioned further components; and
individual values are to be selected and combined such that the sum of the relative amounts for the respective components does not exceed 100 weight-%;
individual values are to be selected and combined such that the sum of the relative amounts for the respective components allows to comply with other conditions, such as that a particular additive can be added in an amount that is appropriate to convey the desired functionality of said additive.

### 5.2. Diesel Fuels of the Invention

The diesel fuel compositions of this embodiment of the present invention are characterized by the presence of renewable alkane fuel, biodiesel and solketal as essential components while fossil diesel fuel and further additives are optional additional components. Moreover, the present invention relies on the surprising finding that an excellent combination of performance characteristics in accordance with the above objectives can be accomplished by suitably adjusting the relative amounts of the three essential components such that they fall within the following ranges:
solketal content (w(a)) is from 0.1 weight-% to 32 weight-% such as anyone of the following ranges: 0.2 weight-% to 28 weight-%, 0.3 weight-% to 24 weight-%, 0.5 weight-% to 20 weight-%, or 0.7 weight-% to 15 weight-%; more preferably from 1 to 10 weight-% or 3 to 8 weight-%, even more preferably 4 to 7 weight-% and especially 4 to 6 weight-%; or, in other preferred embodiments, 0.1 weight-% or more and 2.3 weight-% or less, 0.2 weight-% or more and 2.2 weight-% or less, 2.7 weight-% or more and 32 weight % or less, 2.8 weight-% or more and 28 weight-% or less, 3.0 weight-% or more and 24 weight-% or less.
biodiesel content (w(b)) is from 2 weight-% to 95 weight-% or, more specifically, 2 weight-% to 90 weight-% or 2 weight-% to 85 weight-%, such as 3 weight-% to 80 weight-% or 4 weight-% to 75 weight-%; preferably from 5 to 70 weight-%, more preferably 6 to 50 weight-%, even more preferably 7 to 45 weight-% and especially 10 to 40 weight-%;
renewable alkane content (w(c)) is from 0.1 weight-% to 97 weight-%, such as 10 weight-% to 90 weight-%; preferably from 25 to 80 weight-%, more preferably 26 to 70 weight-%, even more preferably 27 to 68 weight-% and especially 30 to 65 weight-%;
the remainder, if w(a)+w(b)+w(c)<100 weight-%, being fossil diesel fuel and/or one or more additives and, in some embodiments, unmentioned further components, with the provision that the content of fossil diesel fuel is no more than 50 weight-% and preferably less than 50 weight-%, more preferably 40 weight-% or less, even more preferably 30 weight-% or less, particularly preferably 20 weight-% or less, especially preferably 10 weight-% or less, or even 5 weight-% or less and most preferably 0 weight-%, i.e. fossil diesel fuel being completely absent. In some embodiments, the content of fossil diesel fuel is in the range of from 0.1 weight-% or more, 1 weight-% or more, 2 weight-% or more, 3 weight-% or more, 4 weight-% or more, 5 weight-% or more, 6 weight-% or more, 7 weight-% or more, 8 weight-% or more, 9 weight-% or more, 10 weight-% or more and 50 weight-% or less, 45 weight-% or less, 40 weight-% or less, 35 weight-% or less, 30 weight-% or less, 25 weight-% or less, 20 weight-% or less or 15 weight-% or less.
The content of additives, i.e. the content of the sum of all additives, is 0 to 10 weight-%, preferably 0.1 to 10 weight-%, more preferably 0.1 to 3 weight-% and typically in the range of 0.5 to 2 weight-%.

It is also preferred that the ratio of renewable alkane content to biodiesel content, w(c)/w(b), is greater than 1.0, more preferably in the range of 1.2 to 4.0, even more preferably 1.5 to 3.5.

Also preferred is that the ratio of biodiesel content and solketal content, w(b)/w(a), is in the range of 1.5 to 10.0, more preferably in the range of 2.0 to 8.0, even more preferably 2.5 to 7.5, so as, in a specific embodiment 2.5 to 5.0 or, in another specific embodiment, 3.0 to 7.0 or, in yet another specific embodiment 4.0 to 8.0.

The following table summarizes relative amounts of components according to further preferred embodiments according to the invention.

TABLE 1

| | Solketal, | Biodiesel, | Renewable | | Total |
|---|---|---|---|---|---|
| Specific | w(a) | w(b) | alkane, w(c) | Fossil diesel, | Additives |
| Embodiment | (wt. %) | (wt. %) | (wt. %) | w(d), (wt. %) | (wt. %) |
| A1 | 0.1-20.0 | 2.0-85.0 | 0.1-97.0 | 0.0-50.0 | 0.0-10.0 |
| A2 | 0.5-15.0 | 3.0-80.0 | 10.0-90.0 | 0.0-50.0 | 0.0-10.0 |
| A3 | 1.0-10.0 | 5.0-70.0 | 25.0-80.0 | 0.0-50.0 | 0.0-10.0 |
| A4 | 3.0-8.0 | 6.0-50.0 | 26.0-70.0 | 0.0-50.0 | 0.0-10.0 |
| A5 | 4.0-7.0 | 7.0-45.0 | 27.0-68.0 | 0.0-50.0 | 0.0-10.0 |
| A6 | 4.0-6.0 | 10.0-40.0 | 30.0-65.0 | 0.0-50.0 | 0.0-10.0 |

The above table specifies broad ranges for fossil fuel and additives to reflect the fact that these components are optional components and need not be provided in a particular relative amount. As far as fossil diesel fuel is concerned, the specified maximum content reflects the fact that the present invention aims to provide a replacement for fossil diesel fuel. Incorporating even greater amounts of fossil diesel would contradict this aspect of the present invention. It is of course preferred that lower amounts of fossil fuel are contained. Any of the above compositions A1-A5 is preferably characterized by the relative amounts specified for the other components but contains only smaller amounts of fossil diesel, such as 40 weight-% or less, 30 weight-% or less, 20 weight-% or less, 10 weight-% or less, 10 weight-% or less, or even 5 weight-%, and most preferably 0 weight-%. This is illustrated by the following table for the highly preferred range of 5 weight-% or less. The same logic applies for the other fossil fuel amounts specified herein above and below.

TABLE 2

| | Solketal, | Biodiesel, | Renewable | | Total |
|---|---|---|---|---|---|
| Specific | w(a) | w(b) | alkane, w(c) | Fossil diesel, | Additives |
| Embodiment | (wt. %) | (wt. %) | (wt. %) | w(d), (wt. %) | (wt. %) |
| A1′ | 0.1-20.0 | 2.0-85.0 | 0.1-96.9 | 0.0-5.0 | 0.0-10.0 |
| A2′ | 0.5-15.0 | 3.0-80.0 | 10.0-90.0 | 0.0-5.0 | 0.0-10.0 |
| A3′ | 1.0-10.0 | 5.0-70.0 | 25.0-80.0 | 0.0-5.0 | 0.0-10.0 |
| A4′ | 3.0-8.0 | 6.0-50.0 | 26.0-70.0 | 0.0-5.0 | 0.0-10.0 |
| A5′ | 4.0-7.0 | 7.0-45.0 | 27.0-68.0 | 0.0-5.0 | 0.0-10.0 |
| A6′ | 4.0-6.0 | 10.0-40.0 | 30.0-65.0 | 0.0-5.0 | 0.0-10.0 |

The above tables specify a broad range of 0.0-10.0 weight-% for additives in order to make it clear that there is no particular restriction on the relative amounts of additives to that may be employed. If a specific additive is employed, its relative amount will be selected such that the desired functionality of the additive is effectively achieved, which of course depends crucially on the type of additive and the type of functionality to be accomplished. The skilled person will be able to select appropriate relative amounts based on common general knowledge, indications provided by manufacturers and, if necessary, simple routine tests.

According to a specific embodiment (B) of the invention, the relative amount of renewable alkane is relatively high (within the above-mentioned ranges), typically higher than the biodiesel content. The following table illustrates some compositions of this embodiments.

TABLE 3

| | Solketal, | Biodiesel, | Renewable | | Total |
|---|---|---|---|---|---|
| Specific | w(a) | w(b) | alkane, w(c) | Fossil diesel, | Additives, |
| Embodiment | (wt. %) | (wt. %) | (wt. %) | w(d), (wt. %) | w(e), (wt. %) |
| B1 | 2.5-10.0 | 20.0-45.0 | 45.0-75.0 | 0-40.0 | 0-10.0 |
| B2 | 3.0-8.0 | 25.0-45.0 | 45.0-70.0 | 0-40.0 | 0-10.0 |
| B3 | 3.5-7.0 | 25.0-40.0 | 50.0-70.0 | 0-20.0 | 0-10.0 |
| B4 | 4.0-6.0 | 30.0-40.0 | 55.0-65.0 | 0-5.0 | 0-10.0 |
| B5 | 4.0-6.0 | 32.5-37.5 | 57.5-62.5 | 0-1.0 | 0-10.0 |
| B6 | 5 | 35 | 60 | 0 | 0 |

According to another specific embodiment (C), the relative amount of renewable alkane may be even higher, as illustrated by the following table.

TABLE 4

| | Solketal, | Biodiesel, | Renewable | | Total |
|---|---|---|---|---|---|
| Specific | w(a) | w(b) | alkane, w(c) | Fossil diesel, | Additives, |
| Embodiment | (wt. %) | (wt. %) | (wt. %) | w(d), (wt. %) | w(e), (wt. %) |
| C1 | 2.5-10.0 | 10.0-35.0 | 55.0-85.0 | 0-40.0 | 0-10.0 |
| C2 | 3.0-8.0 | 15.0-35.0 | 55.0-80.0 | 0-40.0 | 0-10.0 |
| C3 | 3.5-7.0 | 15.0-30.0 | 60.0-80.0 | 0-20.0 | 0-10.0 |
| C4 | 4.0-6.0 | 20.0-30.0 | 65.0-75.0 | 0-5.0 | 0-10.0 |
| C5 | 4.0-6.0 | 22.5-27.5 | 67.5-72.5 | 0-1.0 | 0-10.0 |
| C6 | 5 | 25 | 70 | 0 | 0 |

According to a further embodiment (D), when compared to the above embodiment (B), the relative amounts of renewable alkane and biodiesel may both be lower. This embodiment is illustrated by the following table.

TABLE 5

| | Solketal, | Biodiesel, | Renewable | | Total |
|---|---|---|---|---|---|
| Specific | w(a) | w(b) | alkane, w(c) | Fossil diesel, | Additives, |
| Embodiment | (wt. %) | (wt. %) | (wt. %) | w(d), (wt. %) | w(e), (wt. %) |
| D1 | 4.5-20.0 | 15.0-45.0 | 25.0-65.0 | 0-40.0 | 0-10.0 |
| D2 | 5.0-15.0 | 20.0-40.0 | 30.0-60.0 | 0-40.0 | 0-10.0 |
| D3 | 7.0-13.0 | 22.0-37.0 | 40.0-60.0 | 0-20.0 | 0-10.0 |
| D4 | 8.0-12.0 | 25.0-35.0 | 45.0-55.0 | 0-20.0 | 0-10.0 |
| D5 | 9.0-11.0 | 27.5-32.5 | 47.5-52.5 | 0-20.0 | 0-10.0 |
| D6 | 10 | 30 | 50 | 10 | 0 |

Another specific embodiment (E) is characterized by compositions as described in the following table.

TABLE 6

| | Solketal, | Biodiesel, | Renewable | | Total |
|---|---|---|---|---|---|
| Specific | w(a) | w(b) | alkane, w(c) | Fossil diesel, | Additives, |
| Embodiment | (wt. %) | (wt. %) | (wt. %) | w(d), (wt. %) | w(e), (wt. %) |
| E1 | 4.5-20.0 | 25.0-55.0 | 25.0-65.0 | 0-40.0 | 0-10.0 |
| E2 | 5.0-15.0 | 30.0-50.0 | 30.0-60.0 | 0-40.0 | 0-10.0 |
| E3 | 7.0-13.0 | 32.0-47.0 | 40.0-60.0 | 0-20.0 | 0-10.0 |
| E4 | 8.0-12.0 | 35.0-45.0 | 45.0-55.0 | 0-10.0 | 0-10.0 |
| E5 | 9.0-11.0 | 37.5-42.5 | 47.5-52.5 | 0-10.0 | 0-10.0 |
| E6 | 10 | 40 | 50 | 0 | 0 |

Yet another specific embodiment (F) is characterized by the compositions shown in the table below.

TABLE 7

| | Solketal, | Biodiesel, | Renewable | | Total |
|---|---|---|---|---|---|
| Specific | w(a) | w(b) | alkane, w(c) | Fossil diesel, | Additives, |
| Embodiment | (wt. %) | (wt. %) | (wt. %) | w(d), (wt. %) | w(e), (wt. %) |
| F1 | 14-28.0 | 25.0-55.0 | 25.0-65.0 | 0-40.0 | 0-10.0 |
| F2 | 15.0-25.0 | 30.0-50.0 | 30.0-60.0 | 0-40.0 | 0-10.0 |
| F3 | 17.0-23.0 | 32.0-47.0 | 40.0-60.0 | 0-20.0 | 0-10.0 |
| F4 | 18.0-22.0 | 35.0-45.0 | 45.0-55.0 | 0-10.0 | 0-10.0 |
| F5 | 19.0-21.0 | 37.5-42.5 | 47.5-52.5 | 0-10.0 | 0-10.0 |
| F6 | 20 | 40 | 40 | 0 | 0 |

Density is a characteristic of diesel fuel compositions of considerable importance. The present invention therefore relates in particular to diesel fuel compositions, wherein the density is within a predetermined target range. This can be the current density range specified in EN 590, i.e. 820 to 845 kg/m³, or it can be a different or broader range that may be in accordance with the specifications in other jurisdictions or it may take into account future amendments of EN 590. Hence, according to further embodiments, density may be in the range of 810 to 845 kg/m³, or even 800 to 845 kg/m³. Likewise, the diesel fuel compositions of the invention may comply with the density requirements of any other industrial norm originating from other countries that is applicable to diesel fuel compositions containing renewable components, such as Dirjen Migas Standard 185.K/HK.02/DJM/2022 of Indonesia.

Generally, density may be estimated relying on the following basic equation (I):

$$Density = [ ( w ( a ) \times 1063 ) + ( w ( b ) \times 885 ) + ( w ( c ) \times 780 ) + ( w ( d ) \times 825 ) + ( w ( e ) \times d ( e ) ) ] / ( 100 ) \qquad ( I )$$

or, in general form, equation (I-1):

$$( I - 1 )$$

$$Density = [ ( w ( a ) \times d ( a ) ) + ( w ( b ) \times d ( b ) ) + ( w ( c ) \times d ( c ) ) + ( w ( d ) \times d ( d ) ) + ( w ( e ) \times d ( e ) ) ] / ( 100 )$$

wherein
the relative amount in wt. % of solketal is w(a),
the relative amount in wt. % of biodiesel is w(b),
the relative amount in wt. % of renewable alkane is w(c),
the relative amount in wt. % of fossil diesel is w(d),
the relative amount in wt. % of additives is w(e), and
the density of the solketal is d(a), it is 1063 kg/m³,
the density of the biodiesel is d(b),
the density of the renewable alkane is d(c),
the density of the fossil diesel is d(d),
the average density of the additives is d(e), and
wherein the densities of solketal, biodiesel, renewable alkane and diesel are taken in equation (I) as 1063 kg/m³, 885 kg/m³, 780 kg/m³ and 825 kg/m³, respectively. These values can be suitably adjusted if a component with different density is intended to be used. The densities for biodiesel and renewable alkane may, for instance, vary by ±3% or even ±5%. The density for fossil diesel may for instance vary from 820 kg/m³ to 845 kg/m³.

If the diesel fuel composition of the invention must exhibit a density falling within a particular target range (e.g., originating from an industrial norm), the diesel fuel composition of the invention should comply with the following equation (I′) or (I′-1):

$$LDL \leq [ ( w ( a ) \times 1063 ) + ( w ( b ) \times 885 ) + ( w ( c ) \times 780 ) + ( w ( d ) \times 825 ) + ( w ( e ) \times d ( e ) ) ] / ( 100 ) \leq UDL \qquad ( {I}^{′} )$$

$$( {I}^{′} - 1 )$$

$$LDL \leq [ ( w ( a ) \times d ( a ) ) + ( w ( b ) \times d ( b ) ) + ( w ( c ) \times d ( c ) ) + ( w ( d ) \times d ( d ) ) + ( w ( e ) \times d ( e ) ) ] / ( 100 ) \leq UDL$$

In the above equations (I′) and (I′-1), LDL and UDL stand for lower density limit and upper density limit, respectively. The lower density limit may for instance be 800, 810, 815 or 820 kg/m³. The upper density limit may for instance be 845 or 880 kg/m³. The present invention pertains inter alia to the diesel fuel compositions described hereinabove or below, for which at least one of the above equations (I′) and/or (I′-1) is fulfilled for the target density range, such as the density ranges derivable from the above lower and upper density limits.

Density of the fuel part formed by the main components (i.e. without the additive(s)) can be expressed by the following modified equations (Ia) and (Ia-1):

$$Density = [ \text{} ( w ( a ) \times 1063 ) + ( w ( b ) \times 885 ) + ( w ( c ) \times 780 ) + ( w ( d ) \times 825 ) ] / \text{} ( 100 - w ( e ) ) \qquad ( Ia )$$

$$Density = [ ( w ( a ) \times d ( a ) ) + ( w ( b ) \times d ( b ) ) + ( w ( c ) \times d ( c ) ) + ( w ( d ) \times d ( d ) ) ] / ( 100 - w ( e ) ) \qquad ( Ia - 1 )$$

If, in some embodiments, unmentioned further components are present, the following equations (Ib) or (Ib-1) should be used instead of the above equations:

$$Density = [ ( w ( a ) \times 1063 ) + ( w ( b ) \times 885 ) + ( w ( c ) \times 780 ) + ( w ( d ) \times 825 ) ] / \text{} w ( a ) + w ( b ) + w ( c ) + w ( d ) ) \qquad ( Ib )$$

$$Density = [ \text{} ( w ( a ) \times d ( a ) ) + ( w ( b ) \times \text{} d ( \text{} b ) ) + ( w ( c ) \times d ( c ) ) + \text{} ( w ( d ) \times d ( d ) ) ] / ( w ( a ) + ( w ( b ) + w ( c ) + w ( d ) ) \qquad ( Ib - 1 )$$

Amount, type and thus density of the additives may be selected individually according to specific requirements. The impact of the additive component on the total density can therefore not be taken into account prior to selection of type and amount of additive(s).

However, additives are typically used in relatively small amounts, so that their impact on density is not so high. By consequence, in order to comply with density requirements, it is a reasonable approximation to select the amounts of the main components such that the following equation (II) or (II-1) is fulfilled:

$$820 \leq [ \text{} ( w ( a ) \times 1063 ) + ( w ( b ) \times 885 ) + ( w ( c ) \times 780 ) + ( w ( d ) \times 825 ) ] / \text{} ( 100 - w ( e ) ) \leq 845 \qquad ( II )$$

$$820 \leq [ ( w ( a ) \times d ( a ) ) + ( w ( b ) \times d ( b ) ) + ( w ( c ) \times d ( c ) ) + ( w ( d ) \times d ( d ) ) ] / \text{} ( 100 - w ( e ) ) \leq 845 \qquad ( II - 1 )$$

Likewise, if alternative density ranges are to be fulfilled, suitably modified versions of equation (II) may be applied, such as the following equations (IIa), (IIb), (IIc) and (IId) as well as (IIa-1), (IIb-1), (IIc-1) and (IId-1), respectively:

$$810 \leq [ \text{} ( w ( a ) \times 1063 ) + ( w ( b ) \times 885 ) + ( w ( c ) \times 780 ) + ( w ( d ) \times 825 ) ] / \text{} ( 100 - w ( e ) ) \leq 845 \qquad ( IIa )$$

$$800 \leq [ \text{} ( w ( a ) \times 1063 ) + ( w ( b ) \times 885 ) + ( w ( c ) \times 780 ) + ( w ( d ) \times 825 ) ] / \text{} ( 100 - w ( e ) ) \leq 845 \qquad ( IIb )$$

$$815 \leq [ \text{} ( w ( a ) \times 1063 ) + ( w ( b ) \times 885 ) + ( w ( c ) \times 780 ) + ( w ( d ) \times 825 ) ] / \text{} ( 100 - w ( e ) ) \leq 880 \qquad ( IIc )$$

$$LDL \leq [ \text{} ( w ( a ) \times 1063 ) + ( w ( b ) \times 885 ) + ( w ( c ) \times 780 ) + ( w ( d ) \times 825 ) ] / \text{} ( 100 - w ( e ) ) \leq UDL \qquad ( IId )$$

$$810 \leq [ ( w ( a ) \times d ( a ) ) + ( w ( b ) \times d ( b ) ) + ( w ( c ) \times d ( c ) ) + ( w ( d ) \times d ( d ) ) ] / \text{} ( 100 - w ( e ) ) \leq 845 \qquad ( IIa - 1 )$$

$$800 \leq [ ( w ( a ) \times d ( a ) ) + \text{} ( w ( b ) \times d ( b ) ) + \text{} ( w ( c ) \times d ( c ) ) + ( w ( d ) \times d ( d ) ) ] / \text{} ( 100 - w ( e ) ) \leq 845 \qquad ( IIb - 1 )$$

$$815 \leq [ ( w ( a ) \times d ( a ) ) + ( w ( b ) \times d ( b ) ) + ( w ( c ) \times d ( c ) ) + ( w ( d ) \times d ( d ) ) ] / \text{} ( 100 - w ( e ) ) \leq 880 \qquad ( IIc - 1 )$$

$$LDL \leq [ ( w ( a ) \times d ( a ) ) + ( w ( b ) \times d ( b ) ) + ( w ( c ) \times d ( c ) ) + ( w ( d ) \times d ( d ) ) ] / ( 100 - w ( e ) ) \leq UDL \qquad ( IId - 1 )$$

In the above equations (IId) and (IId-1), LDL and UDL stand for lower density limit and upper density limit, respectively. If the fuel composition of the invention is to be adapted to the density requirements of another industrial norm, the respective limits of the allowed density range may be inserted as LDL and UDL in the above equations.

In embodiments containing unmentioned further components, the above equations (II) to (IId-1) may be suitably adapted by replacing the denominator (100−w(e)) by the denominator (w(a)+(w(b)+w(c)+w(d)) of the above equations (Ib) and (Ib-1).

Suitable relative amounts of the individual components may be determined taking the following approach: assuming density is primarily determined by the main components of the diesel composition, the influence of the additives on density is disregarded in a first step by assuming that no additive is present, i.e., w(e)=0. The above equations (II) to (IId-1) will then simplify as follows:

$$820 \leq [ \text{} ( w ( a ) \times 1063 ) + ( w ( b ) \times 885 ) + ( w ( c ) \times 780 ) + ( w ( d ) \times 825 ) ] / \text{} ( 100 ) \leq \text{} 845 \qquad ( {II}^{′} )$$

$$820 \leq [ ( w ( a ) \times d ( a ) ) + ( w ( b ) \times d ( b ) ) + ( w ( c ) \times d ( c ) ) + ( w ( d ) \times d ( d ) ) ] / ( 100 ) \leq 845 \qquad ( {II}^{′} - 1 )$$

$$810 \leq [ \text{} ( w ( a ) \times 1063 ) + ( w ( b ) \times 885 ) + ( w ( c ) \times 780 ) + ( w ( d ) \times 825 ) ] / \text{} ( 100 ) \leq \text{} 845 \qquad ( {IIa}^{′} )$$

$$800 \leq [ \text{} ( w ( a ) \times 1063 ) + ( w ( b ) \times 885 ) + ( w ( c ) \times 780 ) + ( w ( d ) \times 825 ) ] / \text{} ( 100 ) \leq \text{} 845 \qquad ( {IIb}^{′} )$$

$$815 \leq [ \text{} ( w ( a ) \times 1063 ) + ( w ( b ) \times 885 ) + ( w ( c ) \times 780 ) + ( w ( d ) \times 825 ) ] / \text{} ( 100 ) \leq \text{} 880 \qquad ( {IIc}^{′} )$$

$$LDL \leq [ \text{} ( w ( a ) \times 1063 ) + ( w ( b ) \times 885 ) + ( w ( c ) \times 780 ) + ( w ( d ) \times 825 ) ] / \text{} ( 100 ) \leq \text{} UDL \qquad ( {IId}^{′} )$$

$$810 \leq [ ( w ( a ) \times d ( a ) ) + ( w ( b ) \times d ( b ) ) + ( w ( c ) \times d ( c ) ) + ( w ( d ) \times d ( d ) ) ] / ( 100 ) \leq 845 \qquad ( {IIa}^{′} - 1 )$$

$$800 \leq [ ( w ( a ) \times d ( a ) ) + ( w ( b ) \times d ( b ) ) + ( w ( c ) \times d ( c ) ) + ( w ( d ) \times d ( d ) ) ] / ( 100 ) \leq 845 \qquad ( {IIb}^{′} - 1 )$$

$$815 \leq [ ( w ( a ) \times d ( a ) ) + ( w ( b ) \times d ( b ) ) + ( w ( c ) \times d ( c ) ) + ( w ( d ) \times d ( d ) ) ] / ( 100 ) \leq 880 \qquad ( {IIc}^{′} - 1 )$$

$$LDL \leq [ ( w ( a ) \times d ( a ) ) + ( w ( b ) \times d ( b ) ) + ( w ( c ) \times d ( c ) ) + ( w ( d ) \times d ( d ) ) ] / ( 100 ) \leq UDL \qquad ( {IId}^{′} - 1 )$$

The present invention inter alia relates to the diesel compositions with the components and relative amounts therefore as described hereinabove and below, which additionally fulfil the conditions of at least one of the above equations (II) to (IId-1) or (II′) to (IId′-1).

Density (expressed in kg/m³) may then be estimated based on the following simplified equation (Ib) or (Ib-1):

$$Density = [ \text{} ( w ( a ) \times 1063 ) + ( w ( b ) \times 885 ) + ( w ( c ) \times 780 ) + ( w ( d ) \times 825 ) ] / \text{} ( 100 ) \qquad ( Ib )$$

$$Density = [ \text{} ( w ( a ) \times d ( a ) ) + ( w ( b ) \times d ( b ) ) + \text{} ( w ( c ) \times d ( c ) ) + ( w ( d ) \times d ( d ) ) ] / ( 100 ) \qquad ( Ib - 1 )$$

Relying on equation (Ib) or (Ib-1) and additionally the following further equation (IIIa):

$$100 = w ( a ) + w ( b ) + w ( c ) + w ( d ) \qquad ( IIIa )$$

suitable relative amounts of the main components (i.e., the components other than the additives) can be determined by pre-selecting relative amounts for two of the main components a, b, c or d, converting equation (IIIa) and inserting the same together with the pre-selected relative amounts into formula (Ib) or (Ib-1). This equation may then solved by inserting the lower or upper end of the permissible density range.

That is, formula (Illa) can be transformed into formula (IIIb) and inserted into equation (Ib) or (Ib-1) in the following manner to yield equation (Ic) or (Ic-1) and ultimately equation (Id) or (Id-1):

$$w ( c ) = 100 - w ( a ) - w ( b ) - w ( d ) \qquad ( IIIb )$$

$$Density = [ \text{} ( w ( a ) \times 1063 ) + ( w ( b ) \times 885 ) + ( ( 100 - w ( a ) - ( w ( b ) - w ( d ) ) \times 780 ) + ( w ( d ) \times 825 ) ] / ( 100 ) \qquad ( Ic )$$

$$Density = [ \text{} ( w ( a ) \times d ( a ) ) + ( w ( b ) \times d ( b ) ) + ( ( 100 - w ( a ) - ( w ( b ) - w ( d ) ) \times d ( c ) ) + ( w ( d ) \times d ( d ) ) ] / ( 100 ) \qquad ( Ic - 1 )$$

$$w ( d ) = [ ( 100 \times Density ) - ( w ( a ) \times 1063 ) - ( w ( b ) \times 885 ) - ( ( 100 - w ( a ) - ( w ( b ) ) \times 780 ) ] / ( 825 - 780 ) ] \qquad ( Id )$$

$$w ( d ) = [ ( 100 \times Density ) - ( w ( a ) \times d ( a ) ) - ( w ( b ) \times d ( b ) ) - ( ( 100 - w ( a ) - ( w ( b ) ) \times d ( c ) ) ] / ( d ( d ) - d ( c ) ) ] \qquad ( Id - 1 )$$

Using w(d) as obtained with equation (Id) or (Id-1), w(c) can be calculated using the equation (IIIb).

For example, assuming w(a) is 3 wt. % and w(b) is 7 wt. %, equation (Illa) may be converted into the following form:

$$w ( c ) = 100 - 3 - 7 - w ( d ) = 90 - w ( d )$$

Inserting this together with a desired lower limit of 820 into equation (Ib), the following equation can be formed:

$$820 = [ ( 3 \times 1063 ) + ( 7 \times 885 ) + ( ( 90 - w ( d ) ) \times 780 ) + ( w ( d ) \times 825 ) ] / ( 100 )$$

This equation may be transformed into

$$w ( d ) = [ ( 820 \times 100 ) - ( 3 \times 1063 ) - ( 7 \times 885 ) - ( 90 \times 780 ) ] / ( 825 - 780 ) = 54$$

w(c) can be obtained by inserting this result into the above equation w(c)=90−w(d) to yield

$$w ( c ) = 90 - 54 = 36.$$

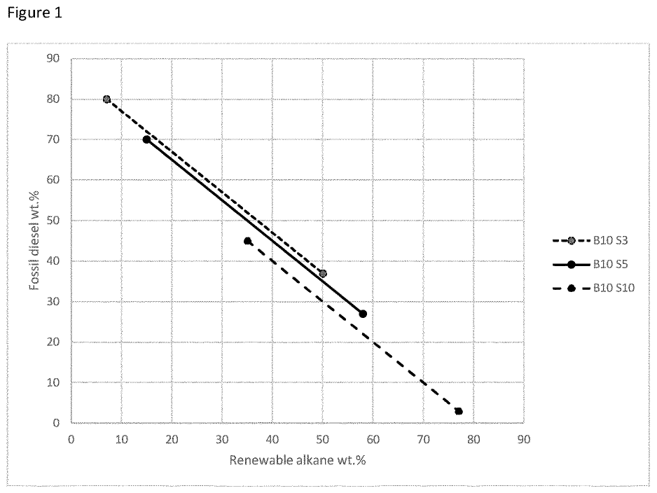

The results of further model calculations are provided in the tables below and attached FIG. 1 in the form of tables and graphical representations, respectively.

If one or more additives is/are also present, its/their relative amount is/are usually predetermined by the function to be achieved by the respective additive. If the density of the additive(s) is/are known, the above equations may be suitably adapted. For example, the basic equation (I) will take the following form if a single additive having density d′(e) is present in a relative amount of w′(e):

$$Density = [ ( w ( a ) \times 1063 ) + ( w ( b ) \times 885 ) + ( w ( c ) \times 780 ) + ( w ( d ) \times 825 ) + ( {w}^{′} ( e ) \times {d}^{′} ( e ) ) ] / ( 100 )$$

If multiple additives of known densities are employed, equation (I) may be used relying on the average density of the additives. Said average density may be calculated as the weight-average density based on the following equation (IV):

$$d ( e ) = [ {\sum }_{k = 1}^{n} ( {w}_{k} ( e ) \times {d}_{k} ( e ) ) ] / [ {\sum }_{k = 1}^{n} ( {w}_{k} ( e ) ) ] \qquad ( IV )$$

wherein
d(e) is the average density
wₖ(e) is the relative amount of the kth additive,
dₖ(e) is the density of the kth additive,
n is the number of additives.

If part or all of the information on density of the additives is missing, the above approach may be taken, but relying on equation (Ia) instead of (Ib). Relative amounts may be selected such that the estimated density is approximately in the middle of the target range. There is a high likelihood that the true density of the final fuel composition after addition of the additive(s) will be within the target range.

Further adjustments may be made, wherein a diesel fuel composition is prepared, density of the same is determined, suitable adjustments are made in relative amounts, depending on the deviation:
if the density is below the target value, the relative amount of renewable alkane may be decreased while the relative amount of biodiesel and/or solketal is increased;
if the density is above the target value, the relative amount of renewable alkane may be increased while the relative amount of biodiesel and/or solketal is decreased.

A new diesel fuel composition may then be prepared based on the modified relative amounts and density of the same may be determined. If necessary, the above steps may be repeated one or more times until the desired target densities accomplished.

Based on the above, preferred embodiments of the present invention provide diesel fuel compositions with the following compositions:
a) Compositions with solketal content of 0.1-1.0 weight-% and density in the range of 820-845 kg/m³: compositions falling within the amount ranges specified in the table below and additionally satisfying the equation

$$820 \leq [ \text{} ( w ( a ) \times 1063 ) + ( w ( b ) \times 885 ) + ( w ( c ) \times 780 ) + ( w ( d ) \times 825 ) ] / \text{} 100 \leq \text{} 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / \text{} ( 100 - w ( e ) ) \leq \text{} 845.$$

TABLE 8

| | Solketal, | Biodiesel, | Renewable | | Total |
|---|---|---|---|---|---|
| Specific | w(a) | w(b) | alkane, w(c) | Fossil diesel, | Additives |
| Embodiment | (wt. %) | (wt. %) | (wt. %) | w(d), (wt. %) | (wt. %) |
| J1 | 0.1-1.0 | 14-20 | 29-43 | 36-50 | 0.0-10 |
| J2 | 0.1-1.0 | 20-30 | 19-56 | 13-50 | 0.0-10 |
| J3 | 0.1-1.0 | 30-40 | 9-65 | 0.0-50 | 0.0-10 |
| J4 | 0.1-1.0 | 40-50 | 9-60 | 0.0-50 | 0.0-10 |
| J5 | 0.1-1.0 | 50-60 | 24-49 | 0.0-25 | 0.0-10 |
| J6 | 0.1-1.0 | 60-62 | 36-40 | 0.0-4 | 0.0-10 |
| J7 | 0.1-1.0 | 14-20 | 29-43 | 36.0-50 | 0.1-10 |
| J8 | 0.1-1.0 | 20-30 | 19-56 | 13.0-50 | 0.1-10 |
| J9 | 0.1-1.0 | 30-40 | 9-65 | 0.0-50 | 0.1-10 |
| J10 | 0.1-1.0 | 40-50 | 9-60 | 0.0-50 | 0.1-10 |
| J11 | 0.1-1.0 | 50-59 | 24-49 | 0.0-25 | 0.1-10 |
| J12 | 0.1-1.0 | 60-62 | 36-40 | 0.0-4 | 0.1-10 |
| J13 | 0.1-1.0 | 30-40 | 9-65 | 0.1-50 | 0.0-10 |
| J14 | 0.1-1.0 | 40-50 | 9-60 | 0.1-50 | 0.0-10 |
| J15 | 0.1-1.0 | 50-59 | 24-49 | 0.1-25 | 0.0-10 |
| J16 | 0.1-1.0 | 60-62 | 36-40 | 0.1-4 | 0.0-10 |

b) Compositions with solketal content of 0.1-1.0 weight-% and density in the range of 810-845 kg/m³: compositions falling within the amount ranges specified for embodiments J17 to J35 below and additionally satisfying the equation

$$810 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$810 \leq [ ( w ( a ) \times 1063 ) + ( w ( b ) \times 885 ) + ( w ( c ) \times 780 ) + ( w ( d ) \times 825 ) ] / \text{} ( 100 - w ( e ) ) \leq 845 .$$

TABLE 9

| | Solketal, | Biodiesel, | Renewable | | Total |
|---|---|---|---|---|---|
| Specific | w(a) | w(b) | alkane, w(c) | Fossil diesel, | Additives |
| Embodiment | (wt. %) | (wt. %) | (wt. %) | w(d), (wt. %) | (wt. %) |
| J17 | 0.1-1.0 | 4-10 | 39-52 | 43-50 | 0.0-10 |
| J18 | 0.1-1.0 | 10-20 | 29-65 | 14-50 | 0.0-10 |
| J19 | 0.1-1.0 | 20-30 | 19-73 | 0.0-50 | 0.0-10 |
| J20 | 0.1-1.0 | 30-40 | 10-70 | 0.0-50 | 0.0-10 |
| J21 | 0.1-1.0 | 39-49 | 8-59 | 2-50 | 0.0-10 |
| J22 | 0.1-1.0 | 50-60 | 23-50 | 0.0-27 | 0.0-10 |
| J23 | 0.1-1.0 | 59-61 | 35-39 | 2-6 | 0.0-10 |
| J24 | 0.1-1.0 | 4-10 | 39-52 | 43-50 | 0.1-10 |
| J25 | 0.1-1.0 | 10-20 | 29-65 | 14-50 | 0.1-10 |
| J26 | 0.1-1.0 | 20-30 | 19-73 | 0.0-50 | 0.1-10 |
| J27 | 0.1-1.0 | 30-40 | 10-70 | 0.0-50 | 0.1-10 |
| J28 | 0.1-1.0 | 39-49 | 8-59 | 2-50 | 0.1-10 |
| J29 | 0.1-1.0 | 50-60 | 23-50 | 0.0-27 | 0.1-10 |
| J30 | 0.1-1.0 | 59-61 | 35-39 | 2-6 | 0.1-10 |
| J31 | 0.1-1.0 | 20-30 | 19-73 | 0.1-50 | 0.0-10 |
| J32 | 0.1-1.0 | 30-40 | 10-70 | 0.1-50 | 0.0-10 |
| J33 | 0.1-1.0 | 39-49 | 8-59 | 0.1-50 | 0.0-10 |
| J34 | 0.1-1.0 | 50-60 | 23-50 | 0.1-27 | 0.0-10 |
| J35 | 0.1-1.0 | 59-61 | 35-39 | 0.1-4 | 0.0-10 |

c) Compositions with solketal content of 0.1-1.0 weight-% and density in the range of 800-845 kg/m³: compositions falling within the amount ranges specified for embodiments J36 to J54 below and additionally satisfying the equation

$$800 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$800 \leq [ ( w ( a ) \times 1063 ) + ( w ( b ) \times 885 ) + ( w ( c ) \times 780 ) + ( w ( d ) \times 825 ) ] / \text{} ( 100 - w ( e ) ) \leq 845 .$$

TABLE 10

| | Solketal, | Biodiesel, | Renewable | | Total |
|---|---|---|---|---|---|
| Specific | w(a) | w(b) | alkane, w(c) | Fossil diesel, | Additives |
| Embodiment | (wt. %) | (wt. %) | (wt. %) | w(d), (wt. %) | (wt. %) |
| J36 | 0.1-1.0 | 0.1-10 | 39-74 | 15-50 | 0.0-10 |
| J37 | 0.1-1.0 | 10-20 | 29-83 | 0.0-50 | 0.0-10 |
| J37 | 0.1-1.0 | 20-30 | 19-80 | 0.0-50 | 0.0-10 |
| J38 | 0.1-1.0 | 30-40 | 10-70 | 0.0-50 | 0.0-10 |
| J39 | 0.1-1.0 | 40-50 | 10-59 | 1-49 | 0.0-10 |
| J40 | 0.1-1.0 | 50-60 | 23-50 | 0.0-27 | 0.0-10 |
| J41 | 0.1-1.0 | 60-62 | 37-39 | 1-4 | 0.0-10 |
| J42 | 0.1-1.0 | 0.1-10 | 39-74 | 15-50 | 0.1-10 |
| J43 | 0.1-1.0 | 10-20 | 29-83 | 0.0-50 | 0.1-10 |
| J44 | 0.1-1.0 | 20-30 | 19-80 | 0.0-50 | 0.1-10 |
| J45 | 0.1-1.0 | 30-40 | 10-70 | 0.0-50 | 0.1-10 |
| J46 | 0.1-1.0 | 40-50 | 10-59 | 1-49 | 0.1-10 |
| J47 | 0.1-1.0 | 50-60 | 23-50 | 0.0-27 | 0.1-10 |
| J48 | 0.1-1.0 | 60-62 | 37-39 | 1-4 | 0.1-10 |
| J49 | 0.1-1.0 | 10-20 | 29-83 | 0.1-50 | 0.1-10 |
| J50 | 0.1-1.0 | 20-30 | 19-80 | 0.1-50 | 0.0-10 |
| J51 | 0.1-1.0 | 30-40 | 10-70 | 0.1-50 | 0.0-10 |
| J52 | 0.1-1.0 | 40-50 | 10-59 | 1-49 | 0.0-10 |
| J53 | 0.1-1.0 | 50-60 | 23-50 | 0.1-27 | 0.0-10 |
| J54 | 0.1-1.0 | 60-62 | 37-39 | 0.1-4 | 0.0-10 |

d) Compositions with solketal content of 1.0-2.0 weight-% and density in the range of 820-845 kg/m³: compositions falling within the amount ranges specified for embodiments K1 to K16 below and additionally satisfying the equation

$$820 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / \text{} ( 100 - w ( e ) ) \leq 845 .$$

TABLE 11

| | Solketal, | Biodiesel, | Renewable | | Total |
|---|---|---|---|---|---|
| Specific | w(a) | w(b) | alkane, w(c) | Fossil diesel, | Additives |
| Embodiment | (wt. %) | (wt. %) | (wt. %) | w(d), (wt. %) | (wt. %) |
| K1 | 1.0-2.0 | 11-20 | 28-48 | 30-50 | 0.0-10 |
| K2 | 1.0-2.0 | 20-30 | 18-62 | 6-50 | 0.0-10 |
| K3 | 1.0-2.0 | 30-40 | 12-65 | 0.0-50 | 0.0-10 |
| K4 | 1.0-2.0 | 40-50 | 14-59 | 0.0-45 | 0.0-10 |
| K5 | 1.0-2.0 | 50-59 | 28-49 | 0.0-21 | 0.0-10 |
| K6 | 1.0-2.0 | 11-20 | 28-48 | 30-50 | 0.1-10 |
| K7 | 1.0-2.0 | 20-30 | 18-62 | 6-50 | 0.1-10 |
| K8 | 1.0-2.0 | 30-40 | 12-65 | 0.0-50 | 0.1-10 |
| K9 | 1.0-2.0 | 40-50 | 14-59 | 0.0-45 | 0.1-10 |
| K10 | 1.0-2.0 | 50-59 | 28-49 | 0.0-21 | 0.1-10 |
| K11 | 1.0-2.0 | 30-40 | 12-65 | 0.1-50 | 0.0-10 |
| K12 | 1.0-2.0 | 40-50 | 14-59 | 0.1-45 | 0.0-10 |
| K13 | 1.0-2.0 | 50-59 | 28-49 | 0.1-21 | 0.0-10 |
| K14 | 1.0-2.0 | 30-41.0 | 12-65 | 0.0-50 | 0.0-10 |
| K15 | 1.0-2.0 | 44.0-51.0 | 14-59 | 0.0-45 | 0.0-10 |
| K16 | 1.0-2.0 | 54.0-59 | 28-49 | 0.0-21 | 0.0-10 |

e) Compositions with solketal content of 1.0-2.0 weight-% and density in the range of 810-845 kg/m³: compositions falling within the amount ranges specified for embodiments K17 to K36 below and additionally satisfying the equation

$$810 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$810 \leq [ ( w ( a ) \times 1063 ) + ( w ( b ) \times 885 ) + ( w ( c ) \times 780 ) + ( w ( d ) \times 825 ) ] / \text{} ( 100 - w ( e ) ) \leq 845 .$$

TABLE 12

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| K17 | 1.0-2.0 | 2-10 | 38-57 | 31-50 | 0.0-10 |
| K18 | 1.0-2.0 | 10-20 | 28-71 | 7-50 | 0.0-10 |
| K19 | 1.0-2.0 | 20-30 | 19-75 | 0.0-50 | 0.0-10 |
| K20 | 1.0-2.0 | 30-40 | 12-69 | 0.0-50 | 0.0-10 |
| K21 | 1.0-2.0 | 39-49 | 13-58 | 2-47 | 0.0-10 |
| K22 | 1.0-2.0 | 49-58 | 27-48 | 2-23 | 0.0-10 |
| K23 | 1.0-2.0 | 2-10 | 38-57 | 31-50 | 0.1-10 |
| K24 | 1.0-2.0 | 10-20 | 28-71 | 7-50 | 0.1-10 |
| K25 | 1.0-2.0 | 20-30 | 19-75 | 0.0-50 | 0.1-10 |
| K26 | 1.0-2.0 | 30-40 | 12-69 | 0.0-50 | 0.1-10 |
| K27 | 1.0-2.0 | 39-49 | 13-58 | 2-47 | 0.1-10 |
| K28 | 1.0-2.0 | 49-58 | 27-48 | 2-23 | 0.1-10 |
| K29 | 1.0-2.0 | 20-30 | 19-75 | 0.1-50 | 0.0-10 |
| K30 | 1.0-2.0 | 30-40 | 12-69 | 0.1-50 | 0.0-10 |
| K31 | 1.0-2.0 | 39-49 | 13-58 | 0.1-45 | 0.0-10 |
| K32 | 1.0-2.0 | 49-58 | 27-48 | 0.1-21 | 0.0-10 |
| K33 | 1.0-2.0 | 20-31.0 | 19-75 | 0.0-50 | 0.0-10 |
| K34 | 1.0-2.0 | 34.0-42.0 | 12-69 | 0.0-50 | 0.0-10 |
| K35 | 1.0-2.0 | 44.0-52.0 | 13-58 | 0.0-45 | 0.0-10 |
| K36 | 1.0-2.0 | 54.0-58 | 27-48 | 0.0-21 | 0.0-10 |

f) Compositions with solketal content of 1.0-2.0 weight-% and density in the range of 800-845 kg/m³: compositions falling within the amount ranges specified for embodiments K37 to K16 below and additionally satisfying the equation

$$800 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$800 \leq [ ( w ( a ) \times 1063 ) + ( w ( b ) \times 885 ) + ( w ( c ) \times 780 ) + ( w ( d ) \times 825 ) ] / \text{} ( 100 - w ( e ) ) \leq 845 .$$

TABLE 13

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| K37 | 1.0-2.0 | 0.1-10 | 38-79 | 9-50 | 0.0-10 |
| K38 | 1.0-2.0 | 10-20 | 28-84 | 0.0-50 | 0.0-10 |
| K39 | 1.0-2.0 | 20-30 | 18-79 | 0.0-50 | 0.0-10 |
| K40 | 1.0-2.0 | 30-40 | 12-69 | 0.0-50 | 0.0-10 |
| K41 | 1.0-2.0 | 40-50 | 15-58 | 1-44 | 0.0-10 |
| K42 | 1.0-2.0 | 50-59 | 29-48 | 1-20 | 0.0-10 |
| K43 | 1.0-2.0 | 0.1-10 | 38-79 | 9-50 | 0.1-10 |
| K44 | 1.0-2.0 | 10-20 | 28-84 | 0.0-50 | 0.1-10 |
| K45 | 1.0-2.0 | 20-30 | 18-79 | 0.0-50 | 0.1-10 |
| K46 | 1.0-2.0 | 30-40 | 12-69 | 0.0-50 | 0.1-10 |
| K47 | 1.0-2.0 | 40-50 | 15-58 | 1-44 | 0.1-10 |
| K48 | 1.0-2.0 | 50-59 | 29-48 | 1-20 | 0.1-10 |
| K49 | 1.0-2.0 | 10-20 | 28-84 | 0.1-50 | 0.0-10 |
| K50 | 1.0-2.0 | 20-30 | 18-79 | 0.1-50 | 0.0-10 |
| K51 | 1.0-2.0 | 30-40 | 12-69 | 0.1-50 | 0.0-10 |
| K52 | 1.0-2.0 | 40-50 | 14-59 | 0.1-45 | 0.0-10 |
| K53 | 1.0-2.0 | 50-59 | 28-49 | 0.1-21 | 0.0-10 |
| K54 | 1.0-2.0 | 10-21.0 | 28-84 | 0.0-50 | 0.0-10 |
| K55 | 1.0-2.0 | 23.0-31.0 | 18-79 | 0.0-50 | 0.0-10 |
| K56 | 1.0-2.0 | 34.0-42.0 | 12-69 | 0.0-50 | 0.0-10 |
| K57 | 1.0-2.0 | 44.0-52.0 | 15-58 | 0.0-45 | 0.0-10 |
| K58 | 1.0-2.0 | 54.0-59 | 29-48 | 0.0-21 | 0.0-10 |

g) Compositions with solketal content of 2.0-3.0 weight-% and density in the range of 820-845 kg/m³: compositions falling within the amount ranges specified for embodiments L1 to L15 below and additionally satisfying the equation

$$820 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / \text{} ( 100 - w ( e ) ) \leq 845 .$$

TABLE 14

| | | | Renewable | Fossil | |
|---|---|---|---|---|---|
| Specific | Solketal, | Biodiesel, | alkane, | diesel, | Total |
| Embodi- | w(a) | w(b) | w(c) | w(d), | Additives |
| ment | (wt. %) | (wt. %) | (wt. %) | (wt. %) | (wt. %) |
| L1 | 2.0-3.0 | 9-10 | 37-40 | 47-50 | 0.0-10 |
| L2 | 2.0-3.0 | 10-20 | 27-54 | 23-50 | 0.0-10 |
| L3 | 2.0-3.0 | 20-30 | 17-67 | 0.0-50 | 0.0-10 |
| L4 | 2.0-3.0 | 30-40 | 13-67 | 0.0-50 | 0.0-10 |
| L5 | 2.0-3.0 | 40-50 | 19-58 | 0.0-39 | 0.0-10 |
| L6 | 2.0-3.0 | 50-56 | 33-48 | 0.0-15 | 0.0-10 |
| L7 | 2.0-3.0 | 9-10 | 37-40 | 47.0-50 | 0.1-10 |
| L8 | 2.0-3.0 | 10-20 | 27-54 | 23.0-50 | 0.1-10 |
| L9 | 2.0-3.0 | 20-30 | 17-67 | 0.0-50 | 0.1-10 |
| L10 | 2.0-3.0 | 30-40 | 13-67 | 0.0-50 | 0.1-10 |
| L11 | 2.0-3.0 | 40-50 | 19-58 | 0.0-39 | 0.1-10 |
| L12 | 2.0-3.0 | 50-56 | 33-48 | 0.0-15 | 0.1-10 |
| L13 | 2.0-3.0 | 20-30 | 17-67 | 0.1-50 | 0.0-10 |
| L14 | 2.0-3.0 | 30-40 | 13-67 | 0.1-50 | 0.0-10 |
| L15 | 2.0-3.0 | 40-50 | 19-58 | 0.1-39 | 0.0-10 |
| L16 | 2.0-3.0 | 50-56 | 33-48 | 0.1-15 | 0.0-10 |
| L17 | 2.0-3.0 | 30-41.0 | 13-67 | 0.0-50 | 0.0-10 |
| L18 | 2.0-3.0 | 44.0-51.0 | 19-58 | 0.0-39 | 0.0-10 |
| L19 | 2.0-3.0 | 54.0-56 | 33-48 | 0.0-15 | 0.0-10 |

h) Compositions with solketal content of 2.0-3.0 weight-% and density in the range of 810-845 kg/m³: compositions falling within the amount ranges specified for embodiments L20 to L39 below and additionally satisfying the equation

$$810 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$810 \leq [ ( w ( a ) \times 1063 ) + ( w ( b ) \times 885 ) + ( w ( c ) \times 780 ) + ( w ( d ) \times 825 ) ] / \text{} ( 100 - w ( e ) ) \leq 845 .$$

TABLE 15

| | | | Renewable | Fossil | |
|---|---|---|---|---|---|
| Specific | Solketal, | Biodiesel, | alkane, | diesel, | Total |
| Embodi- | w(a) | w(b) | w(c) | w(d), | Additives |
| ment | (wt. %) | (wt. %) | (wt. %) | (wt. %) | (wt. %) |
| L20 | 2.0-3.0 | 0.1-10 | 37-63 | 24-50 | 0.0-10 |
| L21 | 2.0-3.0 | 10-20 | 27-76 | 1.0-50 | 0.0-10 |
| L22 | 2.0-3.0 | 20-30 | 17-76 | 0.0-50 | 0.0-10 |
| L23 | 2.0-3.0 | 30-40 | 13-68 | 0.0-50 | 0.0-10 |
| L24 | 2.0-3.0 | 39-49 | 18-57 | 2-41 | 0.0-10 |
| L25 | 2.0-3.0 | 49-55 | 32-47 | 2-17 | 0.0-10 |
| L26 | 2.0-3.0 | 0.1-10 | 37-63 | 24.0-50 | 0.1-10 |
| L27 | 2.0-3.0 | 10-20 | 27-76 | 1.0-50 | 0.1-10 |
| L28 | 2.0-3.0 | 20-30 | 17-76 | 0.0-50 | 0.1-10 |
| L29 | 2.0-3.0 | 30-40 | 13-68 | 0.0-50 | 0.1-10 |
| L30 | 2.0-3.0 | 39-49 | 18-57 | 2-41 | 0.1-10 |
| L31 | 2.0-3.0 | 49-55 | 32-47 | 2-17 | 0.1-10 |
| L32 | 2.0-3.0 | 20-30 | 17-76 | 0.1-50 | 0.0-10 |
| L33 | 2.0-3.0 | 30-40 | 13-68 | 0.1-50 | 0.0-10 |
| L34 | 2.0-3.0 | 39-49 | 18-57 | 0.1-39.0 | 0.0-10 |
| L35 | 2.0-3.0 | 49-55 | 32-47 | 0.1-15.0 | 0.0-10 |
| L36 | 2.0-3.0 | 20-31.0 | 17-76 | 0.0-50 | 0.0-10 |
| L37 | 2.0-3.0 | 34.0-42.0 | 13-68 | 0.0-50 | 0.0-10 |
| L38 | 2.0-3.0 | 44.0-52.0 | 19-58 | 0.0-39 | 0.0-10 |
| L39 | 2.0-3.0 | 54.0-55 | 32-47 | 0.0-17 | 0.0-10 |

i) Compositions with solketal content of 2.0-3.0 weight-% and density in the range of 800-845 kg/m³: compositions falling within the amount ranges specified for embodiments L40 to L61 below and additionally satisfying the equation

$$800 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$800 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 16

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| L40 | 2.0-3.0 | 0.1-10 | 37-85 | 2-50 | 0.0-10 |
| L41 | 2.0-3.0 | 10-20 | 27-93 | 0.0-50 | 0.0-10 |
| L42 | 2.0-3.0 | 20-30 | 17-78 | 0.0-50 | 0.0-10 |
| L43 | 2.0-3.0 | 30-40 | 13-68 | 0.0-50 | 0.0-10 |
| L44 | 2.0-3.0 | 40-50 | 20-57 | 1-38 | 0.0-10 |
| L45 | 2.0-3.0 | 50-56 | 34-47 | 1-14 | 0.0-10 |
| L46 | 2.0-3.0 | 0.1-10 | 37-85 | 2.0-50 | 0.1-10 |
| L47 | 2.0-3.0 | 10-20 | 27-93 | 0.0-50 | 0.1-10 |
| L48 | 2.0-3.0 | 20-30 | 17-78 | 0.0-50 | 0.1-10 |
| L49 | 2.0-3.0 | 30-40 | 13-68 | 0.0-50 | 0.1-10 |
| L50 | 2.0-3.0 | 40-50 | 20-57 | 1-38 | 0.1-10 |
| L51 | 2.0-3.0 | 50-56 | 34-47 | 1-14 | 0.1-10 |
| L52 | 2.0-3.0 | 10-20 | 27-93 | 0.1-50 | 0.0-10 |
| L53 | 2.0-3.0 | 20-30 | 17-78 | 0.1-50 | 0.0-10 |
| L54 | 2.0-3.0 | 30-40 | 13-68 | 0.1-50 | 0.0-10 |
| L55 | 2.0-3.0 | 40-50 | 20-57 | 0.1-39 | 0.0-10 |
| L56 | 2.0-3.0 | 50-56 | 34-47 | 0.1-15 | 0.0-10 |
| L57 | 2.0-3.0 | 10-21.0 | 27-93 | 0.0-50 | 0.0-10 |
| L58 | 2.0-3.0 | 23.0-31.0 | 17-78 | 0.0-50 | 0.0-10 |
| L59 | 2.0-3.0 | 34.0-42.0 | 14-67 | 0.0-50 | 0.0-10 |
| L60 | 2.0-3.0 | 44.0-52.0 | 20-57 | 0.0-39 | 0.0-10 |
| L61 | 2.0-3.0 | 54.0-56 | 34-47 | 0.0-15 | 0.0-10 |

j) Compositions with solketal content of 3.0-4.0 weight-% and density in the range of 820-845 kg/m³: compositions falling within the amount ranges specified for embodiments M1 to M16 below and additionally satisfying the equation

$$820 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 17

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| M1 | 3.0-4.0 | 6-10 | 36-46 | 40-50 | 0.0-10 |
| M2 | 3.0-4.0 | 10-20 | 24-59 | 17-50 | 0.0-10 |
| M3 | 3.0-4.0 | 20-30 | 17-72 | 0.0-50 | 0.0-10 |
| M4 | 3.0-4.0 | 30-40 | 15-67 | 0.0-50 | 0.0-10 |
| M5 | 3.0-4.0 | 40-50 | 25-57 | 0.0-32 | 0.0-10 |
| M6 | 3.0-4.0 | 50-54 | 38-47 | 0.0-9 | 0.0-10 |
| M7 | 3.0-4.0 | 6-10 | 36-46 | 40-50 | 0.1-10 |
| M8 | 3.0-4.0 | 10-20 | 24-59 | 17-50 | 0.1-10 |
| M9 | 3.0-4.0 | 20-30 | 17-72 | 0.0-50 | 0.1-10 |
| M10 | 3.0-4.0 | 30-40 | 15-67 | 0.0-50 | 0.1-10 |
| M11 | 3.0-4.0 | 40-50 | 25-57 | 0.0-32 | 0.1-10 |
| M12 | 3.0-4.0 | 50-54 | 38-47 | 0.0-9 | 0.1-10 |
| M13 | 3.0-4.0 | 20-30 | 17-72 | 0.1-50 | 0.0-10 |
| M14 | 3.0-4.0 | 30-40 | 15-67 | 0.1-50 | 0.0-10 |
| M15 | 3.0-4.0 | 40-50 | 25-57 | 0.1-32 | 0.0-10 |
| M16 | 3.0-4.0 | 50-56 | 38-47 | 0.1-9 | 0.0-10 |

k) Compositions with solketal content of 3.0-4.0 weight-% and density in the range of 810-845 kg/m³: compositions falling within the amount ranges specified in the table below and additionally satisfying the equation

$$810 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$810 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 18

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| M17 | 3.0-4.0 | 5-9 | 35-45 | 42-52 | 0.0-10 |
| M18 | 3.0-4.0 | 10-20 | 26-59 | 17-50 | 0.0-10 |
| M19 | 3.0-4.0 | 20-30 | 17-68 | 0.0-50 | 0.0-10 |
| M20 | 3.0-4.0 | 29-39 | 14-66 | 2-50 | 0.0-10 |
| M21 | 3.0-4.0 | 39-49 | 24-56 | 2-34 | 0.0-10 |
| M22 | 3.0-4.0 | 50-54 | 39-46 | 0.0-7 | 0.0-10 |
| M23 | 3.0-4.0 | 5-9 | 35-45 | 42-52 | 0.1-10 |
| M24 | 3.0-4.0 | 10-20 | 26-59 | 17-50 | 0.1-10 |
| M25 | 3.0-4.0 | 20-30 | 17-68 | 0.0-50 | 0.1-10 |
| M26 | 3.0-4.0 | 29-39 | 14-66 | 2-50 | 0.1-10 |
| M27 | 3.0-4.0 | 39-49 | 24-56 | 2-34 | 0.1-10 |
| M28 | 3.0-4.0 | 50-54 | 39-46 | 0.0-7 | 0.1-10 |
| M29 | 3.0-4.0 | 20-30 | 17-68 | 0.1-50 | 0.0-10 |
| M30 | 3.0-4.0 | 29-39 | 14-66 | 0.1-50 | 0.0-10 |
| M31 | 3.0-4.0 | 39-49 | 24-56 | 0.1-32 | 0.0-10 |
| M32 | 3.0-4.0 | 50-54 | 39-46 | 0.1-7 | 0.0-10 |

l) Compositions with solketal content of 3.0-4.0 weight-% and density in the range of 800-845 kg/m³: compositions falling within the amount ranges specified in the table below and additionally satisfying the equation

$$800 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$800 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 19

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| M33 | 3.0-4.0 | 0.1-10 | 36-90 | 0.0-50 | 0.0-10 |
| M34 | 3.0-4.0 | 10-20 | 26-86 | 0.0-50 | 0.0-10 |
| M35 | 3.0-4.0 | 20-30 | 17-77 | 0.0-50 | 0.0-10 |
| M36 | 3.0-4.0 | 30-40 | 16-66 | 1-49 | 0.0-10 |
| M37 | 3.0-4.0 | 40-50 | 26-56 | 1-31 | 0.0-10 |
| M38 | 3.0-4.0 | 50-54 | 39-46 | 0.0-7 | 0.0-10 |
| M39 | 3.0-4.0 | 6-10 | 36-90 | 0.0-50 | 0.1-10 |
| M40 | 3.0-4.0 | 10-20 | 26-86 | 0.0-50 | 0.1-10 |
| M41 | 3.0-4.0 | 20-30 | 17-77 | 0.0-50 | 0.1-10 |
| M42 | 3.0-4.0 | 30-40 | 16-66 | 1-49 | 0.1-10 |
| M43 | 3.0-4.0 | 40-50 | 26-56 | 1-31 | 0.1-10 |
| M44 | 3.0-4.0 | 50-54 | 39-46 | 0.0-7 | 0.1-10 |
| M45 | 3.0-4.0 | 0.1-10 | 36-90 | 0.1-50 | 0.0-10 |
| M46 | 3.0-4.0 | 10-20 | 26-86 | 0.1-50 | 0.0-10 |
| M47 | 3.0-4.0 | 20-30 | 17-77 | 0.1-50 | 0.0-10 |
| M48 | 3.0-4.0 | 30-40 | 16-66 | 0.1-50 | 0.0-10 |
| M49 | 3.0-4.0 | 40-50 | 26-56 | 0.1-32 | 0.0-10 |
| M50 | 3.0-4.0 | 50-54 | 39-46 | 0.1-7 | 0.0-10 |

m) Compositions with solketal content of 4.0-5.0 weight-% and density in the range of 820-845 kg/m³: compositions falling within the amount ranges specified in the table below and additionally satisfying the equation

$$820 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 20

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| N1 | 4.0-5.0 | 3-10 | 35-51 | 34-50 | 0.0-10 |
| N2 | 4.0-5.0 | 10-20 | 25-64 | 11-50 | 0.0-10 |
| N3 | 4.0-5.0 | 20-30 | 17-70 | 0.0-50 | 0.0-10 |
| N4 | 4.0-5.0 | 30-40 | 17-66 | 0.0-49 | 0.0-10 |
| N5 | 4.0-5.0 | 40-51 | 30-56 | 0.0-26 | 0.0-10 |
| N6 | 4.0-5.0 | 3-10 | 35-51 | 34-50 | 0.1-10 |
| N7 | 4.0-5.0 | 10-20 | 25-64 | 11-50 | 0.1-10 |
| N8 | 4.0-5.0 | 20-30 | 17-70 | 0.0-50 | 0.1-10 |
| N9 | 4.0-5.0 | 30-40 | 17-66 | 0.0-49 | 0.1-10 |
| N10 | 4.0-5.0 | 40-51 | 30-56 | 0.0-26 | 0.1-10 |
| N11 | 4.0-5.0 | 20-30 | 17-70 | 0.1-50 | 0.0-10 |
| N12 | 4.0-5.0 | 30-40 | 17-66 | 0.1-49 | 0.0-10 |
| N13 | 4.0-5.0 | 40-51 | 30-56 | 0.1-26 | 0.0-10 |

n) Compositions with solketal content of 4.0-5.0 weight-% and density in the range of 810-845 kg/m³: compositions falling within the amount ranges specified in the table below and additionally satisfying the equation

$$810 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$810 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 21

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| N14 | 4.0-5.0 | 0.1-10 | 35-73 | 12-50 | 0.0-10 |
| N15 | 4.0-5.0 | 10-20 | 25-80 | 0.0-50 | 0.0-10 |
| N16 | 4.0-5.0 | 20-30 | 17-76 | 0.0-50 | 0.0-10 |
| N17 | 4.0-5.0 | 29-39 | 16-65 | 2-50 | 0.0-10 |
| N18 | 4.0-5.0 | 39-50 | 29-55 | 2-28 | 0.0-10 |
| N19 | 4.0-5.0 | 0.1-10 | 35-73 | 12-50 | 0.1-10 |
| N20 | 4.0-5.0 | 10-20 | 25-80 | 0.0-50 | 0.1-10 |
| N21 | 4.0-5.0 | 20-30 | 17-76 | 0.0-50 | 0.1-10 |
| N22 | 4.0-5.0 | 29-39 | 16-65 | 2-50 | 0.1-10 |
| N23 | 4.0-5.0 | 39-50 | 29-55 | 2-28 | 0.1-10 |
| N24 | 4.0-5.0 | 10-20 | 25-80 | 0.1-50 | 0.0-10 |
| N25 | 4.0-5.0 | 20-30 | 17-76 | 0.1-50 | 0.0-10 |
| N26 | 4.0-5.0 | 29-39 | 16-65 | 0.1-49 | 0.0-10 |
| N27 | 4.0-5.0 | 39-50 | 29-55 | 0.1-26 | 0.0-10 |

o) Compositions with solketal content of 4.0-5.0 weight-% and density in the range of 800-845 kg/m³: compositions falling within the amount ranges specified in the table below and additionally satisfying the equation

$$800 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$800 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 22

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| N28 | 4.0-5.0 | 0.1-10 | 35-89 | 0.0-50 | 0.0-10 |
| N29 | 4.0-5.0 | 10-20 | 25-86 | 0.0-50 | 0.0-10 |
| N30 | 4.0-5.0 | 20-30 | 18-75 | 1-49 | 0.0-10 |
| N31 | 4.0-5.0 | 30-40 | 18-65 | 1-48 | 0.0-10 |
| N32 | 4.0-5.0 | 40-51 | 30-56 | 0.0-26 | 0.0-10 |
| N33 | 4.0-5.0 | 0.1-10 | 35-89 | 0.0-50 | 0.1-10 |
| N34 | 4.0-5.0 | 10-20 | 25-86 | 0.0-50 | 0.1-10 |
| N35 | 4.0-5.0 | 20-30 | 17-76 | 0.0-50 | 0.1-10 |
| N36 | 4.0-5.0 | 30-40 | 18-75 | 1-49 | 0.1-10 |
| N37 | 4.0-5.0 | 40-51 | 18-65 | 1-48 | 0.1-10 |
| N38 | 4.0-5.0 | 0.1-10 | 35-89 | 0.1-50 | 0.0-10 |
| N39 | 4.0-5.0 | 10-20 | 25-86 | 0.1-50 | 0.0-10 |
| N40 | 4.0-5.0 | 20-30 | 18-75 | 0.1-50 | 0.0-10 |
| N41 | 4.0-5.0 | 30-40 | 18-65 | 0.1-49 | 0.0-10 |
| N42 | 4.0-5.0 | 40-51 | 30-56 | 0.1-26 | 0.0-10 |

p) Compositions with solketal content of 5.0-6.0 weight-% and density in the range of 820-845 kg/m³: compositions falling within the amount ranges specified in the table below and additionally satisfying the equation

$$820 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 23

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| O1 | 5.0-6.0 | 0.1-10 | 34-56 | 28-50 | 0.0-10 |
| O2 | 5.0-6.0 | 10-20 | 24-70 | 4-50 | 0.0-10 |
| O3 | 5.0-6.0 | 20-30 | 18-72 | 0.0-50 | 0.0-10 |
| O4 | 5.0-6.0 | 30-40 | 22-65 | 0.0-43 | 0.0-10 |
| O5 | 5.0-6.0 | 40-48 | 35-55 | 0.0-20 | 0.0-10 |
| O6 | 5.0-6.0 | 0.1-10 | 34-56 | 28-50 | 0.1-10 |
| O7 | 5.0-6.0 | 10-20 | 24-70 | 4-50 | 0.1-10 |
| O8 | 5.0-6.0 | 20-30 | 18-72 | 0.0-50 | 0.1-10 |
| O9 | 5.0-6.0 | 30-40 | 22-65 | 0.0-43 | 0.1-10 |
| O10 | 5.0-6.0 | 40-48 | 35-55 | 0.0-20 | 0.1-10 |
| O11 | 5.0-6.0 | 20-30 | 18-72 | 0.1-50 | 0.0-10 |
| O12 | 5.0-6.0 | 30-40 | 22-65 | 0.1-43 | 0.0-10 |
| O13 | 5.0-6.0 | 40-48 | 35-55 | 0.1-20 | 0.0-10 |

q) Compositions with solketal content of 5.0-6.0 weight-% and density in the range of 810-845 kg/m³: compositions falling within the amount ranges specified in the table below and additionally satisfying the equation

$$810 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$810 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 24

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| O14 | 5.0-6.0 | 0.1-10 | 34-78 | 6-50 | 0.0-10 |
| O15 | 5.0-6.0 | 10-20 | 24-81 | 0.0-50 | 0.0-10 |
| O16 | 5.0-6.0 | 20-30 | 18-65 | 0.0-50 | 0.0-10 |
| O17 | 5.0-6.0 | 29-39 | 21-64 | 2-45 | 0.0-10 |
| O18 | 5.0-6.0 | 39-47 | 34-54 | 2-22 | 0.0-10 |
| O19 | 5.0-6.0 | 0.1-10 | 34-78 | 6-50 | 0.1-10 |
| O20 | 5.0-6.0 | 10-20 | 24-81 | 0.0-50 | 0.1-10 |
| O21 | 5.0-6.0 | 20-30 | 18-65 | 0.0-50 | 0.1-10 |
| O22 | 5.0-6.0 | 29-39 | 21-64 | 2-45 | 0.1-10 |
| O23 | 5.0-6.0 | 39-47 | 34-54 | 2-22 | 0.1-10 |
| O24 | 5.0-6.0 | 10-20 | 24-81 | 0.1-50 | 0.0-10 |
| O25 | 5.0-6.0 | 20-30 | 18-65 | 0.1-50 | 0.0-10 |
| O26 | 5.0-6.0 | 29-39 | 21-64 | 0.1-43 | 0.0-10 |
| O27 | 5.0-6.0 | 39-47 | 34-54 | 0.1-20 | 0.0-10 |

r) Compositions with solketal content of 5.0-6.0 weight-% and density in the range of 800-845 kg/m³: compositions falling within the amount ranges specified in the table below and additionally satisfying the equation

$$800 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$800 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 25

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| O28 | 5.0-6.0 | 0.1-10 | 34-91 | 0.0-50 | 0.0-10 |
| O29 | 5.0-6.0 | 10-20 | 24-85 | 0.0-50 | 0.0-10 |
| O30 | 5.0-6.0 | 20-30 | 18-75 | 0.0-50 | 0.0-10 |
| O31 | 5.0-6.0 | 30-40 | 23-64 | 1-42 | 0.0-10 |
| O32 | 5.0-6.0 | 40-48 | 36-54 | 1-19 | 0.0-10 |
| O33 | 5.0-6.0 | 0.1-10 | 34-91 | 0.0-50 | 0.1-10 |
| O34 | 5.0-6.0 | 10-20 | 24-85 | 0.0-50 | 0.1-10 |
| O35 | 5.0-6.0 | 20-30 | 18-75 | 0.0-50 | 0.1-10 |
| O36 | 5.0-6.0 | 30-40 | 23-64 | 1-42 | 0.1-10 |
| O37 | 5.0-6.0 | 40-48 | 36-54 | 1-19 | 0.1-10 |
| O38 | 5.0-6.0 | 0.1-10 | 34-91 | 0.1-50 | 0.0-10 |
| O39 | 5.0-6.0 | 10-20 | 24-85 | 0.1-50 | 0.0-10 |
| O40 | 5.0-6.0 | 20-30 | 18-75 | 0.1-50 | 0.0-10 |
| O41 | 5.0-6.0 | 30-40 | 23-64 | 0.1-43 | 0.0-10 |
| O42 | 5.0-6.0 | 40-48 | 36-54 | 0.1-20 | 0.0-10 |

s) Compositions with solketal content of 6.0-8.0 weight-% and density in the range of 820-845 kg/m³: compositions falling within the amount ranges specified in the table below and additionally satisfying the equation

$$820 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 26

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| P1 | 6.0-8.0 | 0.1-10 | 32-67 | 15-50 | 0.0-10 |
| P2 | 6.0-8.0 | 10-20 | 23-75 | 0.0-50 | 0.0-10 |
| P3 | 6.0-8.0 | 20-30 | 20-72 | 0.0-50 | 0.0-10 |
| P4 | 6.0-8.0 | 30-40 | 27-64 | 0.0-37 | 0.0-10 |
| P5 | 6.0-8.0 | 40-46 | 41-54 | 0.0-13 | 0.0-10 |
| P6 | 6.0-8.0 | 0.1-10 | 32-67 | 15-50 | 0.1-10 |
| P7 | 6.0-8.0 | 10-20 | 23-75 | 0.0-50 | 0.1-10 |
| P8 | 6.0-8.0 | 20-30 | 20-72 | 0.0-50 | 0.1-10 |
| P9 | 6.0-8.0 | 30-40 | 27-64 | 0.0-37 | 0.1-10 |
| P10 | 6.0-8.0 | 40-46 | 41-54 | 0.0-13 | 0.1-10 |
| P11 | 6.0-8.0 | 10-20 | 23-75 | 0.1-50 | 0.0-10 |
| P12 | 6.0-8.0 | 20-30 | 20-72 | 0.1-50 | 0.0-10 |
| P13 | 6.0-8.0 | 30-40 | 27-64 | 0.1-37 | 0.0-10 |
| P14 | 6.0-8.0 | 40-46 | 41-54 | 0.1-13 | 0.0-10 |

t) Compositions with solketal content of 6.0-8.0 weight-% and density in the range of 810-845 kg/m³: compositions falling within the amount ranges specified in the table below and additionally satisfying the equation

$$810 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$810 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 27

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| P15 | 6.0-8.0 | 0.1-10 | 32-85 | 0.0-50 | 0.0-10 |
| P16 | 6.0-8.0 | 10-20 | 23-82 | 0.0-50 | 0.0-10 |
| P17 | 6.0-8.0 | 20-30 | 20-74 | 0.0-50 | 0.0-10 |
| P18 | 6.0-8.0 | 29-39 | 26-63 | 2-39 | 0.0-10 |
| P19 | 6.0-8.0 | 39-45 | 40-53 | 2-15 | 0.0-10 |
| P20 | 6.0-8.0 | 0.1-10 | 32-85 | 0.0-50 | 0.1-10 |
| P21 | 6.0-8.0 | 10-20 | 23-82 | 0.0-50 | 0.1-10 |
| P22 | 6.0-8.0 | 20-30 | 20-74 | 0.0-50 | 0.1-10 |
| P23 | 6.0-8.0 | 29-39 | 26-63 | 2-39 | 0.1-10 |
| P24 | 6.0-8.0 | 39-45 | 40-53 | 2-15 | 0.1-10 |
| P25 | 6.0-8.0 | 0.1-10 | 32-85 | 0.1-50 | 0.0-10 |
| P26 | 6.0-8.0 | 10-20 | 23-82 | 0.1-50 | 0.0-10 |
| P27 | 6.0-8.0 | 20-30 | 20-74 | 0.1-50 | 0.0-10 |
| P28 | 6.0-8.0 | 29-39 | 26-63 | 0.1-37 | 0.0-10 |
| P29 | 6.0-8.0 | 39-45 | 40-53 | 0.1-13 | 0.0-10 |

u) Compositions with solketal content of 6.0-8.0 weight-% and density in the range of 800-845 kg/m³: compositions falling within the amount ranges specified in the table below and additionally satisfying the equation

$$800 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$800 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 28

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| P30 | 6.0-8.0 | 0.1-10 | 32-92 | 0.0-50 | 0.0-10 |
| P31 | 6.0-8.0 | 10-20 | 23-84 | 0.0-50 | 0.0-10 |
| P32 | 6.0-8.0 | 20-30 | 20-74 | 0.0-50 | 0.0-10 |
| P33 | 6.0-8.0 | 30-40 | 28-63 | 1-36 | 0.0-10 |
| P34 | 6.0-8.0 | 40-46 | 42-53 | 1-12 | 0.0-10 |
| P35 | 6.0-8.0 | 0.1-10 | 32-92 | 0.0-50 | 0.1-10 |
| P36 | 6.0-8.0 | 10-20 | 23-84 | 0.0-50 | 0.1-10 |
| P37 | 6.0-8.0 | 20-30 | 20-74 | 0.0-50 | 0.1-10 |
| P38 | 6.0-8.0 | 30-40 | 28-63 | 1-36 | 0.1-10 |
| P39 | 6.0-8.0 | 40-46 | 42-53 | 1-12 | 0.1-10 |
| P40 | 6.0-8.0 | 0.1-10 | 32-92 | 0.1-50 | 0.0-10 |
| P41 | 6.0-8.0 | 10-20 | 23-84 | 0.1-50 | 0.0-10 |
| P42 | 6.0-8.0 | 20-30 | 20-74 | 0.1-50 | 0.0-10 |
| P43 | 6.0-8.0 | 30-40 | 28-63 | 0.1-37 | 0.0-10 |
| P44 | 6.0-8.0 | 40-46 | 42-53 | 0.1-13 | 0.0-10 |

v) Compositions with solketal content of 8.0-10.0 weight-% and density in the range of 820-845 kg/m³: compositions falling within the amount ranges specified in the table below and additionally satisfying the equation

$$820 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 29

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| Q1 | 8.0-10.0 | 0.1-10 | 30-77 | 3-50 | 0.0-10 |
| Q2 | 8.0-10.0 | 10-20 | 23-79 | 0.0-50 | 0.0-10 |
| Q3 | 8.0-10.0 | 20-30 | 24-72 | 0.0-47 | 0.0-10 |
| Q4 | 8.0-10.0 | 30-40 | 38-62 | 0.0-24 | 0.0-10 |
| Q5 | 8.0-10.0 | 0.1-10 | 30-77 | 3-50 | 0.1-10 |
| Q6 | 8.0-10.0 | 10-20 | 23-79 | 0.0-50 | 0.1-10 |
| Q7 | 8.0-10.0 | 20-30 | 24-72 | 0.0-47 | 0.1-10 |
| Q8 | 8.0-10.0 | 30-40 | 38-62 | 0.0-24 | 0.1-10 |
| Q9 | 8.0-10.0 | 10-20 | 23-79 | 0.1-50 | 0.0-10 |
| Q10 | 8.0-10.0 | 20-30 | 24-72 | 0.1-47 | 0.0-10 |
| Q11 | 8.0-10.0 | 30-40 | 38-62 | 0.1-24 | 0.0-10 |

w) Compositions with solketal content of 8.0-10.0 weight-% and density in the range of 810-845 kg/m³: compositions falling within the amount ranges specified in the table below and additionally satisfying the equation

$$810 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$810 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 30

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| Q12 | 8.0-10.0 | 0.1-10 | 30-88 | 0.0-50 | 0.0-10 |
| Q13 | 8.0-10.0 | 10-20 | 23-82 | 0.0-50 | 0.0-10 |
| Q14 | 8.0-10.0 | 19-29 | 23-71 | 2-49 | 0.0-10 |
| Q15 | 8.0-10.0 | 29-39 | 37-61 | 2-26 | 0.0-10 |
| Q16 | 8.0-10.0 | 0.1-10 | 30-88 | 0.0-50 | 0.1-10 |
| Q17 | 8.0-10.0 | 10-20 | 23-82 | 0.0-50 | 0.1-10 |
| Q18 | 8.0-10.0 | 19-29 | 23-71 | 2-49 | 0.1-10 |
| Q19 | 8.0-10.0 | 29-39 | 37-61 | 2-26 | 0.1-10 |
| Q20 | 8.0-10.0 | 0.1-10 | 30-88 | 0.1-50 | 0.0-10 |
| Q21 | 8.0-10.0 | 10-20 | 23-82 | 0.1-50 | 0.0-10 |
| Q22 | 8.0-10.0 | 19-29 | 23-71 | 0.1-47 | 0.0-10 |
| Q23 | 8.0-10.0 | 29-39 | 37-61 | 0.1-24 | 0.0-10 |

x) Compositions with solketal content of 8.0-10.0 weight-% and density in the range of 800-845 kg/m³: compositions falling within the amount ranges specified in the table below and additionally satisfying the equation

$$800 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$800 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 31

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| Q24 | 6.0-8.0 | 0.1-10 | 30-92 | 0.0-50 | 0.0-10 |
| Q25 | 6.0-8.0 | 10-20 | 23-82 | 0.0-50 | 0.0-10 |
| Q26 | 6.0-8.0 | 20-30 | 25-71 | 1-46 | 0.0-10 |
| Q27 | 6.0-8.0 | 30-40 | 39-61 | 1-23 | 0.0-10 |
| Q28 | 6.0-8.0 | 0.1-10 | 30-92 | 0.0-50 | 0.1-10 |
| Q29 | 6.0-8.0 | 10-20 | 23-82 | 0.0-50 | 0.1-10 |
| Q30 | 6.0-8.0 | 20-30 | 25-71 | 1-46 | 0.1-10 |
| Q31 | 6.0-8.0 | 30-40 | 39-61 | 1-23 | 0.1-10 |
| Q32 | 6.0-8.0 | 0.1-10 | 30-92 | 0.1-50 | 0.0-10 |
| Q33 | 6.0-8.0 | 10-20 | 23-82 | 0.1-50 | 0.0-10 |
| Q34 | 6.0-8.0 | 20-30 | 25-71 | 0.1-47 | 0.0-10 |
| Q35 | 6.0-8.0 | 30-40 | 39-61 | 0.1-24 | 0.0-10 |

y) Compositions with solketal content of 10.0-12.0 weight-% and density in the range of 820-845 kg/m³: compositions falling within the amount ranges specified in the table below and additionally satisfying the equation

$$820 \leq [ ( w ( a ) \times 1063 ) + ( w ( b ) \times 885 ) + ( w ( c ) \times 780 ) + ( w ( d ) \times 825 ) ] + 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 32

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| R1 | 10.0-12.0 | 0.1-10 | 30-82 | 0.0-50 | 0.0-10 |
| R2 | 10.0-12.0 | 10-20 | 27-79 | 0.0-50 | 0.0-10 |
| R3 | 10.0-12.0 | 20-30 | 35-70 | 0.0-35 | 0.0-10 |
| R4 | 10.0-12.0 | 30-35 | 48-60 | 0.0-12 | 0.0-10 |
| R5 | 10.0-12.0 | 0.1-10 | 30-82 | 0.0-50 | 0.1-10 |
| R6 | 10.0-12.0 | 10-20 | 27-79 | 0.0-50 | 0.1-10 |
| R7 | 10.0-12.0 | 20-30 | 35-70 | 0.0-35 | 0.1-10 |
| R8 | 10.0-12.0 | 30-35 | 48-60 | 0.0-12 | 0.1-10 |
| R9 | 10.0-12.0 | 0.1-10 | 30-82 | 0.1-50 | 0.0-10 |
| R10 | 10.0-12.0 | 10-20 | 27-79 | 0.1-50 | 0.0-10 |
| R11 | 10.0-12.0 | 20-30 | 35-70 | 0.1-35 | 0.0-10 |
| R12 | 10.0-12.0 | 30-35 | 48-60 | 0.1-12 | 0.0-10 |

z) Compositions with solketal content of 10.0-12.0 weight-% and density in the range of 810-845 kg/m³: compositions falling within the amount ranges specified in the table below and additionally satisfying the equation

$$810 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$810 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 33

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| R13 | 10.0-12.0 | 0.1-10 | 30-88 | 0.0-50 | 0.0-10 |
| R14 | 10.0-12.0 | 10-20 | 27-80 | 0.0-50 | 0.0-10 |
| R15 | 10.0-12.0 | 19-29 | 34-69 | 2-37 | 0.0-10 |
| R16 | 10.0-12.0 | 29-34 | 47-59 | 2-14 | 0.0-10 |
| R17 | 10.0-12.0 | 0.1-10 | 30-88 | 0.0-50 | 0.1-10 |
| R18 | 10.0-12.0 | 10-20 | 27-80 | 0.0-50 | 0.1-10 |
| R19 | 10.0-12.0 | 19-29 | 34-69 | 2-37 | 0.1-10 |
| R20 | 10.0-12.0 | 29-34 | 47-59 | 2-14 | 0.1-10 |
| R21 | 10.0-12.0 | 0.1-10 | 30-88 | 0.1-50 | 0.0-10 |
| R22 | 10.0-12.0 | 10-20 | 27-80 | 0.1-50 | 0.0-10 |
| R23 | 10.0-12.0 | 19-29 | 34-69 | 0.1-35 | 0.0-10 |
| R24 | 10.0-12.0 | 29-34 | 47-59 | 0.1-12 | 0.0-10 |

aa) Compositions with solketal content of 10.0-12.0 weight-% and density in the range of 800-845 kg/m³: compositions falling within the amount ranges specified in the table below and additionally satisfying the equation

$$800 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$800 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 34

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| R25 | 10.0-12.0 | 0.1-10 | 30-90 | 0.0-50 | 0.0-10 |
| R26 | 10.0-12.0 | 10-20 | 27-80 | 0.0-50 | 0.0-10 |
| R27 | 10.0-12.0 | 20-30 | 36-69 | 1-34 | 0.0-10 |
| R28 | 10.0-12.0 | 30-35 | 49-59 | 1-11 | 0.0-10 |
| R29 | 10.0-12.0 | 0.1-10 | 30-90 | 0.0-50 | 0.1-10 |
| R30 | 10.0-12.0 | 10-20 | 27-80 | 0.0-50 | 0.1-10 |
| R31 | 10.0-12.0 | 20-30 | 36-69 | 1-34 | 0.1-10 |
| R32 | 10.0-12.0 | 30-35 | 49-59 | 1-11 | 0.1-10 |
| R33 | 10.0-12.0 | 0.1-10 | 30-90 | 0.1-50 | 0.0-10 |
| R34 | 10.0-12.0 | 10-20 | 27-80 | 0.1-50 | 0.0-10 |
| R35 | 10.0-12.0 | 20-30 | 36-69 | 0.1-35 | 0.0-10 |
| R36 | 10.0-12.0 | 30-35 | 49-59 | 0.1-12 | 0.0-10 |

ab) Compositions with solketal content of 12.0-14.0 weight-% and density in the range of 820-845 kg/m³: compositions falling within the amount ranges specified in the table below and additionally satisfying the equation

$$820 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 35

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| S1 | 12.0-14.0 | 0.1-10 | 30-86 | 0.0-50 | 0.0-10 |
| S2 | 12.0-14.0 | 10-20 | 32-78 | 0.0-46 | 0.0-10 |
| S3 | 12.0-14.0 | 20-30 | 46-68 | 0.0-22 | 0.0-10 |
| S4 | 12.0-14.0 | 0.1-10 | 30-86 | 0.0-50 | 0.1-10 |
| S5 | 12.0-14.0 | 10-20 | 32-78 | 0.0-46 | 0.1-10 |
| S6 | 12.0-14.0 | 20-30 | 46-68 | 0.0-22 | 0.1-10 |
| S7 | 12.0-14.0 | 0.1-10 | 30-86 | 0.1-50 | 0.0-10 |
| S8 | 12.0-14.0 | 10-20 | 32-78 | 0.1-46 | 0.0-10 |
| S9 | 12.0-14.0 | 20-30 | 46-68 | 0.1-22 | 0.0-10 |

ac) Compositions with solketal content of 12.0-14.0 weight-% and density in the range of 810-845 kg/m³: compositions falling within the amount ranges specified in the table below and additionally satisfying the equation

$$810 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$810 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 36

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| S10 | 12.0-14.0 | 0.1-10 | 30-88 | 0.0-50 | 0.0-10 |
| S11 | 12.0-14.0 | 9-19 | 31-77 | 2-48 | 0.0-10 |
| S12 | 12.0-14.0 | 19-29 | 45-67 | 2-24 | 0.0-10 |
| S13 | 12.0-14.0 | 0.1-10 | 30-88 | 0.0-50 | 0.1-10 |
| S14 | 12.0-14.0 | 9-19 | 31-77 | 2-48 | 0.1-10 |
| S15 | 12.0-14.0 | 19-29 | 45-67 | 2-24 | 0.1-10 |
| S16 | 12.0-14.0 | 0.1-10 | 30-88 | 0.1-50 | 0.0-10 |
| S17 | 12.0-14.0 | 9-19 | 31-77 | 0.1-46 | 0.0-10 |
| S18 | 12.0-14.0 | 19-29 | 45-67 | 0.1-22 | 0.0-10 |

ad) Compositions with solketal content of 12.0-14.0 weight-% and density in the range of 800-845 kg/m³: compositions falling within the amount ranges specified in the table below and additionally satisfying the equation

$$800 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$800 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 37

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| S19 | 12.0-14.0 | 0.1-10 | 30-88 | 0.0-50 | 0.0-10 |
| S20 | 12.0-14.0 | 10-20 | 33-77 | 1-45 | 0.0-10 |
| S21 | 12.0-14.0 | 20-30 | 47-67 | 1-21 | 0.0-10 |
| S22 | 12.0-14.0 | 0.1-10 | 30-88 | 0.0-50 | 0.1-10 |
| S23 | 12.0-14.0 | 10-20 | 33-77 | 1-45 | 0.1-10 |
| S24 | 12.0-14.0 | 20-30 | 47-67 | 1-21 | 0.1-10 |
| S25 | 12.0-14.0 | 0.1-10 | 30-88 | 0.1-50 | 0.0-10 |
| S26 | 12.0-14.0 | 10-20 | 33-77 | 0.1-46 | 0.0-10 |
| S27 | 12.0-14.0 | 20-30 | 47-67 | 0.1-22 | 0.0-10 |

ae) Compositions with solketal content of 14.0-16.0 weight-% and density in the range of 820-845 kg/m³: compositions falling within the amount ranges specified in the table below and additionally satisfying the equation

$$820 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 38

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| T1 | 14.0-16.0 | 0.1-10 | 34-86 | 0.0-50 | 0.0-10 |
| T2 | 14.0-16.0 | 10-20 | 43-76 | 0.0-33 | 0.0-10 |
| T3 | 14.0-16.0 | 20-24 | 56-66 | 0.0-10 | 0.0-10 |
| T4 | 14.0-16.0 | 0.1-10 | 34-86 | 0.0-50 | 0.1-10 |
| T5 | 14.0-16.0 | 10-20 | 43-76 | 0.0-33 | 0.1-10 |
| T6 | 14.0-16.0 | 20-24 | 56-66 | 0.0-10 | 0.1-10 |
| T7 | 14.0-16.0 | 0.1-10 | 34-86 | 0.1-50 | 0.0-10 |
| T8 | 14.0-16.0 | 10-20 | 43-76 | 0.1-33 | 0.0-10 |
| T9 | 14.0-16.0 | 20-24 | 56-66 | 0.1-10 | 0.0-10 |

af) Compositions with solketal content of 14.0-16.0 weight-% and density in the range of 810-845 kg/m³: compositions falling within the amount ranges specified in the table below and additionally satisfying the equation

$$810 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$810 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 39

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| T10 | 14.0-16.0 | 0.1-9 | 33-85 | 2-50 | 0.0-10 |
| T11 | 14.0-16.0 | 9-19 | 42-75 | 2-35 | 0.0-10 |
| T12 | 14.0-16.0 | 19-23 | 55-65 | 2-12 | 0.0-10 |
| T13 | 14.0-16.0 | 0.1-9 | 33-85 | 2-50 | 0.1-10 |
| T14 | 14.0-16.0 | 9-19 | 42-75 | 2-35 | 0.1-10 |
| T15 | 14.0-16.0 | 19-23 | 55-65 | 2-12 | 0.1-10 |
| T16 | 14.0-16.0 | 0.1-9 | 33-85 | 0.1-50 | 0.0-10 |
| T17 | 14.0-16.0 | 9-19 | 42-75 | 0.1-33 | 0.0-10 |
| T18 | 14.0-16.0 | 19-23 | 55-65 | 0.1-10 | 0.0-10 |

ag) Compositions with solketal content of 14.0-16.0 weight-% and density in the range of 800-845 kg/m³: compositions falling within the amount ranges specified in the table below and additionally satisfying the equation

$$800 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$800 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 40

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| T19 | 14.0-16.0 | 0.1-10 | 35-85 | 1-49 | 0.0-10 |
| T20 | 14.0-16.0 | 10-20 | 44-75 | 1-32 | 0.0-10 |
| T21 | 14.0-16.0 | 20-24 | 57-65 | 1-9 | 0.0-10 |
| T22 | 14.0-16.0 | 0.1-10 | 35-85 | 1-49 | 0.1-10 |
| T23 | 14.0-16.0 | 10-20 | 44-75 | 1-32 | 0.1-10 |
| T24 | 14.0-16.0 | 20-24 | 57-65 | 1-9 | 0.1-10 |
| T25 | 14.0-16.0 | 0.1-10 | 35-85 | 0.1-50 | 0.0-10 |
| T26 | 14.0-16.0 | 10-20 | 44-75 | 0.1-33 | 0.0-10 |
| T27 | 14.0-16.0 | 20-24 | 57-65 | 0.1-10 | 0.0-10 |

ah) Compositions with solketal content of 16.0-18.0 weight-% and density in the range of 820-845 kg/m³: compositions falling within the amount ranges specified in the table below and additionally satisfying the equation

$$820 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 41

| | | | Renewable | Fossil | |
|---|---|---|---|---|---|
| | Solketal, | Biodiesel, | alkane, | diesel, | Total |
| Specific | w(a) | w(b) | w(c) | w(d), | Additives |
| Embodiment | (wt. %) | (wt. %) | (wt. %) | (wt. %) | (wt. %) |
| U1 | 16.0-18.0 | 0.1-10 | 40-84 | 0.0-44 | 0.0-10 |
| U2 | 16.0-18.0 | 10-19 | 54-74 | 0.0-20 | 0.0-10 |
| U3 | 16.0-18.0 | 0.1-10 | 40-84 | 0.0-44 | 0.1-10 |
| U4 | 16.0-18.0 | 10-19 | 54-74 | 0.0-20 | 0.1-10 |
| U5 | 16.0-18.0 | 0.1-10 | 40-84 | 0.1-44 | 0.0-10 |
| U6 | 16.0-18.0 | 10-19 | 54-74 | 0.1-20 | 0.0-10 |
| U7 | 16.0-18.0 | 0.1-9 | 39-83 | 2-46 | 0.0-10 |
| U8 | 16.0-18.0 | 9-18 | 53-73 | 2-22 | 0.0-10 |
| U9 | 16.0-18.0 | 0.1-9 | 39-83 | 2-46 | 0.1-10 |
| U10 | 16.0-18.0 | 9-18 | 53-73 | 2-22 | 0.1-10 |
| U11 | 16.0-18.0 | 0.1-9 | 39-83 | 0.1-44 | 0.0-10 |
| U12 | 16.0-18.0 | 9-18 | 53-73 | 0.1-20 | 0.0-10 |
| U13 | 16.0-18.0 | 0.1-10 | 39-83 | 1-43 | 0.0-10 |
| U14 | 16.0-18.0 | 10-19 | 55-73 | 1-19 | 0.0-10 |
| U15 | 16.0-18.0 | 0.1-10 | 39-83 | 1-43 | 0.1-10 |
| U16 | 16.0-18.0 | 10-19 | 55-73 | 1-19 | 0.1-10 |
| U17 | 16.0-18.0 | 0.1-10 | 39-83 | 0.1-44 | 0.0-10 |
| U18 | 16.0-18.0 | 10-19 | 55-73 | 0.1-20 | 0.0-10 |

ai) Compositions with solketal content of 18.0-20.0 weight-% and density in the range of 820-845 kg/m³: compositions falling within the amount ranges specified in the table below and additionally satisfying the equation

$$820 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 42

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| V1 | 18.0-20.0 | 0.1-10 | 51-82 | 0.0-31 | 0.0-10 |
| V2 | 18.0-20.0 | 10-13 | 64-72 | 0.0-8 | 0.0-10 |
| V3 | 18.0-20.0 | 0.1-10 | 51-82 | 0.0-31 | 0.1-10 |
| V4 | 18.0-20.0 | 10-13 | 64-72 | 0.0-8 | 0.1-10 |
| V5 | 18.0-20.0 | 0.1-10 | 51-82 | 0.1-31 | 0.0-10 |
| V6 | 18.0-20.0 | 10-13 | 64-72 | 0.1-8 | 0.0-10 |
| V7 | 18.0-20.0 | 0.1-9 | 50-81 | 2-33 | 0.0-10 |
| V8 | 18.0-20.0 | 9-12 | 63-71 | 2-10 | 0.0-10 |
| V9 | 18.0-20.0 | 0.1-9 | 50-81 | 2-33 | 0.1-10 |
| V10 | 18.0-20.0 | 9-12 | 63-71 | 2-10 | 0.1-10 |
| V11 | 18.0-20.0 | 0.1-9 | 50-81 | 0.1-31 | 0.0-10 |
| V12 | 18.0-20.0 | 9-12 | 63-71 | 0.1-8 | 0.0-10 |
| V13 | 18.0-20.0 | 0.1-10 | 52-81 | 1-30 | 0.0-10 |
| V14 | 18.0-20.0 | 10-13 | 65-71 | 1-7 | 0.0-10 |
| V15 | 18.0-20.0 | 0.1-10 | 52-81 | 1-30 | 0.1-10 |
| V16 | 18.0-20.0 | 10-13 | 65-71 | 1-7 | 0.1-10 |
| V17 | 18.0-20.0 | 0.1-10 | 52-81 | 0.1-31 | 0.0-10 |
| V18 | 18.0-20.0 | 10-13 | 65-71 | 0.1-8 | 0.0-10 |

aj) Compositions with solketal content of 20.0-23.0 weight-% and density in the range of 820-845 kg/m³: compositions falling within the amount ranges specified in the table below and additionally satisfying the equation

$$820 \leq [ ( w ( a ) \times 1063 ) + ( w ( b ) \times 885 ) + ( w ( c ) \times 780 ) + ( w ( d ) \times 825 ) ] / 100 \leq 845$$

or, if the additive content is above 0 weight-%, satisfying the following equation:

$$820 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845.$$

TABLE 42

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| W1 | 20.0-22.0 | 0.1-8 | 61-80 | 0.0-18 | 0.0-10 |
| W2 | 22.0-23.0 | 0.1-3 | 72-78 | 0.0-6 | 0.0-10 |
| W3 | 20.0-22.0 | 0.1-8 | 61-80 | 0.0-18 | 0.1-10 |
| W4 | 22.0-23.0 | 0.1-3 | 72-78 | 0.0-6 | 0.1-10 |
| W5 | 20.0-22.0 | 0.1-8 | 61-80 | 0.0-18 | 0.0-10 |
| W6 | 22.0-23.0 | 0.1-3 | 72-78 | 0.0-6 | 0.0-10 |
| W7 | 20.0-22.0 | 0.1-7 | 60-79 | 2-20 | 0.0-10 |
| W8 | 22.0-23.0 | 0.1-2 | 71-77 | 2-8 | 0.0-10 |
| W9 | 20.0-22.0 | 0.1-7 | 60-79 | 2-20 | 0.1-10 |
| W10 | 22.0-23.0 | 0.1-2 | 71-77 | 2-8 | 0.1-10 |
| W11 | 20.0-22.0 | 0.1-7 | 60-79 | 0.0-18 | 0.0-10 |
| W12 | 22.0-23.0 | 0.1-2 | 71-77 | 0.0-6 | 0.0-10 |
| W13 | 20.0-22.0 | 0.1-8 | 62-79 | 1-17 | 0.0-10 |
| W14 | 22.0-23.0 | 0.1-3 | 73-77 | 1-5 | 0.0-10 |
| W15 | 20.0-22.0 | 0.1-8 | 62-79 | 1-17 | 0.1-10 |
| W16 | 22.0-23.0 | 0.1-3 | 73-77 | 1-5 | 0.1-10 |
| W17 | 20.0-22.0 | 0.1-8 | 62-79 | 0.0-18 | 0.0-10 |
| W18 | 22.0-23.0 | 0.1-3 | 73-77 | 0.0-6 | 0.0-10 |

As noted above, the present invention also provides diesel fuel compositions that a in good compliance with other industrial norms such as Dirjen Migas Standard 185.K/HK.02/DJM/2022 of Indonesia. For example for this standard or any related standard, the following compositions may be implemented according to the present invention:
ba) Compositions with solketal content of 0.1-1.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 880.$$

TABLE 43

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AA1 | 0.1-1.0 | 9-20 | 29-54 | 25-50 | 0.0-10 |
| AA2 | 0.1-1.0 | 20-30 | 19-68 | 1.5-50 | 0.0-10 |
| AA3 | 0.1-1.0 | 30-40 | 9-68 | 0.0-50 | 0.0-10 |
| AA4 | 0.1-1.0 | 40-50 | 0.1-60 | 0.0-50 | 0.0-10 |
| AA5 | 0.1-1.0 | 50-60 | 0.1-50 | 0.0-50 | 0.0-10 |
| AA6 | 0.1-1.0 | 60-70 | 0.1-40 | 0.0-40 | 0.0-10 |
| AA7 | 0.1-1.0 | 70-80 | 0.1-30 | 0.0-30 | 0.0-10 |
| AA8 | 0.1-1.0 | 80-90 | 0.1-20 | 0.0-20 | 0.0-10 |
| AA9 | 0.1-1.0 | 90-95 | 0.1-10 | 0.0-10 | 0.0-10 |
| AA10 | 0.1-1.0 | 9-20 | 29-54 | 25-50 | 0.1-10 |
| AA11 | 0.1-1.0 | 20-30 | 19-68 | 1.5-50 | 0.1-10 |
| AA12 | 0.1-1.0 | 30-40 | 9-68 | 0.0-50 | 0.1-10 |
| AA13 | 0.1-1.0 | 40-50 | 0.1-60 | 0.0-50 | 0.1-10 |
| AA14 | 0.1-1.0 | 50-60 | 0.1-50 | 0.0-50 | 0.1-10 |
| AA15 | 0.1-1.0 | 60-70 | 0.1-40 | 0.0-40 | 0.1-10 |
| AA16 | 0.1-1.0 | 70-80 | 0.1-30 | 0.0-30 | 0.1-10 |
| AA17 | 0.1-1.0 | 80-90 | 0.1-20 | 0.0-20 | 0.1-10 |
| AA17 | 0.1-1.0 | 90-95 | 0.1-10 | 0.0-10 | 0.1-10 |
| AA18 | 0.1-1.0 | 30-40 | 9-68 | 0.1-50 | 0.0-10 |
| AA19 | 0.1-1.0 | 40-50 | 0.1-60 | 0.1-50 | 0.0-10 |
| AA20 | 0.1-1.0 | 50-60 | 0.1-50 | 0.1-50 | 0.0-10 |
| AA21 | 0.1-1.0 | 60-70 | 0.1-40 | 0.1-40 | 0.0-10 |
| AA22 | 0.1-1.0 | 70-80 | 0.1-30 | 0.1-30 | 0.0-10 |
| AA23 | 0.1-1.0 | 80-90 | 0.1-20 | 0.1-20 | 0.0-10 |
| AA24 | 0.1-1.0 | 90-95 | 0.1-10 | 0.1-10 | 0.0-10 |

bb) Compositions with solketal content of 1.0-2.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 880.$$

TABLE 44

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AB1 | 1.0-2.0 | 7-20 | 28-59 | 19-50 | 0.0-10 |
| AB2 | 1.0-2.0 | 20-30 | 18-70 | 0.0-50 | 0.0-10 |
| AB3 | 1.0-2.0 | 30-40 | 8-68 | 0.0-50 | 0.0-10 |
| AB4 | 1.0-2.0 | 40-50 | 0.1-59 | 0.0-50 | 0.0-10 |
| AB5 | 1.0-2.0 | 50-60 | 0.1-49 | 0.0-49 | 0.0-10 |
| AB6 | 1.0-2.0 | 60-70 | 0.1-39 | 0.0-39 | 0.0-10 |
| AB7 | 1.0-2.0 | 70-80 | 0.1-29 | 0.0-29 | 0.0-10 |
| AB8 | 1.0-2.0 | 80-93 | 0.1-19 | 0.0-19 | 0.0-10 |
| AB9 | 1.0-2.0 | 7-20 | 28-59 | 19-50 | 0.1-10 |
| AB10 | 1.0-2.0 | 20-30 | 18-70 | 0.0-50 | 0.1-10 |
| AB11 | 1.0-2.0 | 30-40 | 8-68 | 0.0-50 | 0.1-10 |
| AB12 | 1.0-2.0 | 40-50 | 0.1-59 | 0.0-50 | 0.1-10 |
| AB13 | 1.0-2.0 | 50-60 | 0.1-49 | 0.0-49 | 0.1-10 |
| AB14 | 1.0-2.0 | 60-70 | 0.1-39 | 0.0-39 | 0.1-10 |
| AB15 | 1.0-2.0 | 70-80 | 0.1-29 | 0.0-29 | 0.1-10 |
| AB16 | 1.0-2.0 | 80-93 | 0.1-19 | 0.0-19 | 0.1-10 |
| AB17 | 1.0-2.0 | 20-30 | 18-70 | 0.1-50 | 0.0-10 |
| AB18 | 1.0-2.0 | 30-40 | 8-68 | 0.1-50 | 0.0-10 |
| AB19 | 1.0-2.0 | 40-50 | 0.1-59 | 0.1-50 | 0.0-10 |
| AB20 | 1.0-2.0 | 50-60 | 0.1-49 | 0.1-49 | 0.0-10 |
| AB21 | 1.0-2.0 | 60-70 | 0.1-39 | 0.1-39 | 0.0-10 |
| AB22 | 1.0-2.0 | 70-80 | 0.1-29 | 0.1-29 | 0.0-10 |
| AB23 | 1.0-2.0 | 80-93 | 0.1-19 | 0.1-19 | 0.0-10 |
| AB24 | 1.0-2.0 | 20-31 | 18-70 | 0.0-50 | 0.0-10 |
| AB25 | 1.0-2.0 | 34-41 | 8-68 | 0.0-50 | 0.0-10 |
| AB26 | 1.0-2.0 | 44-51 | 0.1-59 | 0.0-50 | 0.0-10 |
| AB27 | 1.0-2.0 | 54-61 | 0.1-49 | 0.0-49 | 0.0-10 |
| AB28 | 1.0-2.0 | 63-71 | 0.1-39 | 0.0-39 | 0.0-10 |
| AB29 | 1.0-2.0 | 73-80 | 0.1-29 | 0.0-29 | 0.0-10 |
| AB30 | 1.0-2.0 | 83-89 | 0.1-19 | 0.0-19 | 0.0-10 |

bc) Compositions with solketal content of 2.0-3.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / 100 - w ( e ) ) \leq 880.$$

TABLE 45

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AC1 | 2.0-3.0 | 4-10 | 37-51 | 36-50 | 0.0-10 |
| AC2 | 2.0-3.0 | 10-20 | 27-65 | 12-50 | 0.0-10 |
| AC3 | 2.0-3.0 | 20-30 | 17-73 | 0.0-50 | 0.0-10 |
| AC4 | 2.0-3.0 | 30-40 | 7-68 | 0.0-50 | 0.0-10 |
| AC5 | 2.0-3.0 | 40-50 | 0.1-58 | 0.0-50 | 0.0-10 |
| AC6 | 2.0-3.0 | 50-60 | 0.1-48 | 0.0-48 | 0.0-10 |
| AC7 | 2.0-3.0 | 60-70 | 0.1-38 | 0.0-38 | 0.0-10 |
| AC8 | 2.0-3.0 | 70-80 | 0.1-28 | 0.0-28 | 0.0-10 |
| AC9 | 2.0-3.0 | 80-90 | 0.1-18 | 0.0-18 | 0.0-10 |
| AC10 | 2.0-3.0 | 4-10 | 37-51 | 36-50 | 0.1-10 |
| AC11 | 2.0-3.0 | 10-20 | 27-65 | 12-50 | 0.1-10 |
| AC12 | 2.0-3.0 | 20-30 | 17-73 | 0.0-50 | 0.1-10 |
| AC13 | 2.0-3.0 | 30-40 | 7-68 | 0.0-50 | 0.1-10 |
| AC14 | 2.0-3.0 | 40-50 | 0.1-58 | 0.0-50 | 0.1-10 |
| AC15 | 2.0-3.0 | 50-60 | 0.1-48 | 0.0-48 | 0.1-10 |
| AC16 | 2.0-3.0 | 60-70 | 0.1-38 | 0.0-38 | 0.1-10 |
| AC17 | 2.0-3.0 | 70-80 | 0.1-28 | 0.0-28 | 0.1-10 |
| AC18 | 2.0-3.0 | 80-90 | 0.1-18 | 0.0-18 | 0.1-10 |
| AC19 | 2.0-3.0 | 20-30 | 17-73 | 0.1-50 | 0.0-10 |
| AC20 | 2.0-3.0 | 30-40 | 7-68 | 0.1-50 | 0.0-10 |
| AC21 | 2.0-3.0 | 40-50 | 0.1-58 | 0.1-50 | 0.0-10 |
| AC22 | 2.0-3.0 | 50-60 | 0.1-48 | 0.1-48 | 0.0-10 |
| AC23 | 2.0-3.0 | 60-70 | 0.1-38 | 0.1-38 | 0.0-10 |
| AC24 | 2.0-3.0 | 70-80 | 0.1-28 | 0.1-28 | 0.0-10 |
| AC25 | 2.0-3.0 | 80-90 | 0.1-18 | 0.1-18 | 0.0-10 |
| AC26 | 2.0-3.0 | 20-31 | 17-73 | 0.0-50 | 0.0-10 |
| AC27 | 2.0-3.0 | 34-41 | 7-68 | 0.0-50 | 0.0-10 |
| AC28 | 2.0-3.0 | 44-51 | 0.1-58 | 0.0-50 | 0.0-10 |
| AC29 | 2.0-3.0 | 54-61 | 0.1-48 | 0.0-48 | 0.0-10 |
| AC30 | 2.0-3.0 | 63-70 | 0.1-38 | 0.0-38 | 0.0-10 |
| AC31 | 2.0-3.0 | 73-80 | 0.1-28 | 0.0-28 | 0.0-10 |
| AC32 | 2.0-3.0 | 83-89 | 0.1-18 | 0.0-18 | 0.0-10 |

bd) Compositions with solketal content of 3.0-4.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / 100 - w ( e ) ) \leq 880.$$

TABLE 46

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AD1 | 3.0-4.0 | 1-10 | 36-57 | 29-50 | 0.0-10 |
| AD2 | 3.0-4.0 | 10-20 | 26-70 | 6-50 | 0.0-10 |
| AD3 | 3.0-4.0 | 20-30 | 16-73 | 0.0-50 | 0.0-10 |
| AD4 | 3.0-4.0 | 30-40 | 6-67 | 0.0-50 | 0.0-10 |
| AD5 | 3.0-4.0 | 40-50 | 0.1-57 | 0.0-50 | 0.0-10 |
| AD6 | 3.0-4.0 | 50-60 | 0.1-47 | 0.0-47 | 0.0-10 |
| AD7 | 3.0-4.0 | 60-70 | 0.1-37 | 0.0-37 | 0.0-10 |
| AD8 | 3.0-4.0 | 70-80 | 0.1-27 | 0.0-27 | 0.0-10 |
| AD9 | 3.0-4.0 | 80-87 | 0.1-17 | 0.0-17 | 0.0-10 |
| AD10 | 3.0-4.0 | 1-10 | 36-57 | 29-50 | 0.1-10 |
| AD11 | 3.0-4.0 | 10-20 | 26-70 | 6-50 | 0.1-10 |
| AD12 | 3.0-4.0 | 20-30 | 16-73 | 0.0-50 | 0.1-10 |
| AD13 | 3.0-4.0 | 30-40 | 6-67 | 0.0-50 | 0.1-10 |
| AD14 | 3.0-4.0 | 40-50 | 0.1-57 | 0.0-50 | 0.1-10 |
| AD15 | 3.0-4.0 | 50-60 | 0.1-47 | 0.0-47 | 0.1-10 |
| AD16 | 3.0-4.0 | 60-70 | 0.1-37 | 0.0-37 | 0.1-10 |
| AD17 | 3.0-4.0 | 70-80 | 0.1-27 | 0.0-27 | 0.1-10 |
| AD18 | 3.0-4.0 | 80-87 | 0.1-17 | 0.0-17 | 0.1-10 |
| AD19 | 3.0-4.0 | 20-30 | 16-73 | 0.1-50 | 0.0-10 |
| AD20 | 3.0-4.0 | 30-40 | 6-67 | 0.1-50 | 0.0-10 |
| AD21 | 3.0-4.0 | 40-50 | 0.1-57 | 0.1-50 | 0.0-10 |
| AD22 | 3.0-4.0 | 50-60 | 0.1-47 | 0.1-47 | 0.0-10 |
| AD23 | 3.0-4.0 | 60-70 | 0.1-37 | 0.1-37 | 0.0-10 |
| AD24 | 3.0-4.0 | 70-80 | 0.1-27 | 0.1-27 | 0.0-10 |
| AD25 | 3.0-4.0 | 80-87 | 0.1-17 | 0.1-17 | 0.0-10 |

be) Compositions with solketal content of 4.0-5.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / 100 - w ( e ) ) \leq 880.$$

TABLE 47

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AE1 | 4.0-5.0 | 0.1-10 | 35-62 | 23-50 | 0.0-10 |
| AE2 | 4.0-5.0 | 10-20 | 25-75 | 0.0-50 | 0.0-10 |
| AE3 | 4.0-5.0 | 20-30 | 15-75 | 0.0-50 | 0.0-10 |
| AE4 | 4.0-5.0 | 30-40 | 5-66 | 0.0-50 | 0.0-10 |
| AE5 | 4.0-5.0 | 40-50 | 0.1-56 | 0.0-50 | 0.0-10 |
| AE6 | 4.0-5.0 | 50-60 | 0.1-46 | 0.0-46 | 0.0-10 |
| AE7 | 4.0-5.0 | 60-70 | 0.1-36 | 0.0-36 | 0.0-10 |
| AE8 | 4.0-5.0 | 70-80 | 0.1-26 | 0.0-26 | 0.0-10 |
| AE9 | 4.0-5.0 | 80-84 | 6-16 | 0.0-10 | 0.0-10 |
| AE10 | 4.0-5.0 | 0.1-10 | 35-62 | 23-50 | 0.1-10 |
| AE11 | 4.0-5.0 | 10-20 | 25-75 | 0.0-50 | 0.1-10 |
| AE12 | 4.0-5.0 | 20-30 | 15-75 | 0.0-50 | 0.1-10 |
| AE13 | 4.0-5.0 | 30-40 | 5-66 | 0.0-50 | 0.1-10 |
| AE14 | 4.0-5.0 | 40-50 | 0.1-56 | 0.0-50 | 0.1-10 |
| AE15 | 4.0-5.0 | 50-60 | 0.1-46 | 0.0-46 | 0.1-10 |
| AE16 | 4.0-5.0 | 60-70 | 0.1-36 | 0.0-36 | 0.1-10 |
| AE17 | 4.0-5.0 | 70-80 | 0.1-26 | 0.0-26 | 0.1-10 |
| AE18 | 4.0-5.0 | 80-84 | 6-16 | 0.0-10 | 0.1-10 |
| AE19 | 4.0-5.0 | 10-20 | 25-75 | 0.1-50 | 0.0-10 |
| AE20 | 4.0-5.0 | 20-30 | 15-75 | 0.1-50 | 0.0-10 |
| AE21 | 4.0-5.0 | 30-40 | 5-66 | 0.1-50 | 0.0-10 |
| AE22 | 4.0-5.0 | 40-50 | 0.1-56 | 0.1-50 | 0.0-10 |
| AE23 | 4.0-5.0 | 50-60 | 0.1-46 | 0.1-46 | 0.0-10 |
| AE24 | 4.0-5.0 | 60-70 | 0.1-36 | 0.1-36 | 0.0-10 |
| AE25 | 4.0-5.0 | 70-80 | 0.1-26 | 0.1-26 | 0.0-10 |
| AE26 | 4.0-5.0 | 80-84 | 6-16 | 0.1-10 | 0.0-10 |

bf) Compositions with solketal content of 5.0-6.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / 100 - w ( e ) ) \leq 880.$$

TABLE 48

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AF1 | 5.0-6.0 | 0.1-10 | 34-67 | 23-50 | 0.0-10 |
| AF2 | 5.0-6.0 | 10-20 | 24-77 | 0.0-50 | 0.0-10 |
| AF3 | 5.0-6.0 | 20-30 | 14-75 | 0.0-50 | 0.0-10 |
| AF4 | 5.0-6.0 | 30-40 | 4-65 | 0.0-50 | 0.0-10 |
| AF5 | 5.0-6.0 | 40-50 | 0.1-55 | 0.0-50 | 0.0-10 |
| AF6 | 5.0-6.0 | 50-60 | 0.1-45 | 0.0-45 | 0.0-10 |
| AF7 | 5.0-6.0 | 60-70 | 0.1-35 | 0.0-35 | 0.0-10 |
| AF8 | 5.0-6.0 | 70-80 | 0.1-25 | 0.0-25 | 0.0-10 |
| AF9 | 5.0-6.0 | 80-82 | 11-15 | 0.0-4 | 0.0-10 |
| AF10 | 5.0-6.0 | 0.1-10 | 34-67 | 23-50 | 0.1-10 |
| AF11 | 5.0-6.0 | 10-20 | 24-77 | 0.0-50 | 0.1-10 |
| AF12 | 5.0-6.0 | 20-30 | 14-75 | 0.0-50 | 0.1-10 |
| AF13 | 5.0-6.0 | 30-40 | 4-65 | 0.0-50 | 0.1-10 |
| AF14 | 5.0-6.0 | 40-50 | 0.1-55 | 0.0-50 | 0.1-10 |
| AF15 | 5.0-6.0 | 50-60 | 0.1-45 | 0.0-45 | 0.1-10 |
| AF16 | 5.0-6.0 | 60-70 | 0.1-35 | 0.0-35 | 0.1-10 |
| AF17 | 5.0-6.0 | 70-80 | 0.1-25 | 0.0-25 | 0.1-10 |
| AF18 | 5.0-6.0 | 80-82 | 11-15 | 0.0-4 | 0.1-10 |
| AF19 | 5.0-6.0 | 10-20 | 24-77 | 0.1-50 | 0.0-10 |
| AF20 | 5.0-6.0 | 20-30 | 14-75 | 0.1-50 | 0.0-10 |
| AF21 | 5.0-6.0 | 30-40 | 4-65 | 0.1-50 | 0.0-10 |
| AF22 | 5.0-6.0 | 40-50 | 0.1-55 | 0.1-50 | 0.0-10 |
| AF23 | 5.0-6.0 | 50-60 | 0.1-45 | 0.1-45 | 0.0-10 |
| AF24 | 5.0-6.0 | 60-70 | 0.1-35 | 0.1-35 | 0.0-10 |
| AF25 | 5.0-6.0 | 70-80 | 0.1-25 | 0.1-25 | 0.0-10 |
| AF26 | 5.0-6.0 | 80-82 | 11-15 | 0.1-4 | 0.0-10 |

bg) Compositions with solketal content of 6.0-8.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / 100 - w ( e ) ) \leq 880.$$

TABLE 49

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AG1 | 6.0-8.0 | 0.1-10 | 32-78 | 4-50 | 0.0-10 |
| AG2 | 6.0-8.0 | 10-20 | 22-80 | 0.0-50 | 0.0-10 |
| AG3 | 6.0-8.0 | 20-30 | 12-74 | 0.0-50 | 0.0-10 |
| AG4 | 6.0-8.0 | 30-40 | 2-64 | 0.0-50 | 0.0-10 |
| AG5 | 6.0-8.0 | 40-50 | 0.1-54 | 0.0-50 | 0.0-10 |
| AG6 | 6.0-8.0 | 50-60 | 0.1-44 | 0.0-44 | 0.0-10 |
| AG7 | 6.0-8.0 | 60-70 | 0.1-34 | 0.0-34 | 0.0-10 |
| AG8 | 6.0-8.0 | 70-79 | 3-24 | 0.0-21 | 0.0-10 |
| AG9 | 6.0-8.0 | 0.1-10 | 32-78 | 4-50 | 0.1-10 |
| AG10 | 6.0-8.0 | 10-20 | 22-80 | 0.0-50 | 0.1-10 |
| AG11 | 6.0-8.0 | 20-30 | 12-74 | 0.0-50 | 0.1-10 |
| AG12 | 6.0-8.0 | 30-40 | 2-64 | 0.0-50 | 0.1-10 |
| AG13 | 6.0-8.0 | 40-50 | 0.1-54 | 0.0-50 | 0.1-10 |
| AG14 | 6.0-8.0 | 50-60 | 0.1-44 | 0.0-44 | 0.1-10 |
| AG15 | 6.0-8.0 | 60-70 | 0.1-34 | 0.0-34 | 0.1-10 |
| AG16 | 6.0-8.0 | 70-79 | 3-24 | 0.0-21 | 0.1-10 |
| AG17 | 6.0-8.0 | 10-20 | 22-80 | 0.1-50 | 0.0-10 |
| AG18 | 6.0-8.0 | 20-30 | 12-74 | 0.1-50 | 0.0-10 |
| AG19 | 6.0-8.0 | 30-40 | 2-64 | 0.1-50 | 0.0-10 |
| AG20 | 6.0-8.0 | 40-50 | 0.1-54 | 0.1-50 | 0.0-10 |
| AG21 | 6.0-8.0 | 50-60 | 0.1-44 | 0.1-44 | 0.0-10 |
| AG22 | 6.0-8.0 | 60-70 | 0.1-34 | 0.1-34 | 0.0-10 |
| AG23 | 6.0-8.0 | 70-79 | 3-24 | 0.1-21 | 0.0-10 |

bh) Compositions with solketal content of 8.0-10.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / 100 - w ( e ) ) \leq 880.$$

TABLE 50

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AH1 | 8.0-10.0 | 0.1-10 | 30-83 | 0.0-50 | 0.0-10 |
| AH2 | 8.0-10.0 | 10-20 | 20-80 | 0.0-50 | 0.0-10 |
| AH3 | 8.0-10.0 | 20-30 | 10-72 | 0.0-50 | 0.0-10 |
| AH4 | 8.0-10.0 | 30-40 | 0.1-62 | 0.0-50 | 0.0-10 |
| AH5 | 8.0-10.0 | 40-50 | 0.1-52 | 0.0-50 | 0.0-10 |
| AH6 | 8.0-10.0 | 50-60 | 0.1-42 | 0.0-42 | 0.0-10 |
| AH7 | 8.0-10.0 | 60-70 | 0.1-32 | 0.0-32 | 0.0-10 |
| AH8 | 8.0-10.0 | 70-74 | 13-22 | 0.0-9 | 0.0-10 |
| AH9 | 8.0-10.0 | 0.1-10 | 30-83 | 0.0-50 | 0.1-10 |
| AH10 | 8.0-10.0 | 10-20 | 20-80 | 0.0-50 | 0.1-10 |
| AH11 | 8.0-10.0 | 20-30 | 10-72 | 0.0-50 | 0.1-10 |
| AH12 | 8.0-10.0 | 30-40 | 0.1-62 | 0.0-50 | 0.1-10 |
| AH13 | 8.0-10.0 | 40-50 | 0.1-52 | 0.0-50 | 0.1-10 |
| AH14 | 8.0-10.0 | 50-60 | 0.1-42 | 0.0-42 | 0.1-10 |
| AH15 | 8.0-10.0 | 60-70 | 0.1-32 | 0.0-32 | 0.1-10 |
| AH16 | 8.0-10.0 | 70-74 | 13-22 | 0.0-9 | 0.1-10 |
| AH17 | 8.0-10.0 | 0.1-10 | 30-83 | 0.1-50 | 0.0-10 |
| AH18 | 8.0-10.0 | 10-20 | 20-80 | 0.1-50 | 0.0-10 |
| AH19 | 8.0-10.0 | 20-30 | 10-72 | 0.1-50 | 0.0-10 |
| AH20 | 8.0-10.0 | 30-40 | 0.1-62 | 0.1-50 | 0.0-10 |
| AH21 | 8.0-10.0 | 40-50 | 0.1-52 | 0.1-50 | 0.0-10 |
| AH22 | 8.0-10.0 | 50-60 | 0.1-42 | 0.1-42 | 0.0-10 |
| AH23 | 8.0-10.0 | 60-70 | 0.1-32 | 0.1-32 | 0.0-10 |
| AH24 | 8.0-10.0 | 70-74 | 13-22 | 0.1-9 | 0.0-10 |

bi) Compositions with solketal content of 10.0-12.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / 100 \leq ( e ) ) \leq 880.$$

TABLE 51

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AI1 | 10.0-12.0 | 0.1-10 | 28-87 | 0.0-50 | 0.0-10 |
| AI2 | 10.0-12.0 | 10-20 | 18-80 | 0.0-50 | 0.0-10 |
| AI3 | 10.0-12.0 | 20-30 | 8-70 | 0.0-50 | 0.0-10 |
| AI4 | 10.0-12.0 | 30-40 | 0.1-60 | 0.0-50 | 0.0-10 |
| AI5 | 10.0-12.0 | 40-50 | 0.1-50 | 0.0-50 | 0.0-10 |
| AI6 | 10.0-12.0 | 50-60 | 0.1-40 | 0.0-40 | 0.0-10 |
| AI7 | 10.0-12.0 | 60-68 | 11-30 | 0.0-19 | 0.0-10 |
| AI8 | 10.0-12.0 | 0.1-10 | 28-87 | 0.0-50 | 0.1-10 |
| AI9 | 10.0-12.0 | 10-20 | 18-80 | 0.0-50 | 0.1-10 |
| AI10 | 10.0-12.0 | 20-30 | 8-70 | 0.0-50 | 0.1-10 |
| AI11 | 10.0-12.0 | 30-40 | 0.1-60 | 0.0-50 | 0.1-10 |
| AI12 | 10.0-12.0 | 40-50 | 0.1-50 | 0.0-50 | 0.1-10 |
| AI13 | 10.0-12.0 | 50-60 | 0.1-40 | 0.0-40 | 0.1-10 |
| AI14 | 10.0-12.0 | 60-68 | 11-30 | 0.0-19 | 0.1-10 |
| AI15 | 10.0-12.0 | 0.1-10 | 28-87 | 0.1-50 | 0.0-10 |
| AI16 | 10.0-12.0 | 10-20 | 18-80 | 0.1-50 | 0.0-10 |
| AI17 | 10.0-12.0 | 20-30 | 8-70 | 0.1-50 | 0.0-10 |
| AI18 | 10.0-12.0 | 30-40 | 0.1-60 | 0.1-50 | 0.0-10 |
| AI19 | 10.0-12.0 | 40-50 | 0.1-50 | 0.1-50 | 0.0-10 |
| AI20 | 10.0-12.0 | 50-60 | 0.1-40 | 0.1-40 | 0.0-10 |
| AI21 | 10.0-12.0 | 60-68 | 11-30 | 0.1-19 | 0.0-10 |

bj) Compositions with solketal content of 12.0-14.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 880.$$

TABLE 52

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AJ1 | 12.0-14.0 | 0.1-10 | 26-87 | 0.0-50 | 0.0-10 |
| AJ2 | 12.0-14.0 | 10-20 | 16-78 | 0.0-50 | 0.0-10 |
| AJ3 | 12.0-14.0 | 20-30 | 6-68 | 0.0-50 | 0.0-10 |
| AJ4 | 12.0-14.0 | 30-40 | 0.1-58 | 0.0-50 | 0.0-10 |
| AJ5 | 12.0-14.0 | 40-50 | 0.1-48 | 0.0-48 | 0.0-10 |
| AJ6 | 12.0-14.0 | 50-60 | 7-38 | 0.0-30 | 0.0-10 |
| AJ7 | 12.0-14.0 | 60-63 | 21-28 | 0.0-7 | 0.0-10 |
| AJ8 | 12.0-14.0 | 0.1-10 | 26-87 | 0.0-50 | 0.1-10 |
| AJ9 | 12.0-14.0 | 10-20 | 16-78 | 0.0-50 | 0.1-10 |
| AJ10 | 12.0-14.0 | 20-30 | 6-68 | 0.0-50 | 0.1-10 |
| AJ11 | 12.0-14.0 | 30-40 | 0.1-58 | 0.0-50 | 0.1-10 |
| AJ12 | 12.0-14.0 | 40-50 | 0.1-48 | 0.0-48 | 0.1-10 |
| AJ13 | 12.0-14.0 | 50-60 | 7-38 | 0.0-30 | 0.1-10 |
| AJ14 | 12.0-14.0 | 60-63 | 21-28 | 0.0-7 | 0.1-10 |
| AJ15 | 12.0-14.0 | 0.1-10 | 26-87 | 0.1-50 | 0.0-10 |
| AJ16 | 12.0-14.0 | 10-20 | 16-78 | 0.1-50 | 0.0-10 |
| AJ17 | 12.0-14.0 | 20-30 | 6-68 | 0.1-50 | 0.0-10 |
| AJ18 | 12.0-14.0 | 30-40 | 0.1-58 | 0.1-50 | 0.0-10 |
| AJ19 | 12.0-14.0 | 40-50 | 0.1-48 | 0.1-48 | 0.0-10 |
| AJ20 | 12.0-14.0 | 50-60 | 7-38 | 0.1-30 | 0.0-10 |
| AJ21 | 12.0-14.0 | 60-63 | 21-28 | 0.1-7 | 0.0-10 |

bk) Compositions with solketal content of 14.0-16.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 880.$$

TABLE 53

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AK1 | 14.0-16.0 | 0.1-10 | 24-86 | 0.0-50 | 0.0-10 |
| AK2 | 14.0-16.0 | 10-20 | 14-76 | 0.0-50 | 0.0-10 |
| AK3 | 14.0-16.0 | 20-30 | 4-66 | 0.0-50 | 0.0-10 |
| AK4 | 14.0-16.0 | 30-40 | 0.1-56 | 0.0-50 | 0.0-10 |
| AK5 | 14.0-16.0 | 40-50 | 5-46 | 0.0-41 | 0.0-10 |
| AK6 | 14.0-16.0 | 50-57 | 18-36 | 0.0-18 | 0.0-10 |
| AK7 | 14.0-16.0 | 0.1-10 | 24-86 | 0.0-50 | 0.1-10 |
| AK8 | 14.0-16.0 | 10-20 | 14-76 | 0.0-50 | 0.1-10 |
| AK9 | 14.0-16.0 | 20-30 | 4-66 | 0.0-50 | 0.1-10 |
| AK10 | 14.0-16.0 | 30-40 | 0.1-56 | 0.0-50 | 0.1-10 |
| AK11 | 14.0-16.0 | 40-50 | 5-46 | 0.0-41 | 0.1-10 |
| AK12 | 14.0-16.0 | 50-57 | 18-36 | 0.0-18 | 0.1-10 |
| AK13 | 14.0-16.0 | 0.1-10 | 24-86 | 0.1-50 | 0.0-10 |
| AK14 | 14.0-16.0 | 10-20 | 14-76 | 0.1-50 | 0.0-10 |
| AK15 | 14.0-16.0 | 20-30 | 4-66 | 0.1-50 | 0.0-10 |
| AK16 | 14.0-16.0 | 30-40 | 0.1-56 | 0.1-50 | 0.0-10 |
| AK17 | 14.0-16.0 | 40-50 | 5-46 | 0.1-41 | 0.0-10 |
| AK18 | 14.0-16.0 | 50-57 | 18-36 | 0.1-18 | 0.0-10 |

bl) Compositions with solketal content of 16.0-18.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 880.$$

TABLE 54

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AL1 | 16.0-18.0 | 0.1-10 | 22-84 | 0.0-50 | 0.0-10 |
| AL2 | 16.0-18.0 | 10-20 | 12-74 | 0.0-50 | 0.0-10 |
| AL3 | 16.0-18.0 | 20-30 | 4-64 | 0.0-50 | 0.0-10 |
| AL4 | 16.0-18.0 | 30-40 | 4-54 | 0.0-50 | 0.0-10 |
| AL5 | 16.0-18.0 | 40-50 | 16-44 | 0.0-28 | 0.0-10 |
| AL6 | 16.0-18.0 | 50-52 | 29-34 | 0.0-5 | 0.0-10 |
| AL7 | 16.0-18.0 | 0.1-10 | 22-84 | 0.0-50 | 0.1-10 |
| AL8 | 16.0-18.0 | 10-20 | 12-74 | 0.0-50 | 0.1-10 |
| AL9 | 16.0-18.0 | 20-30 | 4-64 | 0.0-50 | 0.1-10 |
| AL10 | 16.0-18.0 | 30-40 | 4-54 | 0.0-50 | 0.1-10 |
| AL11 | 16.0-18.0 | 40-50 | 16-44 | 0.0-28 | 0.1-10 |
| AL12 | 16.0-18.0 | 50-52 | 29-34 | 0.0-5 | 0.1-10 |
| AL13 | 16.0-18.0 | 0.1-10 | 22-84 | 0.1-50 | 0.0-10 |
| AL14 | 16.0-18.0 | 10-20 | 12-74 | 0.1-50 | 0.0-10 |
| AL15 | 16.0-18.0 | 20-30 | 4-64 | 0.1-50 | 0.0-10 |
| AL16 | 16.0-18.0 | 30-40 | 4-54 | 0.1-50 | 0.0-10 |
| AL17 | 16.0-18.0 | 40-50 | 16-44 | 0.1-28 | 0.0-10 |
| AL18 | 16.0-18.0 | 50-52 | 29-34 | 0.1-5 | 0.0-10 |

bm) Compositions with solketal content of 18.0-20.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 880.$$

TABLE 55

| | | | | Fossil | |
|---|---|---|---|---|---|
| | Solketal, | Biodiesel, | Renewable | diesel, | Total |
| Specific | w(a) | w(b) | alkane, w(c) | w(d), | Additives |
| Embodiment | (wt. %) | (wt. %) | (wt. %) | (wt. %) | (wt. %) |
| AM1 | 18.0-20.0 | 0.1-10 | 20-82 | 0.0-50 | 0.0-10 |
| AM2 | 18.0-20.0 | 10-20 | 10-72 | 0.0-50 | 0.0-10 |
| AM3 | 18.0-20.0 | 20-30 | 7-62 | 0.0-50 | 0.0-10 |
| AM4 | 18.0-20.0 | 30-40 | 13-52 | 0.0-39 | 0.0-10 |
| AM5 | 18.0-20.0 | 40-47 | 26-42 | 0.0-16 | 0.0-10 |
| AM6 | 18.0-20.0 | 0.1-10 | 20-82 | 0.0-50 | 0.1-10 |
| AM7 | 18.0-20.0 | 10-20 | 10-72 | 0.0-50 | 0.1-10 |
| AM8 | 18.0-20.0 | 20-30 | 7-62 | 0.0-50 | 0.1-10 |
| AM9 | 18.0-20.0 | 30-40 | 13-52 | 0.0-39 | 0.1-10 |
| AM10 | 18.0-20.0 | 40-47 | 26-42 | 0.0-16 | 0.1-10 |
| AM11 | 18.0-20.0 | 0.1-10 | 20-82 | 0.1-50 | 0.0-10 |
| AM12 | 18.0-20.0 | 10-20 | 10-72 | 0.1-50 | 0.0-10 |
| AM13 | 18.0-20.0 | 20-30 | 7-62 | 0.1-50 | 0.0-10 |
| AM14 | 18.0-20.0 | 30-40 | 13-52 | 0.1-39 | 0.0-10 |
| AM15 | 18.0-20.0 | 40-47 | 26-42 | 0.1-16 | 0.0-10 |

bn) Compositions with solketal content of 20.0-22.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 880.$$

TABLE 56

| | Solketal, | Biodiesel, | Renewable | Fossil diesel, | Total |
|---|---|---|---|---|---|
| Specific | w(a) | w(b) | alkane, w(c) | w(d), | Additives |
| Embodiment | (wt. %) | (wt. %) | (wt. %) | (wt. %) | (wt. %) |
| AN1 | 20.0-22.0 | 0.1-10 | 18-80 | 0.0-50 | 0.0-10 |
| AN2 | 20.0-22.0 | 10-20 | 10-70 | 0.0-50 | 0.0-10 |
| AN3 | 20.0-22.0 | 20-30 | 10-60 | 0.0-50 | 0.0-10 |
| AN4 | 20.0-22.0 | 30-41 | 24-50 | 0.0-26 | 0.0-10 |
| AN5 | 20.0-22.0 | 0.1-10 | 18-80 | 0.0-50 | 0.1-10 |
| AN6 | 20.0-22.0 | 10-20 | 10-70 | 0.0-50 | 0.1-10 |
| AN7 | 20.0-22.0 | 20-30 | 10-60 | 0.0-50 | 0.1-10 |
| AN8 | 20.0-22.0 | 30-41 | 24-50 | 0.0-26 | 0.1-10 |
| AN9 | 20.0-22.0 | 0.1-10 | 18-80 | 0.1-50 | 0.0-10 |
| AN10 | 20.0-22.0 | 10-20 | 10-70 | 0.1-50 | 0.0-10 |
| AN11 | 20.0-22.0 | 20-30 | 10-60 | 0.1-50 | 0.0-10 |
| AN12 | 20.0-22.0 | 30-41 | 24-50 | 0.1-26 | 0.0-10 |

bo) Compositions with solketal content of 22.0-24.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 880.$$

TABLE 57

| | Solketal, | Biodiesel, | Renewable | Fossil diesel, | Total |
|---|---|---|---|---|---|
| Specific | w(a) | w(b) | alkane, w(c) | w(d), | Additives |
| Embodiment | (wt. %) | (wt. %) | (wt. %) | (wt. %) | (wt. %) |
| AO1 | 22.0-24.0 | 0.1-10 | 17-78 | 0.0-50 | 0.0-10 |
| AO2 | 22.0-24.0 | 10-20 | 14-68 | 0.0-50 | 0.0-10 |
| AO3 | 22.0-24.0 | 20-30 | 21-58 | 0.0-37 | 0.0-10 |
| AO4 | 22.0-24.0 | 30-41 | 34-48 | 0.0-14 | 0.0-10 |
| AO5 | 22.0-24.0 | 0.1-10 | 17-78 | 0.0-50 | 0.1-10 |
| AO6 | 22.0-24.0 | 10-20 | 14-68 | 0.0-50 | 0.1-10 |
| AO7 | 22.0-24.0 | 20-30 | 21-58 | 0.0-37 | 0.1-10 |
| AO8 | 22.0-24.0 | 30-41 | 34-48 | 0.0-14 | 0.1-10 |
| AO9 | 22.0-24.0 | 0.1-10 | 17-78 | 0.1-50 | 0.0-10 |
| AO10 | 22.0-24.0 | 10-20 | 14-68 | 0.1-50 | 0.0-10 |
| AO11 | 22.0-24.0 | 20-30 | 21-58 | 0.1-37 | 0.0-10 |
| AO12 | 22.0-24.0 | 30-41 | 34-48 | 0.1-14 | 0.0-10 |

bp) Compositions with solketal content of 24.0-26.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 880.$$

TABLE 58

| | Solketal, | Biodiesel, | Renewable | Fossil diesel, | Total |
|---|---|---|---|---|---|
| Specific | w(a) | w(b) | alkane, w(c) | w(d), | Additives |
| Embodiment | (wt. %) | (wt. %) | (wt. %) | (wt. %) | (wt. %) |
| AP1 | 24.0-26.0 | 0.1-10 | 17-76 | 0.0-50 | 0.0-10 |
| AP2 | 24.0-26.0 | 10-20 | 18-66 | 0.0-48 | 0.0-10 |
| AP3 | 24.0-26.0 | 20-31 | 31-56 | 0.0-25 | 0.0-10 |
| AP4 | 24.0-26.0 | 0.1-10 | 17-76 | 0.0-50 | 0.1-10 |
| AP5 | 24.0-26.0 | 10-20 | 18-66 | 0.0-48 | 0.1-10 |
| AP6 | 24.0-26.0 | 20-31 | 31-56 | 0.0-25 | 0.1-10 |
| AP7 | 24.0-26.0 | 0.1-10 | 17-76 | 0.1-50 | 0.0-10 |
| AP8 | 24.0-26.0 | 10-20 | 18-66 | 0.1-48 | 0.0-10 |
| AP9 | 24.0-26.0 | 20-31 | 31-56 | 0.1-25 | 0.0-10 |

bq) Compositions with solketal content of 26.0-28.0, 28.0-30.0 or 30.0-32.0 weight-% and density in the range of 815-880 kg/m³: compositions falling within the amount ranges specified in the table below and additionally satisfying the equation

$$815 \leq [ ( w ( a ) \times 1063 ) + ( w ( b ) \times 885 ) + ( w ( c ) \times 780 ) + ( w ( d ) \times 825 ) ] / 100 \leq 880$$

or, if the additive content is above 0 weight-%, satisfying the following equation:

$$815 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 880.$$

TABLE 59

| | Solketal, | Biodiesel, | Renewable | Fossil diesel, | Total |
|---|---|---|---|---|---|
| Specific | w(a) | w(b) | alkane, w(c) | w(d), | Additives |
| Embodiment | (wt. %) | (wt. %) | (wt. %) | (wt. %) | (wt. %) |
| AQ1 | 26.0-28.0 | 0.1-10 | 21-74 | 0.0-50 | 0.0-10 |
| AQ2 | 26.0-28.0 | 10-20 | 29-64 | 0.0-35 | 0.0-10 |
| AQ3 | 26.0-28.0 | 20-25 | 42-54 | 0.0-12 | 0.0-10 |
| AQ4 | 28.0-30.0 | 0.1-10 | 26-72 | 0.0-46 | 0.0-10 |
| AQ5 | 28.0-30.0 | 10-20 | 39-62 | 0.0-23 | 0.0-10 |
| AQ6 | 30.0-32.0 | 0.1-10 | 37-70 | 0.0-33 | 0.0-10 |
| AQ7 | 30.0-32.0 | 10-14 | 50-60 | 0.0-10 | 0.0-10 |
| AQ8 | 26.0-28.0 | 0.1-10 | 21-74 | 0.0-50 | 0.1-10 |
| AQ9 | 26.0-28.0 | 10-20 | 29-64 | 0.0-35 | 0.1-10 |
| AQ10 | 26.0-28.0 | 20-25 | 42-54 | 0.0-12 | 0.1-10 |
| AQ11 | 28.0-30.0 | 0.1-10 | 26-72 | 0.0-46 | 0.1-10 |
| AQ12 | 28.0-30.0 | 10-20 | 39-62 | 0.0-23 | 0.1-10 |
| AQ13 | 30.0-32.0 | 0.1-10 | 37-70 | 0.0-33 | 0.1-10 |
| AQ14 | 30.0-32.0 | 10-14 | 50-60 | 0.0-10 | 0.1-10 |
| AQ15 | 26.0-28.0 | 0.1-10 | 21-74 | 0.1-50 | 0.0-10 |
| AQ16 | 26.0-28.0 | 10-20 | 29-64 | 0.1-35 | 0.0-10 |
| AQ17 | 26.0-28.0 | 20-25 | 42-54 | 0.1-12 | 0.0-10 |
| AQ18 | 28.0-30.0 | 0.1-10 | 26-72 | 0.1-46 | 0.0-10 |
| AQ19 | 28.0-30.0 | 10-20 | 39-62 | 0.1-23 | 0.0-10 |
| AQ20 | 30.0-32.0 | 0.1-10 | 37-70 | 0.1-33 | 0.0-10 |
| AQ21 | 30.0-32.0 | 10-14 | 50-60 | 0.1-10 | 0.0-10 |

In further embodiments of the invention, the diesel fuel compositions are as characterized in any of the specific entries of the above tables, but having a content of the one or more additives in the preferred range of 0.5 to 2 weight-%. Likewise, in further embodiments of the invention, the diesel fuel compositions are as characterized in any of the specific entries of the above tables, but having a fossil diesel content in a range starting at the lower end at 5 weight-% or more, unless an even higher value is specified as lower limit in the respective entry of the tables above.

Of course, the present invention not only relates to any of the above-specified compositions individually, but also to any combination, subset and/or entirety of the above-specified compositions.

In some countries, there are non-technical (legal) restrictions on the amount of biodiesel that may be incorporated into commercial diesel fuel. For instance, EN 590 limits the content of biodiesel to a maximum value of only 7%. According to yet another specific embodiment (“embodiment (X)”), it is therefore possible to mix the diesel fuel compositions of the inventions (other than those of embodiment (X) itself), as described hereinabove and below, with additional fossil fuel to thereby comply with legal requirements. Of course, the compositions of embodiment (X) accomplish only to a limited extent the beneficial effect of increasing the content of fuel components from renewable resources. However, even a limited benefit may be better than nothing under circumstances where greater reductions of fossil fuel are not possible for non-technical reasons. For this embodiment (X), there is no particular upper limit for the fossil fuel, while the further components of the compositions according to the invention must be provided in such ratios that they are in agreement with the above indications when (mentally) subtracting part or all of the fossil fuel component.

It is another aspect of said embodiment (X) to provide any of the diesel fuel compositions of the invention described herein as a supplement for addition to fossil diesel fuel.

### 5.2.1. Biodiesel

According to the present invention, it is possible to use any biodiesel, i.e. any composition of fatty acid methyl, ethyl or propyl esters. Biodiesel is typically obtained by transesterification of oils and/or fats from renewable resources or esterification of fatty acids from renewable sources with monovalent alcohols, e.g., methanol, ethanol or propanol.

The fatty acids to be esterified and the fatty acids contained in the oils/fats typically have number average chain lengths of 4 to 28 carbon atoms, more specifically 6 to 24 carbon atoms and especially 6 to 22 carbon atoms (including the carbon atom of the carboxyl group). The monovalent alcohol is typically selected from methanol, ethanol, propanol, isopropanol, n-butanol and iso-butanol and any mixture thereof. Methanol is preferred.

Biodiesel can for instance be prepared using the methods described in “The Biodiesel Handbook” by G. Knothe, J. Krahl and J. v. Gerpen, 2^{nd} Ed. 2010 (https://www.sciencedirect.com/book/9781893997622/the-biodiesel-handbook) as well as the methods of WO 2000/075098 A and documents cited therein.

If biodiesel is prepared by transesterification of oils or fats (i.e. triglycerides), glycerin is obtained as a by-product. According to a preferred aspect of the present invention, the glycerin obtained in this manner is used as a raw material for producing solketal by reacting it with acetone.

Biodiesel typically contains water as an unavoidable impurity. As explained in more detail below, in an embodiment of the invention it is possible to use biodiesel with higher water content of 200 mg/kg to 4000 mg/kg and preferably 250 mg/kg to 3000 mg/kg, such as 300 mg/kg to 2500 mg/kg.

### 5.2.2. Solketal

Solketal, i.e. a substance with the IUPAC name (2,2-dimethyl-1,3-dioxolan-4-yl)methanol, also known as isopropylidene glycerol, has the following chemical structure:

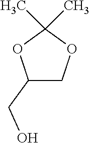

Solketal has a chiral center, namely the carbon atom in the heterocycle carrying the hydroxy methylene substituent. Solketal may therefore exist in the form of pure enantiomers, in the form of a racemate consisting of a 50:50 mixture of the two enantiomers, or in the form of a mixture of the two enantiomers in any other mixing ratio. Any of these forms is suitable for use in the present invention.

Solketal can be formed by condensation of acetone with glycerol. Glycerol preferably originates from renewable sources, e.g. as a by-product when manufacturing biodiesel from oils and/or fats from plant materials or animals by transesterification, as mentioned above. Acetone can be obtained via Hock-Cumol (doi: https://doi.org/10.1002/cber.19440770321), preferably also obtained from renewable sources, e.g. via ABE fermentation of carbohydrates from renewable sources. The solketal formation is advantageously carried out making use of a catalyst. Suitable catalysts include inter alia Fe(III) compounds, clays, zeolites, and ion exchange resins. A comprehensive review of the literature on the production of solketal is found in I. Correa et al. in Sustainable Chemistry, 2021, 2, 286-324. https://doi.org/10.3390/suschem2020017.

The above-mentioned condensation of acetone with glycerol may result in the formation of the isomer 2,2-dimethyl-1 3-dioxan-5-ol as a by-product:

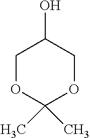

This substance exhibits performance characteristics in fuel that are comparable to those of solketal. There is, therefore, no need to remove or reduce the amount of this isomer in the solketal to be used in the present invention. In some embodiments, the content of this isomer in the solketal is less than 10 weight-%, preferably less than 5 weight-% and more preferably less than 2 weight-%, wherein these weight-% indications are based on the total amount of solketal and its isomer being 100%. These indications are based on the total weight of the solketal, including the isomer and any other impurity.

### 5.2.3. Renewable Alkane Fuel

The renewable alkane fuel can be HVO or other alkane-containing fuel from renewable sources like e-fuels. HVO can be produced by treating vegetable oil with hydrogen under elevated temperature and/or pressure in the presence of a catalyst. Further information on HVO and its manufacturing can be found in the review by A. Sonthalia and N. Kumar in Journal of the Energy Institute, Volume 92, Issue 1, February 2019, Pages 1-17, https://doi.org/10.1016/j.joei.2017.10.008 and references cited therein. For use in the diesel fuel composition of the present invention, the HVO should preferably comply with the criteria specified in DIN EN 15940.

E-fuels can be obtained by reacting carbon monoxide or carbon dioxide with hydrogen. Information on the state of the art on the production of e-fuels can be found in the article of S. Saeidi et al. in Progress in Energy and Combustion Science, Volume 85, July 2021, 100905, https://doi.org/10.1016/j.pecs.2021.100905 and references cited therein. In order to be suitable for use in the diesel fuel composition of the present invention, the e-fuels preferably exhibit the same or comparable characteristics as expected for HVO pursuant to DIN EN 15940. Yet another option is to use a mixture of two or more types of renewable alkane fuels as described herein. For such a mixture, the mixing ratios are not particularly restricted.

### 5.2.4. Optional Fossil Diesel Fuel

The diesel fuel composition of the present invention may contain fossil diesel fuel. the quality of this optional component is not particularly limited. It preferably complies with the requirements under EN590. The diesel fuel composition of the present invention preferably contains little or no fossil diesel fuel since the objective is to keep the amount of sp² hybridized carbons e.g. in double bonds in alkenes or aromatic systems as low as possible. Hence, in preferred embodiments, the content of fossil diesel fuel is 40 weight-% or less, more preferably 20 weight-% or less, even more preferably 10 weight-% or less or even 5 weight-% or less. Most preferably fossil diesel fuel is completely absent.

### 5.2.5. Optional Additives

In addition to that, the fuel composition of the invention may contain further optional components and in particular additives designed to ensure accomplishment of certain performance characteristics. These include in particular
additives for improving low temperature stability including especially e.g. vinyl acetates
additives for improving oxidation stability e.g. tert-butylhydroquinone, butylated hydroxytoluene, methyl tert-butyl ether, radical scavengers. A list of suitable commercial products can be found in the document “Oxidationsstabilisatoren für FAME als Blendkomponente in Dieselkraftstoff”, version of Jun. 16, 2022, which has been published under the url: https://www.agqm-biodiesel.de/application/files/1916/5720/0940/No-Harm-Liste_Oxi_deu_07_2022.pdf. A preferred commercial antioxidant is Lanxess Baynox Ultra.
Additives for lubricity, e.g., tall oil methyl esters (TOFA), fatty acid esters, unsaturated fatty acid dimers, aliphatic amines
additives for improving cetane number, e.g., alkyl nitrates such as 2-ethylhexyl nitrate
additives for reducing generation of soot particles including especially e.g. ammonia
colorants such as sudan dyes such as solvent yellow 14, solvent red 23, solvent blue 35
flow improvers, i.e. agents to improve flow characteristics at low temperature, such as (ethyl-) vinylacetate copolymer, polymethacrylate, alkylacrylate
biocides, i.e., agents to protect against microorganisms, such as oxazolidine, isothiazolone (e.g., 5-chloro-2-methyl-isothiazolin-3-one (CIT), 2-methyl-isothiazolin-3-one (MIT))
antitstatic agents, i.e., agents for improving conductivity of the composition, such as chromium salts of carboxylic acids
hydrogen sulfide scavengers such as triazines, aromatic aldehydes, iron gluconate
corrosion inhibitors, i.e., agents acting by film formation on metal surfaces such as surfactants and alkyl amides
stabilizers, i.e., agents to reduce concentration of active species such as radical scavengers, reducing agents, antioxidants that may act synergistically, e.g., dimethyloctadecylamine
anti-wear agents, i.e., agents acting by film formation on metal surfaces such as carboxylic esters, polyamines, carboxylic amides
filter blocking tendency (FBT) improvers, i.e., agents for preventing clogging of filters by precipitation or viscosity increase similar to pourpoint depressors, e.g., copolymers of styrene with alkylacrylate, and especially those having about 2% alkylacrylate-derived units and 98% styrene-derived units, polymethacrylates.

Besides these additives other additives may also be present. Further information on additives that can be used in accordance with the present invention is found in https://www.atc-europe.org/public/doc52.pdf. Suitable additives are mentioned for instance in the text starting at page 12 of this document. A listing of suitable additives can be found under https://www3.epa.gov/otag/fuels1/ffars/web-dies.htm. Further information on suitable additives is provided in a review article by A. M. Danilov in Petroleum Chemistry, 2015, Vol. 55, No. 3, pp. 169-179.

The relative amount of these optional additives is not particularly limited and depends on the effects to be accomplished. Typically, the additives are each present in a relative amount of 100 to 5000 ppm, preferably 200 to 500 ppm, wherein the specified ranges apply to the relative amount of each individual additive. Said relative amount indications in ppm are preferably on a w/w-basis, but could also be adjusted in the above ranges on v/v-basis, w/v-basis or v/w-basis. Of course, the relative amount of each individual additive is to be chosen depending on the type of additive and the functionality to be accomplished, such that the additive amount is at least as high as required for achieving the desired functionality to the desired extent, but not so high that there is a negative impact on any other relevant property of the fuel composition. For economic reasons, the amount of additive employed is typically at or near the lower end of this range.

The total amount of optional additives is not particularly limited. It is in the range of 0 to 10 weight-%, preferably 0.1 to 3 weight-% and typically in the range of 0.5 to 2 weight-%.

### 5.2.6. Preferred Embodiments

According to preferred embodiments, the diesel fuel composition of the present invention does not contain any fossil diesel. These preferred embodiments include the diesel fuels in which w(a)+w(b)+w(c)=100 weight-% as well as the diesel fuels in which w(a)+w(b)+w(c)<100 weight-%, e.g. w(a)+w(b)+w(c) being in the range of from 95 weight-% or more and less than 100 weight-%, more preferably 97 weight-% or more and less than 100 weight-% and even more preferably 98 weight-% or more and less than 100 weight-%. In these embodiments, the remainder is constituted of one or more additives, each of which preferably being selected from the additives described hereinbelow. Particularly preferred is the embodiment of w(a)+w(b)+w(c)=100 weight-%, i.e., the fuel compositions of the invention without any fossil fuel and without any additives.

Other preferred embodiments of the present invention fulfil one of the features specified hereinabove or below as being preferred. Of course, fuel compositions of the present invention, which fulfil two or more of the preferred features, are even more preferred.

### 5.2.7. Advantageous Effects and Uses

As noted above, the diesel fuel compositions of the present invention are characterized by a combination of highly advantageous performance characteristics including two or more of absence of demixing problems, high stability including high stability at low temperature, density being adjustable according to requirements, high cetane number, low soot formation, as well as a high calorific value and satisfactory energy content and range. This combination of beneficial properties makes the diesel fuel compositions of the present invention a highly attractive substitute for fossil diesel fuel, thus allowing to effectively increase the content of fuel components from renewable sources and reducing the content of fossil fuel components. Preferred embodiments are characterized by a particularly high degree of compliance with EN590 and especially a density in accordance with EN590, a high storage stability, as well as the absence of any de-mixing problems. Such preferred diesel fuel compositions of the present invention are well-suited as drop-in replacement for fossil diesel fuel, permitting a complete replacement of fossil diesel fuel without need for any adaptations in technology.

The high storage stability of the diesel fuel compositions of the present invention is expressed by the absence of any turbidity (transmission) or precipitations after storage for >12 months at 20° C. in a sealed container shielding the sample from influences of air, humidity and UV irradiation. Preferably, there is no turbidity or precipitation even after storage for 18 months or, more preferably even after storage for 24 months.

The absence of demixing problems is confirmed by subjecting the diesel fuel composition of the invention to the following test conditions: after some time, a sample is taken from a storage tank (stirred). Then the sample is transferred to a control tube. By using back light, a visible assessment is determined. The demix would be identified, if the solution is two-phased. An alternative pathway is an online-IR device. The diesel fuel compositions of the present invention show no sign of demixing even after prolonged standing at room temperature (20° C.) of the control tube for 1 week or more, preferably 1 month or more and more preferably 1 year or more. Preferred embodiments show the same absence of demixing even after prolonged standing at 0° C. of the control tube for 1 week or more, preferably 1 month or more and more preferably 1 year or more.

The diesel fuel compositions are furthermore characterized by a lower tendency towards demixing in case of elevated moisture content. Normally, according to EN 590, diesel compositions contain no more than 200 mg/kg water. Surprisingly, it has been found that the diesel fuel compositions of the present invention are stable against demixing even if they contain 650 mg/kg water or even more. Biodiesel-containing fuel compositions take up water from the surrounding atmosphere, especially when being stored in a humid environment (e.g., 70% RH or more, such as 80% RH or more and especially 90% RH or more; these relative humidities are particularly severe if they are encountered in combination with an average temperature of 20° C. or more, such as an average temperature in the range of from 25 to 30° C.). If conventional biodiesel fuel compositions are stored in a humid environment, they may take up so much water that eventually demixing occurs. The separated water may then cause corrosion and/or form an environment susceptible for the growth of molds or bacteria. Reducing the tendency of demixing therefore enhances the stability of the diesel fuel composition when being stored in a humid environment.

In preferred embodiments, the diesel fuel compositions of the present invention further exhibit one or more of the following additional beneficial effects: low tendency to generate soot; net-zero greenhouse gas emissions; higher cetane number; and/or significantly reduced sulphur content. Another benefit is the possibility of increasing the content of glycerin-derived component in the composition (via the solketal component). This is advantageous in view of circular economy considerations because glycerin and the fatty acids contained in biodiesel originate from the same raw material (fats and oils from renewable sources). Yet another benefit is the possibility of tolerating higher contents of monoglycerides as impurities in biodiesel.

Having regard to the above advantageous effects, the diesel fuel compositions of the present invention are suitable as a replacement of commercial diesel fuel in any of the fields of application in which diesel fuel is currently used, including especially cars, trucks, boats, aviation, machinery, electric power generators, as well as generators of heat e.g., for chemical processes.

### 5.2.8. Water as an Inevitable Impurity

In a further embodiment, the present invention provides the possibility of using raw materials containing water as an impurity in relative amounts that exceed the typical relative amount of water as an inevitable impurity. This applies especially to biodiesel, which is known to contain typically 100 to 300 mg/kg water, such as 200 to 300 mg/kg. According to this embodiment of the invention, it is possible to use starting materials, and especially biodiesel, for the manufacture of a diesel fuel composition of the present invention, which starting materials contain water as an impurity, in an amount greater than the typical amount. This is a realistic scenario in view of the fact that biodiesel is hygroscopic. Hence, when storing biodiesel for extended periods of time at relative humidities of 70% RH or more, such as 80% RH or more or even 90% RH or more, the content of water as an impurity will increase to values above the typical range of 100 to 300 mg/kg.

The diesel fuel composition of this embodiment may be any of the diesel fuel compositions described herein. For instance, biodiesel may be used as a raw material, which has a water content of 300 mg/kg to 4000 mg/kg and preferably 350 mg/kg to 3000 mg/kg. In another aspect, the water-content of the raw materials may be such that the resulting diesel fuel composition contains water as an impurity in an amount so that the water content is in the range of 50 mg/kg or more and 4000 mg/kg or less, preferably more than 100 mg/kg and less than 3000 mg/kg, even more preferably 200 mg/kg or more and 1000 mg/kg or less, such as 150 mg/kg or more and 900 mg/kg or less.

The preferred water content of the diesel fuel compositions of this embodiment depends on the content of biodiesel:
In diesel fuel compositions of the invention having 10 weight % biodiesel or less, preferred water contents are in the range of 100 mg/kg or more and 210 mg/kg or less.
If the biodiesel content is more than 10 weight % and less than 50 weight %, the preferred water contents are in the range of 150 mg/kg or more and 1000 mg/kg or less, more preferably 200 mg/kg or more and 900 mg/kg or less.
If the biodiesel content is in the range of from 50 weight % to 100 weight %, the preferred water contents are in the range of from 600 mg/kg or more to 4000 mg/kg or less, more preferably 750 mg/kg or more and 3500 mg/kg or less.

In one aspect of the instant embodiment, the present invention pertains to a diesel fuel composition as described hereinabove and below, which is characterized by a water content as specified above. This can be a diesel fuel composition manufactured using raw materials containing water as an impurity and/or a diesel fuel composition that has taken up water due to storage in a humid environment.

In yet another aspect of this embodiment, the diesel fuel composition contains water as an impurity in amounts as specified above. However, unlike the diesel fuels described herein for the other embodiments, the diesel fuel of this specific aspect is characterized by the possibility that renewable alkane may be absent. Hence, the diesel fuel composition of this aspect contains, in its broadest aspect:
(a) solketal;
(b) biodiesel;
(c) optionally renewable alkane;
(d) optionally fossil diesel; and
(e) optionally one or more further additives;
   wherein
      the relative amount of solketal, w(a), is 0.1 to 32 weight-%,
      the relative amount of biodiesel, w(b), is 2 to 85 weight-%,
      the relative amount of renewable alkane, w(c), is 0 to 97 weight-%,
      the relative amount of fossil fuel, w(d), is 0 to 50 weight-%, and
      the relative amount of total additives, w(e), is 0 to 10 weight-%, and
      the relative amount of water in the fuel composition is 100 mg/kg or more and 4000 mg/kg or less, preferably more than 180 mg/kg and less than 3000 mg/kg, even more preferably 200 mg/kg or more and 1000 mg/kg or less, such as 250 mg/kg or more and 900 mg/kg or less;
         all weight-% indications being based on the total weight of the composition. For instance, preferred fuel compositions according to this aspect contain 5 weight-% solketal, renewable alkane in an amount of from 0-5 weight-%, biodiesel in an amount of 40 weight-%, water in an amount as specified above, and the remainder being fossil fuel and optionally one or more additives. Further information described herein in connection with other embodiments may apply equally to this aspect as long as this does not give rise to any contradictions.

### 5.2.9. Diesel Composition for Marine Vessels

In one embodiment, the diesel fuel compositions of the present invention are adapted for use in larger marine vessels such as container vessels, oil tankers, barges, boats, ferries, and cruise ships.

The diesel fuel compositions for use in marine vessels according to the present invention preferably exhibit a high degree of compliance with ISO 8217 2017. The relative amounts of the individual components can be suitably adjusted within the limits of the present invention to increase said degree of compliance.

For this type of diesel fuel composition, stability and viscosity are important performance characteristics. The present invention provides such diesel fuel compositions, wherein stability is improved while viscosity can be suitably adjusted by appropriately selecting relative amounts of the components.

The above indications are generally valid and applicable also for this specific use except that the renewable alkane fuel component and/or the fossil fuel component, sometimes referred to as bunker fuel, may contain more longer chain hydrocarbon components, such that the boiling point of these components is from 180° C. to 400° C. or more. Moreover, the viscosity and density of the fuel composition may be higher.

According to a further embodiment of the invention, a diesel composition for marine vessels is provided, which contains the following essential components:
solketal
biodiesel;
renewable alkane; and
bunker fuel.

The above-mentioned bunker fuel may be any conventionally used bunker fuel, i.e., diesel-type fuel as it is used for marine vessels. This can be for instance rmg bunker fuel with the code 621-23-06419-015.

The fuel composition of this embodiment may be a diesel fuel composition in accordance with the invention as described herein, but wherein bunker fuel is used as the fossil diesel component. This fuel composition thus contains solketal, biodiesel, renewable alkane and bunker fuel as well as optional additives. The relative amounts of the components of the diesel composition of this embodiment are typically as follows:
solketal: 0.1 to 32 weight-%, preferably 1 to 10 weight-%,
biodiesel: 2 to 85 weight-%, preferably 4 to 75 weight-%,
renewable alkane: 0.1 to 97 weight-%, preferably 25 to 80 weight-%,
bunker fuel: 0.1 to 50 weight-%, preferably 1 to 45 weight-%,
additives: 0 to 10 weight-%, preferably 0.1 to 3 weight-%;
wherein all weight-% indications are based on the total weight of the fuel composition.

Further suitable fuel compositions of this aspect can be derived from the compositions characterized in the above Tables 1-59, but wherein bunker fuel is present instead of fossil diesel, and wherein the relative amount of bunker fuel is within a range as indicated for fossil diesel in the respective compositions.

In another aspect of this embodiment, the fuel composition may be a composition containing solketal, biodiesel and bunker fuel as well as optional additives, i.e., a diesel fuel composition as described herein, but wherein bunker fuel is used instead of the fossil diesel component and instead of the renewable alkane component. The relative amounts of the components of the diesel composition of this embodiment are typically as follows:
solketal: 0.1 to 32 weight-%, preferably 1 to 10 weight-%,
biodiesel: 2 to 85 weight-%, preferably 4 to 75 weight-%,
bunker fuel: 0.1 to 97.9 weight-%, preferably 1 to 45 weight-%,
additives: 0 to 10 weight-%, preferably 0.1 to 3 weight-%.

Further suitable fuel compositions of this aspect can be derived from the compositions characterized in the above Tables 1-59, but wherein bunker fuel is present instead of renewable alkane and fossil diesel, and wherein the relative amount of bunker fuel is within a range derived from a combination of the relative amounts specified for renewable alkane and fossil diesel.

Except for the deviating components, i.e., with bunker fuel and without fossil diesel and optionally without renewable alkane as specified above, information provided herein in connection with other embodiments may thus also be applied to this embodiment, as long as no contradiction is created by this.

### 5.2.10. Manufacture

The diesel fuel compositions of the present invention may be manufactured by
(1) providing the components and
(2) mixing them together.

There is no particular limitation regarding the relative order of mixing the individual components. In one preferred embodiment, the components are advantageously mixed following a specific order:
(i) mixing solketal and biodiesel;
(ii) mixing the mixture obtained in step (i) with fossil diesel (if present);
(iii) mixing the mixture obtained in step (ii) with renewable alkane fuel.

According to another embodiment, the relative order of mixing steps is reversed. That is, the procedure is carried out based on the following steps:
(i′) mixing fossil diesel (if present) with renewable alkane fuel;
(ii′) mixing the mixture obtained in step (i′) with biodiesel;
(iii′) mixing the mixture obtained in step (ii′) with solketal.

In the processes outlines above, additives may be admixed at any stage of the respective process, i.e. admixing to one or more components before, during or after the first mixing step. If a second mixing step is present, admixing of additives may take place before, during or after the second mixing step. Likewise, if a third mixing step is present, admixing of additives may take place before, during or after the third mixing step. If multiple additives are present, said additives may be admixed together or separately.

The type of mixing, mixing equipment and other details of the mixing process are not particularly restricted. It is even conceivable on that no active measures are taken for mixing, e.g., that a sufficient degree of mixing is accomplished by fluid movements that result from introducing the different components into the same container with a certain fluid velocity.

As far as the mixing equipment and process parameters are concerned, it is preferred to use a stainless steel container equipped with a mixing device. The container is advantageously insulated. Suitable mixing devices may include static mixers, turbines, impellers, helical ribbon or anchor mixers.

The process may be carried out at any temperature. It is preferred to carry out the process at a temperature of 10 to 30° C., preferably 18 to 25° C.

The process can be carried out in a continuous manner or as a batch process. Suitable batch sizes range from lab-scale to industrial scale, which means typically from 1 kg to 10 kg, 10 kg to 1 t and 1 t to 100 kt. Preferred batch sizes are from 10 kt to 50 kt and more preferably from 20 kt to 30 kt.

### 5.3. Petrol Fuels of the Invention

The petrol fuels of the present invention are derived from fossil petrol fuels, optionally containing other petrol fuel components such as bioethanol, wherein significant amounts of fossil petrol and/or other petrol fuel components such as bioethanol are replaced by solketal. In this connection, the expression “significant amounts” is used to indicate that the resulting fuel contains at least 6 weight-% or at least 7 weight-%, in particular at least 10 weight-%, preferably at least 11 weight-%, more preferably at least 12 weight-% and even more preferably 13 weight-% and most preferably at least 15 weight-% solketal, such as for instance 20 weight-% or more, 25 weight-% or more, or 30 weight-% or more, after the replacement, with all weight-% indications in this section being based on the total weight of the fuel composition being 100 weight-%. There is no upper limit for the amount of solketal that may be present. In other words, the present invention also provides fuels wherein all of the fossil petrol and all of the bioethanol is replaced by solketal, i.e. wherein the resulting fuel consists of solketal and optionally one or more petrol fuel additives.

The petrol fuels of the present invention may thus optionally contain one or more additives. For the fuels that do not contain any additives, the upper limit for the solketal content is 100 weight-%. For the fuels containing one or more additives, the upper limit of the solketal content is below 100 weight-% while the combined content of solketal and additives is 100 weight-%.

In the embodiments, wherein solketal is present together with fossil petrol fuel and/or bioethanol and/or additives, the solketal content is typically 99 weight-% or less, or 98 weight-% or less, or 97 weight-% or less, or 96 weight-% or less, or even 95 weight-% or less, wherein lower limits are as specified above.

The petrol fuels of the present invention may optionally contain one or more further petrol fuel components and preferably renewable petrol fuel components in addition to the components mentioned above. Other renewable petrol components can be methanol-to-gasoline (MTG) and bio-naphtha fractions. Another renewable fuel component of interest is the group of oxygen containing components and especially alcohols like methanol, propanol (and isomers) and butanol (and isomers).

The content of these further petrol fuel components and especially further renewable petrol fuel components is not particularly limited. In some embodiments, it is restricted to the international petrol standards e.g. EN 228, but disregarding restrictions in relation to oxygen content in EN 228. In even further embodiments, the content of these components is restricted to the international petrol standards e.g. EN 228 while respecting restrictions in relation to oxygen content in EN 228.

If other renewable petrol fuel components are present, they may be treated together with solketal as a substitute for part or all of the fossil fuel component. This means that the above-mentioned amount indications for solketal are equally valid for compositions of the invention, which contain renewable petrol components in addition to fossil fuel (or as a complete replacement of fossil fuel). Hence, as shown in the table below, renewable petrol components may be present in amounts of 0, 10, 20, 30, 40 or 50 weight-% or more and 10, 20, 30, 40, 50, 60, 65, 70, 75, 80 or 90 weight-% or less.

By consequence, the present invention relates to the following classes of petrol fuel compositions.

| | | | Renewable | |
|---|---|---|---|---|
| | Solketal | Fossil | petrol fuel | Petrol fuel |
| Specific | content | petrol | component | additives |
| embodiment | (wt. %) | (wt. %) | (wt. %) | (wt. %) |
| P1 | 10-100 | 0-90 | 0-90 | 0-10 |
| P2 | 20-100 | 0-80 | 0-80 | 0-10 |
| P3 | 25-100 | 0-75 | 0-75 | 0-10 |
| P4 | 30-100 | 0-70 | 0-70 | 0-10 |
| P5 | 35-100 | 0-65 | 0-65 | 0-10 |
| P6 | 40-100 | 0-60 | 0-60 | 0-10 |
| P7 | 50-100 | 0-50 | 0-50 | 0-10 |
| P8 | 60-100 | 0-40 | 0-40 | 0-10 |
| P9 | 70-100 | 0-30 | 0-30 | 0-10 |
| P10 | 80-100 | 0-20 | 0-20 | 0-10 |
| P11 | 90-100 | 0-10 | 0-10 | 0-10 |
| P12 | 100 | 0 | 0 | 0 |
| P13 | 95-100 | 0 | 0 | 0-5 |
| P14 | 96-100 | 0 | 0 | 0-4 |
| P15 | 97-100 | 0 | 0 | 0-3 |
| P16 | 98-100 | 0 | 0 | 0-2 |
| P17 | 99-100 | 0 | 0 | 0-1 |
| P18 | 10-90 | 0-70 | 10-90 | 0-10 |
| P19 | 10-80 | 0-80 | 20-90 | 0-10 |
| P20 | 10-70 | 0-75 | 30-90 | 0-10 |
| P21 | 10-60 | 0-70 | 40-90 | 0-10 |
| P22 | 10-50 | 0-65 | 50-90 | 0-10 |
| P23 | 40-80 | 0-10 | 20-60 | 0-10 |
| P24 | 50-90 | 0-10 | 10-50 | 0-10 |
| P25 | 6-10 | 0-70 | 0-10 | 0-10 |
| P26 | 6-10 | 0-80 | 0 | 0-10 |
| P27 | 6-10 | 0 | 0-80 | 0-10 |
| P28 | 6-10 | 0 | 0-90 | 0 |
| P29 | 6-10 | 0-90 | 0 | 0 |
| P30 | 7-10 | 0-70 | 0-10 | 0-10 |
| P31 | 7-10 | 0-80 | 0 | 0-10 |
| P32 | 7-10 | 0 | 0-80 | 0-10 |
| P33 | 7-10 | 0 | 0-90 | 0 |
| P34 | 7-10 | 0-90 | 0 | 0 |

### 5.3.1. Solketal

The solketal to be a used according to this embodiment of the invention is the same as specified above in relation to the diesel fuels of the invention.

### 5.3.2. Petrol Fuel Component and Especially Renewable Petrol Fuel Component

The petrol fuels of the invention may contain any fuel component that is suitable for use in petrol fuel, including especially those that can also be present in conventional petrol fuel.

The petrol fuels of the invention typically contain one or more renewable petrol fuel components (however, in one embodiment, pure solketal is used so that no renewable petrol fuel component needs to be added). This type of component includes any petrol fuel component that is produced from renewable materials and/or waste materials or by-products in the sense of a circular economy. Such renewable petrol fuels may include for instance one or more of petrol-type e-fuels as defined above, biogasoline, as well as e-gasoline. It also includes bioethanol or any other alcohol made from renewable raw material sources. Bioethanol is ethanol that is typically obtained by bacterial fermentation of biomass or organic waste, followed by purification and drying. Any bioethanol that is used in conventional petrol (e.g. in “E10” grade petrol in Germany) can be present in the petrol compositions of the present invention.

### 5.3.3. Fossil Fuel

While not being an essential component, the petrol fuel composition of the invention typically contains fossil fuel as a further component.

Any type of petrol fuel of fossil origin may be used with octane ratings typically ranging from 95 to 102, including especially regular (95), premium (97-98), super (99) and high-performance (>99) petrol.

### 5.3.4. Optional Additives

In addition to that, the petrol fuel composition of the invention may contain further optional components and in particular additives designed to ensure accomplishment of certain performance characteristics. The used additives according to this embodiment of the invention are the same as specified above in relation to the diesel fuels of the invention. These include in particular additives for improving low temperature stability, biocides, lubricity, antioxidants, corrosion inhibitor. In addition to the above-mentioned additives, very important petrol additives are antiknock agents such as methyl tertiary butyl ether or ethyl tertiary butyl ether, detergents such as alkylamines and alkyl phosphates. The relative amount of these optional additives is not particularly limited and depends on the effects to be accomplished. Typically, the additives are present in a relative amount of 100 to 5000 ppm preferably 200 to 500 ppm, wherein the specified ranges apply to the relative amount of each individual additive. These ppm indications are preferably on a w/w-basis, but could also be adjusted in the above ranges on v/v-basis, w/v-basis or v/w-basis.

A listing of suitable additives can be found under https://www3.epa.gov/otag/fuels1/ffars/web-gas.htm. Further information on suitable additives is found in the review article by A. M. Danilov cited above.

The total relative amount of all optional additives together is typically in the range of 0 to 10 weight-%, preferably 0.1 to 10 weight-% and more preferably 0.5 to 2 weight-%.

### 5.3.5. Preferred Embodiments

According to one preferred embodiment, the petrol fuel of the invention contains only two fuel components, namely solketal and one of fossil fuel and renewable petrol fuel. Additives, as described hereinabove, may optionally be present. In a particularly preferred embodiment, the petrol fuel does not contain any additives. That is, the particularly preferred petrol fuel of the invention consists of solketal, and one further component selected from fossil fuel and renewable petrol fuels.

### 5.3.6. Advantageous Effects and Uses

The petrol fuel of the present invention is characterized by a high or even very high relative amount of components originating from renewable sources. Hence, use of the petrol fuel of the present invention permits to reduce the carbon dioxide footprint of a motor engine. In addition, the petrol fuel of the present invention is characterized by an advantageously low degree of soot formation. It is further characterized by a high stability. This includes a low rate of formation of precipitates and/or turbidity. It also includes the absence of any degradation of components into soluble or insoluble degradation products. There is, for instance, no significant degradation of solketal into its components glycerin and acetone in fuel applications. There is also no harmful impact on the range of a car using the petrol fuel of the present invention: compared to fossil petrol fuel having an ethanol component, petrol fuel of the present invention, wherein said ethanol is replaced by a corresponding amount of solketal, permits to accomplish approximately the same range. The petrol fuel of the present invention is further characterized by a low degree of toxicity, which facilitates handling, transport and storage. Another benefit is a relatively high flash point of the petrol fuel of the present invention, which also facilitates handling, transport and storage.

### 5.3.7. Manufacture

The petrol fuel compositions of the present invention may be manufactured by
(1) providing the components and
(2) mixing them together.

There is no particular limitation regarding the relative order of mixing the individual components. In one embodiment, the components are advantageously mixed following a specific order:
(i) mixing solketal and fossil petrol
(ii) mixing the mixture obtained in step (i) with other renewable components (if present);

According to another embodiment, the relative order of mixing steps is reversed. That is, the procedure is carried out based on the following steps:
(i′) mixing other renewable components (if present) with fossil petrol;
(ii′) mixing the mixture obtained with solketal

In the processes outlined above, additives may be admixed at any stage of the respective process, i.e. admixing to one or more components before, during or after the first mixing step. If a second mixing step is present, admixing of additives may take place before, during or after the second mixing step. If multiple additives are present, said additives may be admixed together or separately.

The type of mixing, mixing equipment and other details of the mixing process are not particularly restricted. It is even conceivable on that no active measures are taken for mixing, e.g., that a sufficient degree of mixing is accomplished by fluid movements that result from introducing the different components into the same container with a certain fluid velocity.

As far as the mixing equipment and process parameters are concerned, it is preferred to use a stainless steel container equipped with a mixing device. The container is advantageously electrically insulated. Suitable mixing devices may include static mixers, turbines, impellers, helical ribbon or anchor mixers.

The process may be carried out at any temperature. It is preferred to carry out the process at a temperature of 10 to 30° C., preferably 18 to 25° C.

The process can be carried out in a continuous manner or as a batch process. Suitable batch sizes range from lab-scale to industrial scale, which means typically from 1 kg to 10 kg, 10 kg to 1 t and 1 t to 100 kt. Preferred batch sizes are from 10 kt to 50 kt and more preferably from 20 kt to 30 kt.

### 6. FURTHER USES OF THE INVENTION

As already mentioned above, solketal is a material obtainable at least partly from renewable sources. Moreover, the presence of solketal permits to increase the content of other renewable fuel components such as biodiesel or renewable alkane fuel. Hence, according to one embodiment of the invention, solketal is used as a means for increasing the content of renewable components in fuel. This use is feasible for diesel fuel and for petrol fuel.

In an extreme form of this aspect, solketal may be used as a drop-in (i.e. complete substitution e.g., for petrol fuels). In view of the rather low cetane number of solketal, it is advantageous to supplement solketal with one or more diesel fuel additives and especially one or more additives that can increase the cetane number. Alternatively, it may be possible to employ solketal in special diesel engines having low requirements regarding the cetane number.

As far as the use of solketal as a drop-in for petrol fuel is concerned, there is no particular need for supplementing solketal with one or more additives, even though such supplementation might nevertheless be beneficial for further improving performance characteristics. However, it is one specific aspect of the present invention to use pure solketal (without additives) as a drop-in for petrol fuel.

Aged diesel fuel as well as aged petrol fuel frequently contain insoluble particles giving rise to turbidity. According to another embodiment of the present invention, solketal is used to reduce turbidity in aged fuels by dissolving the above-mentioned particles and thus reversing formation of turbidity.

According to this embodiment of the invention, solketal is used for removing or reducing turbidity in fuels by addition of the same to the fuel and in particular to aged fuel. In case of diesel fuels, solketal is preferably added in relative amounts of 0.1 to 6 parts by weight, preferably of 1 to 5 parts by weight and more preferably of 1.5 to 3 parts by weight, relative to 100 parts by weight of the aged fuel. In case of petrol fuel, solketal is preferably added in relative amounts of 0.1 to 20 parts by weight, preferably of 1 to 10 parts by weight and more preferably of 2 to 8 parts by weight, relative to 100 parts by weight of the aged fuel.

Said fuel and in particular aged fuel may be any kind of fuel including fossil diesel fuel, fossil petrol fuel as well as any fuels containing renewable components such as B7 diesel fuel, B20 diesel fuel, B30 diesel fuel, B40 diesel fuel or E10 petrol fuel.

### 7. FURTHER NUMBERED EMBODIMENTS OF THE INVENTION

The present invention also relates to the following numbered embodiments:
1. Diesel fuel comprising:
   (a) solketal;
   (b) biodiesel;
   (c) renewable alkane;
   (d) optionally fossil diesel; and
   (e) optionally one or more further additives;
      wherein
         the relative amount of solketal, w(a), is 0.1 to 32 weight-%,
         the relative amount of biodiesel, w(b), is 2 to 85 weight-%,
         the relative amount of renewable alkane, w(c), is 0.1 to 97 weight-%,
         the relative amount of fossil fuel, w(d), is 0 to 50 weight-%, and
         the relative amount of total additives, w(e), is 0 to 10 weight-%,
      all weight-% indications being based on the total weight of the composition.
1a. The diesel fuel of item 1, wherein the solketal content (w(a)) is from 0.1 weight-% to 32 weight-% such as anyone of the following ranges: 0.2 weight-% to 28 weight-%, 0.3 weight-% to 24 weight-%, 0.5 weight-% to 20 weight-%, or 0.7 weight-% to 15 weight-%; more preferably from 1 to 10 weight-% or 3 to 8 weight-%, even more preferably 4 to 7 weight-% and especially 4 to 6 weight-%.
1b. The diesel fuel of item 1 or 1a, wherein the biodiesel content (w(b)) is from 2 weight-% to 85 weight-% such as 3 weight-% to 80 weight-%; preferably from 5 to 70 weight-%, more preferably 6 to 50 weight-%, even more preferably 7 to 45 weight-% and especially 10 to 40 weight-%.
1c. The diesel fuel of item 1, 1a or 1b, wherein the renewable alkane content (w(c)) is from 0.1 weight-% to 97 weight-%, such as 10 weight-% to 90 weight-%; preferably from 25 to 80 weight-%, more preferably 26 to 70 weight-%, even more preferably 27 to 68 weight-% and especially 30 to 65 weight-%.
1d. The diesel fuel of item 1 or anyone of items 1a to 1c, wherein the remainder, if w(a)+w(b)+w(c)<100 weight-%, being fossil diesel fuel and/or one or more additives with the provision that the content of fossil diesel fuel is no more than 50 weight-% and preferably less than 50 weight-%, more preferably 40 weight-% or less, even more preferably 30 weight-% or less, particularly preferably 20 weight-% or less, especially preferably 10 weight-% or less, or even 5 weight-% or less and most preferably 0 weight-%, i.e. fossil diesel fuel being completely absent.
2. The diesel composition according to item 1 or anyone of items 1a to 1d, wherein the composition is selected from the compositions having the relative amounts as characterized in the following tables, wherein each row in any of the tables characterizes a composition:

| Solketal, | Biodiesel, | Renewable | Fossil diesel, | Total Additives, |
|---|---|---|---|---|
| w(a) | w(b) | alkane, w(c) | w(d) | w(e) |
| (wt. %) | (wt. %) | (wt. %) | (wt. %) | (wt. %) |
| 0.1-20.0 | 2.0-85.0 | 0.1-97.0 | 0.0-50.0 | 0.0-10.0 |
| 0.5-15.0 | 3.0-80.0 | 10.0-90.0 | 0.0-50.0 | 0.0-10.0 |
| 1.0-10.0 | 5.0-70.0 | 25.0-80.0 | 0.0-50.0 | 0.0-10.0 |
| 3.0-8.0 | 6.0-50.0 | 26.0-70.0 | 0.0-50.0 | 0.0-10.0 |
| 4.0-7.0 | 7.0-45.0 | 27.0-68.0 | 0.0-50.0 | 0.0-10.0 |
| 4.0-6.0 | 10.0-40.0 | 30.0-65.0 | 0.0-50.0 | 0.0-10.0 |

wherein, further compositions of the present embodiment are characterized by the relative amounts specified for the other components the above compositions, but contain only smaller amounts of fossil diesel, such as 40 weight-% or less, 30 weight-% or less, 20 weight-% or less, 10 weight-% or less, 10 weight-% or less, or even 5 weight-%, and most preferably 0 weight-%; or

| Solketal, | Biodiesel, | Renewable | Fossil diesel, | Total Additives, |
|---|---|---|---|---|
| w(a) | w(b) | alkane, w(c) | w(d) | w(e) |
| (wt. %) | (wt. %) | (wt. %) | (wt. %) | (wt. %) |
| 0.1-20.0 | 2.0-85.0 | 0.1-97.0 | 0.0-5.0 | 0.0-10.0 |
| 0.5-15.0 | 3.0-80.0 | 10.0-90.0 | 0.0-5.0 | 0.0-10.0 |
| 1.0-10.0 | 5.0-70.0 | 25.0-80.0 | 0.0-5.0 | 0.0-10.0 |
| 3.0-8.0 | 6.0-50.0 | 26.0-70.0 | 0.0-5.0 | 0.0-10.0 |
| 4.0-7.0 | 7.0-45.0 | 27.0-68.0 | 0.0-5.0 | 0.0-10.0 |
| 4.0-6.0 | 10.0-40.0 | 30.0-65.0 | 0.0-5.0 | 0.0-10.0 |

| Solketal, | Biodiesel, | Renewable | Fossil diesel | Total Additives, |
|---|---|---|---|---|
| w(a) | w(b) | alkane, w(c) | w(d) | w(e) |
| (wt. %) | (wt. %) | (wt. %) | (wt. %) | (wt. %) |
| 2.5-10.0 | 20.0-45.0 | 45.0-75.0 | 0-40.0 | 0-10.0 |
| 3.0-8.0 | 25.0-45.0 | 45.0-70.0 | 0-40.0 | 0-10.0 |
| 3.5-7.0 | 25.0-40.0 | 50.0-70.0 | 0-20.0 | 0-10.0 |
| 4.0-6.0 | 30.0-40.0 | 55.0-65.0 | 0-5.0 | 0-10.0 |
| 4.0-6.0 | 32.5-37.5 | 57.5-62.5 | 0-1.0 | 0-10.0 |
| 5 | 35 | 60 | 0 | 0 |

| Solketal, | Biodiesel, | Renewable | Fossil diesel, | Total Additives, |
|---|---|---|---|---|
| w(a) | w(b) | alkane, w(c) | w(d) | w(e) |
| (wt. %) | (wt. %) | (wt. %) | (wt. %) | (wt. %) |
| 2.5-10.0 | 10.0-35.0 | 55.0-85.0 | 0-40.0 | 0-10.0 |
| 3.0-8.0 | 15.0-35.0 | 55.0-80.0 | 0-40.0 | 0-10.0 |
| 3.5-7.0 | 15.0-30.0 | 60.0-80.0 | 0-20.0 | 0-10.0 |
| 4.0-6.0 | 20.0-30.0 | 65.0-75.0 | 0-5.0 | 0-10.0 |
| 4.0-6.0 | 22.5-27.5 | 67.5-72.5 | 0-1.0 | 0-10.0 |
| 5 | 25 | 70 | 0 | 0 |

with all weight-% indications being based on the total weight of the composition.
3. The diesel composition according to item 1 or anyone of items 1a to 1d, wherein the composition is selected from the compositions having the relative amounts as characterized in the following tables, wherein each row in any of the tables characterizes a composition:

| Solketal, | Biodiesel, | Renewable | Fossil diesel, | Total Additives, |
|---|---|---|---|---|
| w(a) | w(b) | alkane, w(c) | w(d) | w(e) |
| (wt. %) | (wt. %) | (wt. %) | (wt. %) | (wt. %) |
| 4.5-20.0 | 15.0-45.0 | 25.0-65.0 | 0-40.0 | 0-10.0 |
| 5.0-15.0 | 20.0-40.0 | 30.0-60.0 | 0-40.0 | 0-10.0 |
| 7.0-13.0 | 22.0-37.0 | 40.0-60.0 | 0-20.0 | 0-10.0 |
| 8.0-12.0 | 25.0-35.0 | 45.0-55.0 | 0-20.0 | 0-10.0 |
| 9.0-11.0 | 27.5-32.5 | 47.5-52.5 | 0-20.0 | 0-10.0 |
| 10 | 30 | 50 | 10 | 0 |

| Solketal, | Biodiesel, | Renewable | Fossil diesel, | Total Additives, |
|---|---|---|---|---|
| w(a) | w(b) | alkane, w(c) | w(d) | w(e) |
| (wt. %) | (wt. %) | (wt. %) | (wt. %) | (wt. %) |
| 4.5-20.0 | 25.0-55.0 | 25.0-65.0 | 0-40.0 | 0-10.0 |
| 5.0-15.0 | 30.0-50.0 | 30.0-60.0 | 0-40.0 | 0-10.0 |
| 7.0-13.0 | 32.0-47.0 | 40.0-60.0 | 0-20.0 | 0-10.0 |
| 8.0-12.0 | 35.0-45.0 | 45.0-55.0 | 0-10.0 | 0-10.0 |
| 9.0-11.0 | 37.5-42.5 | 47.5-52.5 | 0-10.0 | 0-10.0 |
| 10 | 40 | 50 | 0 | 0 |

| Solketal, | Biodiesel, | Renewable | Fossil diese, | Total Additives, |
|---|---|---|---|---|
| w(a) | w(b) | alkane, w(c) | w(d) | w(e) |
| (wt. %) | (wt. %) | (wt. %) | (wt. %) | (wt. %) |
| 4.5-20.0 | 25.0-55.0 | 25.0-65.0 | 0-40.0 | 0-10.0 |
| 5.0-15.0 | 30.0-50.0 | 30.0-60.0 | 0-40.0 | 0-10.0 |
| 7.0-13.0 | 32.0-47.0 | 40.0-60.0 | 0-20.0 | 0-10.0 |
| 8.0-12.0 | 35.0-45.0 | 45.0-55.0 | 0-10.0 | 0-10.0 |
| 9.0-11.0 | 37.5-42.5 | 47.5-52.5 | 0-10.0 | 0-10.0 |
| 20 | 40 | 40 | 0 | 0 |

with all weight-% indications being based on the total weight of the composition.
4. The diesel composition according to item 1, 2 or 3 or anyone of items 1a to 1d, wherein the ratio of renewable alkane content to biodiesel content, w(c)/w(b), is greater than 1.0, preferably 1.2 to 4.0, more preferably 1.5 to 3.5.
5. The diesel composition according to any one of items 1 to 4 or anyone of items 1a to 1d, wherein the ratio of biodiesel content to solketal content, w(b)/w(a), is in the range of 1.5 to 10.0, preferably in the range of 2.0 to 8.0, more preferably 2.5 to 7.5, such as 2.5 to 5.0 or 3.0 to 7.0 or 4.0 to 8.0.
6. The diesel composition according to any one of items 1 to 5 or anyone of items 1a to 1d, wherein the fossil diesel content is 0 weight-%.
7. Use of the diesel composition according to any one of items 1 to 6 or anyone of items 1a to 1d for replacing fossil diesel fuel in diesel engine cars, trucks, boats, marine, aviation, machinery, electric power generators, and/or generators of heat or for use as bunker fuel.
8. Use according to item 7, wherein 50-100 weight-% of fossil diesel fuel is replaced by the diesel composition according to any one of claims 1 to 6.
9. Method for manufacturing the diesel composition according to any one of items 1 to 6 or anyone of items 1a to 1d, comprising one or more steps of simultaneously or sequentially mixing the components solketal, biodiesel, renewable alkane, optionally fossil diesel and optionally one or more additives in relative amounts as specified in any one of claims 1 to 6.
10. The method according to item 9, wherein the method comprises the following mixing steps in the specified order:
   (i) mixing solketal and biodiesel;
   (ii) optionally mixing the mixture obtained in step (i) with fossil diesel;
   (iii) mixing the mixture obtained in step (i) if no fossil diesel is added, or the mixture obtained in step (ii) if fossil diesel is added, with renewable alkane fuel.
11. The method of anyone of items 9 and 10, wherein solketal is prepared by converting acetone with glycerin originating from transesterification of triglycerides from renewable sources.
12. Petrol fuel composition comprising
   (i) solketal
   (ii) optionally one or more petrol fuel components such as renewable petrol fuel components
   (iii) optionally fossil petrol
   (iv) optionally petrol additives
      wherein the relative amount of solketal, expressed in weight-%, is 10 to 100 weight-%, preferably 20 to 99 weight-%, more preferably 25 to 98 weight-% and even more preferably 30 to 97 weight-% and most preferably 35 to 96 weight-% of the petrol fuel composition, any remainder being one or more selected from renewable petrol fuel components, fossil petrol, and/or petrol additives,
      or
      wherein the relative amount of solketal, expressed in weight-%, is 90 to 99.9 weight-%, preferably 92 to 99.8 weight-%, more preferably 95 to 99.7 weight-% and even more preferably 96 to 99.5 weight-% and most preferably 97 to 99.4 weight-% of the petrol fuel composition, the remainder being any one or more petrol additives,
      with all weight-% indications being based on the total weight of the composition.
13. Method of making the petrol fuel of item 12, wherein said petrol fuel comprises solketal and at least one of renewable petrol and/or fossil petrol, the method comprising the steps of
   (a) providing solketal as well as renewable petrol and/or fossil petrol; and
   (b) mixing solketal with renewable petrol and/or fossil petrol.
14. Use of solketal for increasing the content of renewable components in diesel or petrol fuel.
15. Use of solketal for reducing degradation such as turbidity or precipitation in diesel or petrol fuel.
16. Use of pure solketal, optionally further comprising one or more additives, as drop-in fuel substitute for diesel fuel or petrol fuel.

The above numbered embodiments may be read and understood in connection with the information provided in this section below and optionally also the definitions and/or further disclosures in other sections of the present disclosure.

In connection with the numbered embodiments of this section, biodiesel comprises one or more fatty acid methyl, ethyl or propyl esters as a main component. In connection with the above numbered embodiments, the following additives may preferably be used:
additives for improving low temperature stability including especially e.g. vinyl acetates
additives for improving oxidation stability e.g. tert-butylhydroquinone, butylated hydroxytoluene. A list of suitable commercial products can be found in the document “Oxidationsstabilisatoren für FAME als Blendkomponente in Dieselkraftstoff”, version of Jun. 16, 2022, which has been published under the url: https://www.agqm-biodiesel.de/application/files/1916/5720/0940/No-Harm-Liste_Oxi_deu_07_2022.pdf. A preferred commercial antioxidant is Lanxess Baynox Ultra.
Additives for lubricity e.g tall oil methyl esters (TOFA)
additives for improving cetane number e.g. 2-ethylhexyl nitrate
additives for reducing generation of soot particles including especially e.g. ammonia
colorants such as sudan dyes such as solvent yellow 14, solvent red 23, solvent blue 35.

The relative amount of the optional additives is not particularly limited and depends on the effects to be accomplished. Typically, the additives are each present in a relative amount of 100 to 5000 ppm, preferably 200 to 500 ppm, wherein the specified ranges apply to the relative amount of each individual additive. Of course, the relative amount of each individual additive is to be chosen depending on the type of additive and the functionality to be accomplished, such that the additive amount is at least as high as required for achieving the desired functionality to the desired extent, but not so high that there is a negative impact on any other relevant property of the fuel composition. For economic reasons, the amount of additive employed is typically at or near the lower end of this range. The total amount of optional additives is not particularly limited. It is in the range of 0 to 10 weight-% and typically in the range of 0.5 to 2 weight-%.

The above numbered embodiments of this section further characterize diesel fuel compositions that are adapted for use in larger marine vessels such as container vessels, oil tankers, barges, boats, ferries, and cruise ships, wherein the indications in the present section are generally valid and applicable also for this specific use except that the renewable alkane fuel component and/or the fossil fuel component may contain more longer chain hydrocarbon components, such that the boiling point of these components is from 180° C. to >400° C. Moreover, the viscosity of the fuel composition may be higher.

The present section of numbered embodiments also relates to petrol fuels as specified in the above numbered item 12. The petrol fuels of numbered item 12 are derived from fossil petrol fuels, optionally containing other petrol fuel components such as bioethanol, wherein significant amounts of fossil petrol and/or other petrol fuel components such as bioethanol are replaced by solketal. In this connection, the expression “significant amounts” is used to indicate that the resulting fuel contains at least 6 weight-% or at least 7 weight-%, in particular at least 10 weight-%, preferably at least 20 weight-%, more preferably at least 25 weight-% and even more preferably 30 weight-% and most preferably at least 35 weight-% solketal after the replacement, with all weight-% indications in this section being based on the total weight of the fuel composition being 100 weight-%. There is no upper limit for the amount of solketal that may be present. In other words, the present embodiment also provides fuels wherein all of the fossil petrol and all of the bioethanol is replaced by solketal, i.e. wherein the resulting fuel consists of solketal and optionally one or more petrol fuel additives.

The petrol fuels of the above numbered embodiment may thus optionally contain one or more additives. For the fuels that do not contain any additives, the upper limit for the solketal content is 100 weight-%. For the fuels containing one or more additives, the upper limit of the solketal content is below 100 weight-% while the combined content of solketal and additives is 100 weight-%.

In the above numbered embodiments, wherein solketal is present together with fossil petrol fuel and/or bioethanol and/or additives, the solketal content is typically 99 weight-% or less, or 98 weight-% or less, or 97 weight-% or less, or 96 weight-% or less, or even 95 weight-% or less, wherein lower limits are as specified above.

The petrol fuels of the above numbered embodiments may optionally contain one or more further petrol fuel components and preferably renewable petrol fuel components in addition to the components mentioned above. Other renewable petrol components can be methanol-to-gasoline (MTG) and bio-naphtha fractions. Another renewable fuel component of interest is the group of oxygen containing components and especially alcohols like methanol, propanol (and isomers) and butanol (and isomers).

In connection with the above numbered embodiments, the content of these further petrol fuel components and especially further renewable petrol fuel components is not particularly limited. In some embodiments, it is restricted to the international petrol standards e.g. EN 228, but disregarding restrictions in relation to oxygen content in EN 228. In even further embodiments, the content of these components is restricted to the international petrol standards e.g. EN 228 while respecting restrictions in relation to oxygen content in EN 228.

If other renewable petrol fuel components are present, they may be treated together with solketal as a substitute for part or all of the fossil fuel component. This means that the above-mentioned amount indications for solketal are equally valid for compositions of the present embodiment, which contain renewable petrol components in addition to fossil fuel (or as a complete replacement of fossil fuel).

The above numbered embodiments of the present section may be interpreted and/or implemented based on further information provided in other sections of this disclosure as long as there is no contradiction with the specific information of the present section. For example, the petrol compositions of the present embodiment may be further implemented on the basis of the petrol composition information provided in the above table under items P1 to P34.

### 8. EXAMPLES

### Example 1: Diesel Fuel Compositions

The following raw materials were used:

### Solketal:

Solketal (purity >98%) purchased from Merck KGaAA, Germany
Biodiesel: As RME purchased from ASG Analytik-Service AG, Germany
Renewable alkane: As HVO purchased from ASG Analytik-Service AG, Germany

A diesel fuel composition according to the invention is prepared by mixing 50 kg solketal with 350 kg biodiesel in a 1.5 t reactor under stirring. Subsequently, 600 kg of renewable alkane are added under mixing to yield a diesel fuel composition of the invention.

### Comparative Example 1: Diesel Fuel Composition According to Alptekin

A diesel fuel composition according to Alptekin (Energy 119, 2017, 44-52, http://dx.doi.org/10.1016/j.energy.2016.12.069) is prepared by mixing 150 kg solketal with 850 kg biodiesel in a 1.5 t reactor under stirring.

The obtained fuel compositions of Example 1 and Comparative Example 1 were examined for their performance characteristics. The following results were obtained:

| | | | Comparative |
|---|---|---|---|
| Tested Parameter | Method of determination | Example 1 | Example 1 |
| Cetane Number | DIN EN 17155: 2018 | 70.2 | 27.4 |
| Density [kg/m3] | DIN EN ISO 12185: 1997 | 824.9 | 905.8 |
| Flash point [° C.] | DIN EN ISO 2719: 2021 | 79.5 | 98.0 |
| Carbon residue [wt. %] | DIN EN ISO 10370: 2015 | <0.10 | 0.27 |
| Ash content [mg/kg] | DIN EN ISO 6245: 2003 | <0.001 | <0.001 |
| Sulfur content | DIN EN ISO 20884: 2022 | 1.2 | 1.5 |
| [mg/kg] | | | |
| Polycyclic aromatic | DIN EN 12916: 2019 Method A | <0.1 | <0.1 |
| hydrocarbons [wt. %] | | | |
| Manganese content | DIN EN 16576: 2015 | <0.5 | <0.5 |
| [mg/l] | | | |
| CFPP [° C.] | DIN EN 116: 2018 | −27 | −16 |
| Gross calorific value | DIN 51900-1: 2000 mod. | 42949 | 37512 |
| [J/g] | | | |
| Net calorific value | DIN 51900-2: 2003 mod. | 40089 | 35140 |
| [J/g] | | | |

A comparison of the experimental results summarized in the table above reveals that the diesel fuel composition of the invention exhibits superior properties at least with respect to cetane number, carbon residue, sulfur content and calorific value.

### Example 2: Turbidity Experiment with Diesel Fuel

10 g of an aged turbid diesel fuel consisting of 67 wt. % fossil diesel fuel, 26 wt. % hydrotreated vegetable oil and 7 wt. % biodiesel was provided. Turbidity was determined to be 10.6 NTU.

Solketal was added in small steps until turbidity disappeared. At that time, 360 μL solketal had been added. Turbidity was determined to be 1.12 NTU.

### Comparative Example 2: Further Turbidity Experiments

10 g of the same aged turbid diesel fuel consisting of 67 wt. % fossil diesel fuel, 26 wt. % hydrotreated vegetable oil and 7 wt. % biodiesel as in Example 2 was provided. Turbidity was 10.6 NTU.

Ethylene glycol was added in small steps but turbidity did not disappear. Turbidity increased to a value of 17.3 NTU.

The same experiment was repeated with propane-1,2-diol. The turbidity did not disappear and turbidity increased up to 13.4 NTU.

The same experiment was also repeated with butanol. The turbidity disappeared after addition of 430 μL. Turbidity was determined to be 2.14 NTU.

Comparison of the results reported above for Example 2 and Comparative Example 2 reveals that solketal exhibits superior effects in reversing aging-related turbidity.

### Example 3: Turbidity Experiment with Petrol Fuel

10 g of an aged turbid petrol fuel was provided. Turbidity was determined to be 12.2 NTU.

Solketal was added in small steps until turbidity disappeared. At that time, ca. 600-610 μL solketal had been added. Turbidity was determined to be ca. 0.73 NTU.

### Example 4: Water Content Measurements

Diesel fuel compositions were prepared with varying amounts of biodiesel (rape methyl ester, RME), solketal and renewable alkane (HVO). Relative amounts of these components are specified in the tables below, the remainder being fossil diesel. The compositions were saturated with water and equilibrated for 3 min under stirring at 3000 rpm. Then, water content was determined using a KF-coulometer. Water content indications are provided relative to the water content at 0% solketal.

a) Samples without Renewable Alkane

| | 7 vol. % | 10 vol. % | 20 vol. % | 40 vol. % | 100 vol. % |
|---|---|---|---|---|---|
| Solketal | RME | RME | RME | RME | RME |
| 0 vol. % | 0% | 0% | 0% | 0% | 0% |
| 2 vol. % | 37% | 7% | 5% | 4% | 190% |
| 4 vol. % | 15% | 19% | 12% | 8% | 240% |
| 6 vol. % | 24% | 33% | 29% | 32% | 294% |
| 8 vol. % | 58% | 26% | 33% | 36% | 349% |
| 10 vol. % | 48% | 29% | 54% | 51% | 406% |

b) Comparison Samples with and without Renewable Alkane

| | 40 vol. % RME | 40 vol. % RME |
|---|---|---|
| Solketal | 5 vol % HVO | 0 vol % HVO |
| 0 vol. % | 0% | 0% |
| 2 vol. % | 9% | 4% |
| 4 vol. % | 12% | 8% |
| 6 vol. % | 26% | 32% |
| 8 vol. % | 34% | 36% |
| 10 vol. % | 37% | 51% |

1. A diesel fuel composition comprising:
(a) solketal;
(b) biodiesel;
(c) optionally renewable alkane;
(d) optionally fossil diesel; and
(e) optionally one or more further additives;
wherein
the relative amount of solketal, w(a), is 0.1 to 32 weight-%,
the relative amount of biodiesel, w(b), is 2 to 95 weight %, such as 2 to 85 weight-%,
the relative amount of renewable alkane, w(c), is 0 to 97 weight-%, such as 0.1 to 97 weight-%,
the relative amount of fossil fuel, w(d), is 0 to 50 weight-%, and
the relative amount of total additives, w(e), is 0 to 10 weight-%,
all weight-% indications being based on the total weight of the composition, wherein the relative amount of solketal, biodiesel, renewable alkane and the relative amount of fossil fuel are optionally selected such that at least one of following equations is fulfilled:
$$800 \leq [ ( w ( a ) \times 1063 ) + ( w ( b ) \times 885 ) + ( w ( c ) \times 780 ) + ( w ( d ) \times 825 ) ] / ( 100 - w ( e ) ) \leq 845 ,$$
$$LDL \leq [ ( w ( a ) \times 1063 ) + ( w ( b ) \times 885 ) + ( w ( c ) \times 780 ) + ( w ( d ) \times 825 ) ] / ( 100 - w ( e ) ) \leq UDL ,$$
$$LDL \leq [ ( w ( a ) \times d ( a ) ) + ( w ( b ) \times d ( b ) ) + ( w ( c ) \times d ( c ) ) + ( w ( d ) \times d ( d ) ) ] / ( 100 - w ( e ) ) \leq UDL ,$$
wherein
d(a) represents the density of solketal,
d(b) represents the density of biodiesel,
d(c) represents the density of renewable alkane,
d(d) represents the density of fossil diesel,
d(e) represents the average density of the additives, and
LDL represents the lower density limit and is preferably selected from 800, 810, 815 and 820 kg/m³, and UDL represents the upper density limit and is preferably selected from 845 and 880 kg/m³.

2. The diesel fuel composition according to claim 1, comprising:
(a) solketal;
(b) biodiesel;
(c) optionally renewable alkane;
(d) optionally fossil diesel; and
(e) optionally one or more further additives;
water as an impurity
wherein
the relative amount of solketal, w(a), is 0.1 to 32 weight-%,
the relative amount of biodiesel, w(b), is 2 to 85 weight-%,
the relative amount of renewable alkane, w(c), is 0 to 97 weight-%,
the relative amount of fossil fuel, w(d), is 0 to 50 weight-%, and
the relative amount of total additives, w(e), is 0 to 10 weight-%,
the relative amount of water is 100 mg/kg or more and 4000 mg/kg or less, or more than 180 mg/kg and less than 3000 mg/kg, or 200 mg/kg or more and 1000 mg/kg or less, such asor 250 mg/kg or more and 900 mg/kg or less;
all weight-% indications being based on the total weight of the composition.

3. The diesel fuel composition according to claim 1, wherein the composition is selected from the compositions as specified in Tables 1 to 59 of the description
with all weight-% indications being based on the total weight of the composition.

4. The diesel fuel composition according to claim 1 wherein the ratio of renewable alkane content to biodiesel content, w(c)/w(b), is greater than 1.0, or 1.2 to 4.0, or 1.5 to 3.5.

5. The diesel fuel composition according to claim 1, wherein the ratio of biodiesel content to solketal content, w(b)/w(a), is in the range of 1.5 to 10.0, or in the range of 2.0 to 8.0, or in the range of 2.5 to 7.5, or in the range of 2.5 to 5.0 or 3.0 to 7.0 or 4.0 to 8.0.

6. The diesel fuel composition according to claim 1, wherein the fossil diesel content is 0 weight-%, 0.1-45 weight-%, 1-40 weight-%, 2-30 weight % or 3-20 weight % or 4-10 weight %.

7. The diesel fuel composition according to claim 1, wherein the diesel composition contains water as an impurity in the range of 200 mg/kg or more and 850 mg/kg or less, or more than 200 mg/kg and less than 800 mg/kg, or 250 mg/kg or more and 750 mg/kg or less, or 280 mg/kg or more and 700 mg/kg or less.

8. The diesel fuel composition according to claim 1, wherein the diesel composition contains bunker fuel as the fossil diesel component.

9. The diesel fuel composition of claim 8, wherein the renewable alkane component is replaced by bunker fuel.

10. A method for replacing fossil diesel fuel or bunker fuel in diesel engine cars, trucks, boats, marine, aviation, machinery, electric power generators, and/or generators of heat, comprising replacing the fossil fuel or bunker fuel with the diesel fuel composition of claim 1.

11. The method according to claim 10, wherein 50-100 weight-% of fossil diesel fuel is replaced by the diesel fuel composition.

12. A method for manufacturing the diesel fuel composition according to claim 1, comprising one or more steps of simultaneously or sequentially mixing the solketal, biodiesel, renewable alkane, optionally fossil diesel and optionally one or more additives in the relative amounts.

13. The method according to claim 12, wherein the method comprises the following mixing steps in the specified order:
(i) mixing solketal and biodiesel;
(ii) optionally mixing the mixture obtained in step (i) with fossil diesel;
(iii) mixing the mixture obtained in step (i) if no fossil diesel is added, or the mixture obtained in step (ii) if fossil diesel is added, with renewable alkane fuel.

14. The method of claim 12, wherein solketal is prepared by converting acetone with glycerin originating from transesterification of triglycerides from renewable sources.

15. A petrol fuel composition comprising
(i) solketal
(ii) optionally one or more petrol fuel components such as renewable petrol fuel components
(iii) optionally fossil petrol
(iv) optionally petrol additives
wherein the relative amount of solketal, expressed in weight-%, is 16 to 100 weight-%, 20 to 99 weight-%, 25 to 98 weight-%, 30 to 97 weight-% or 35 to 96 weight-% of the petrol fuel composition, any remainder being one or more selected from renewable petrol fuel components, fossil petrol, and/or petrol additives,
or
wherein the relative amount of solketal, expressed in weight-%, is 90 to 99.9 weight-%, 92 to 99.8 weight-%, 95 to 99.7 weight-%, 96 to 99.5 weight-% or 97 to 99.4 weight-% of the petrol fuel composition, the remainder being any one or more petrol additives,
with all weight-% indications being based on the total weight of the composition.

16. A method of making the petrol fuel of claim 15, wherein said petrol fuel comprises solketal and at least one of renewable petrol and/or fossil petrol, the method comprising the steps of
(a) providing solketal as well as renewable petrol and/or fossil petrol; and
(b) mixing solketal with renewable petrol and/or fossil petrol.

17. A method for;
i) increasing the content of renewable components in diesel or petrol fuel-;
ii) reducing degradation such as turbidity or precipitation in diesel or petrol fuel;
iii) substituting for diesel fuel or petrol fuel; or
iv) improving the stability of diesel compositions containing biodiesel against degradation caused by water impurities,
comprising adding solketal to the diesel or petrol fuel or replacing the diesel of petrol fuel with solketal.

18-20. (canceled)
